(19) United States
(12) Patent Application Publication
(10) Pub. No.: US 2016/0078564 A1
(43) Pub. Date: Mar. 17, 2016

(54) ADAPTIVE EXPENSE PROCESSING AND MANAGEMENT

(71) Applicant: SpringAhead, Inc., San Francisco, CA (US)

(72) Inventors: Christopher FARRELL, San Francisco, CA (US); Mark MILBOURNE, Walnut Creek, CA (US); Aleksandr PISAREVICH, Clayton, CA (US); Tyler AUSTEN, Antioch, CA (US); Kevin VAN HEUSEN, Ashland, OR (US); Claire MILLIGAN, San Francisco, CA (US); Andrew SCHENCK, San Francisco, CA (US); Milan KORSOS, San Francisco, CA (US); Andrew CHAN, San Francisco, CA (US); Demid POTEMKIN, San Francisco CA, CA (US)

(73) Assignee: SpringAhead, Inc.

(21) Appl. No.: 14/852,550

(22) Filed: Sep. 12, 2015

Related U.S. Application Data
(60) Provisional application No. 62/050,151, filed on Sep. 14, 2014.

(51) Int. Cl. G06Q 40/00

(52) U.S. Cl. CPC G06Q 40/12

(57) ABSTRACT

Methods and apparatus for adaptive expense processing and management include receiving and generating expense data objects, performing one or more expense processing and/or management procedures, adjusting/updating expense data from a first set to a second set for use in an autonomous expense procedure, and generating one or more additional or subsequent expense data objects based on the second set of expense data. For example, one or more account formation characteristics may be determined during an account formation procedure. Further, a merchant identity procedure may be performed. Additionally, the methods and apparatus may perform an expense category estimation procedure. The methods and apparatus may also determine a duplicate expense data object and perform an expense resolution procedure.

### CLAIM OF PRIORITY

The present application claims priority to Provisional Application No. 62/050,151, entitled “COLLECTION, CATEGORIZATION, APPROVAL, AND/OR DELIVERY OF EXPENSE PARAMETERS INTO A COMPUTERIZED ACCOUNTING SYSTEM,” filed Sep. 14, 2014, the content of which is hereby incorporated by reference in its entirety.

### BACKGROUND

The present disclosure relates generally to expense management, and more specifically to adaptive expense processing and management.

Expenses may have a variety of forms. In some instances, a direct payment to a merchant may be considered an expense, whereas in other instances, it may be common practice for an employee to pay for expenses out-of pocket for later reimbursement. Because each expense is unique and subject to at least some form of audit, guidelines may be put into place to assist employees to provide accurate documentation of valid expenses in compliance with payment and reimbursement policies. Despite such efforts accounting errors may still occur. Some errors may be attributed to simple clerical errors, such as calculation errors, typographical errors, illegible handwriting, unwitting or unknowing duplicate submission of expenses, and so forth. Other errors may include classification errors, such as the use of incorrect account codes or incorrect department coding. In some cases, detection of the source of the errors may be problematic due, at least in part, to electronic accounting systems' ability to capture sufficient information for expense reporting. Accordingly, it may be desirable for improved expense management.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some embodiments, a method comprising: at a network entity including one or more electronic access devices: determining a first set of expense data using an autonomous expense procedure and based in part on one or more expense parameters; receiving one or more datasets each associated with a financial transaction record from a data storing entity; generating an expense data object for each of the one or more datasets in response to receiving the one or more datasets and based on the determined first set of expense data; transmitting a resolution request indication to an external electronic device associated with a reviewing entity for one or more of the generated expense data objects; receiving one or more resolution indications for one or more of the generated expense data objects from the external electronic device associated with the reviewing entity; adjusting the first set of expense data to a second set of expense data using the autonomous expense procedure and based at least in part on receiving the one or more resolution indications; generating a second expense data object for a second dataset based on the second set of expense data, wherein the second expense data object is different from the first expense data object; and presenting for display the second expense data object to the external electronic device associated with the reviewing entity.

In some embodiments, a computer-readable storage medium comprising one or more programs for execution by one or more processors of an electronic device. The one or more programs includes instructions which, when executed by the one or more processors, cause the electronic device to: determine a first set of expense data using an autonomous expense procedure based in part on one or more expense parameters; receive one or more datasets each associated with a financial transaction record from a data storing entity; generate an expense data object for each of the one or more datasets in response to receiving the one or more datasets and based on the determined first set of expense data; transmit a resolution request indication to an external electronic device associated with a reviewing entity; receive one or more resolution indications for each generated expense data object from the external electronic device associated with the reviewing entity; adjust the first set of expense data to a second set of expense data using the autonomous expense procedure and in response to receiving the one or more resolution indications; generate a second expense data object for a second dataset based on the second set of expense data, wherein the second expense data object is different from the first expense data object; and present for display the second expense data object to the external electronic device associated with the reviewing entity.

In some embodiments, an electronic apparatus comprising: one or more processors; memory; and one or more programs stored in memory. The one or more programs including instructions for: determining a first set of expense data using an autonomous expense procedure based in part on one or more expense parameters; receiving one or more datasets each associated with a financial transaction record from a data storing entity; generating an expense data object for each of the one or more datasets in response to receiving the one or more datasets and based on the determined first set of expense data; transmitting a resolution request indication to an external electronic device associated with a reviewing entity; receiving one or more resolution indications for each generated expense data object from the external electronic device associated with the reviewing entity; adjusting the first set of expense data to a second set of expense data using the autonomous expense procedure and in response to receiving the one or more resolution indications; generating a second expense data object for a second dataset based on the second set of expense data, wherein the second expense data object is different from the first expense data object; and presenting for display the second expense data object to the external electronic device associated with the reviewing entity.

In some embodiments, a method comprising: at a network entity including one or more electronic devices: establishing a connection with a data storage entity that manages one or more datasets associated with a first account according to one or more transaction configuration parameters; receiving the one or more transaction configuration parameters from the data storage entity in response to establishing the connection with the data storage entity; obtaining an integration level between the network entity and the data storage entity; determining one or more account formation characteristics based on one or both of the one or more transaction configuration parameters or the integration level; adjusting a second account associated with a user at the network entity based on the one or more account formation characteristics; and transmitting one or more account characteristics of the adjusted second account to an external electronic device associated with the user.

In some embodiments, a computer-readable storage medium comprising one or more programs for execution by one or more processors of an electronic device. The one or more programs includes instructions which, when executed by the one or more processors, cause the electronic device to: establish a connection with a data storage entity that manages one or more datasets associated with a first account according to one or more transaction configuration parameters; receive the one or more transaction configuration parameters from the data storage entity in response to establishing the connection with the data storage entity; obtain an integration level between the network entity and the data storage entity; determine one or more account formation characteristics based on one or both of the one or more transaction configuration parameters or the integration level; adjust a second account at the network entity based on the one or more account formation characteristics; and transmit one or more account characteristics of the adjusted second account to an external electronic device associated with the user.

In some embodiments, an electronic apparatus comprising: one or more processors; memory; and one or more programs stored in memory. The one or more programs including instructions for: establishing a connection with a data storage entity that manages one or more datasets associated with a first account according to one or more transaction configuration parameters; receiving the one or more transaction configuration parameters from the data storage entity in response to establishing the connection with the data storage entity; obtaining an integration level between the network entity and the data storage entity; determining one or more account formation characteristics based on one or both of the one or more transaction configuration parameters or the integration level; adjusting a second account at the network entity based on the one or more account formation characteristics; and transmitting one or more account characteristics of the adjusted second account to an external electronic device associated with the user.

In some embodiments, a method comprising: at a network entity including one or more electronic devices: receiving an expense data object having a first merchant identifier, determining whether the expense data object having the first merchant identifier includes a transaction source indication; and performing a merchant identity procedure on the first merchant identifier of the expense data object to obtain a second merchant identifier associated with the expense data object based on a determination that the expense data object includes the transaction source indication.

In some embodiments, a computer-readable storage medium comprising one or more programs for execution by one or more processors of an electronic device. The one or more programs includes instructions which, when executed by the one or more processors, cause the electronic device to: receive an expense data object having a first merchant identifier; determine whether the expense data object having the first merchant identifier includes a transaction source indication; and perform a merchant identity procedure on the first merchant identifier of the expense data object to obtain a second merchant identifier associated with the expense data object based on a determination that the expense data object includes the transaction source indication.

In some embodiments, an electronic apparatus comprising: one or more processors; memory; and one or more programs stored in memory. The one or more programs including instructions for: receiving an expense data object having a first merchant identifier; determining whether the expense data object having the first merchant identifier includes a transaction source indication; and performing a merchant identity procedure on the first merchant identifier of the expense data object to obtain a second merchant identifier associated with the expense data object based on a determination that the expense data object includes the transaction source indication.

In some embodiments, a method comprising: at a network entity including one or more electronic devices and a database: receiving an expense data object; performing an expense category estimation procedure for the expense data object based in part on a heuristic, wherein the expense category estimation procedure includes: determining whether the heuristic has been identified using an autonomous expense process; providing an initial category assignment for the expense data object based on a determination that the heuristic has not been identified using the autonomous expense process; and providing an expense category estimation for the expense data object based on a determination that the heuristic has been identified using the autonomous expense procedure; and transmitting one of the initial category assignment or the expense category estimation to an external electronic device associated with a user

In some embodiments, a computer-readable storage medium comprising one or more programs for execution by one or more processors of an electronic device. The one or more programs includes instructions which, when executed by the one or more processors, cause the electronic device to receive an expense data object; perform an expense category estimation procedure for the expense data object based in part on a heuristic, wherein the expense category estimation procedure includes: determine whether the heuristic has been identified using an autonomous expense process; provide an initial category assignment for the expense data object based on a determination that the heuristic has not been identified using the autonomous expense process; and provide an expense category estimation for the expense data object based on a determination that the heuristic has been identified using the autonomous expense procedure; and transmit one of the initial category assignment or the expense category estimation to an external electronic device associated with a user.

In some embodiments, an electronic apparatus comprising: one or more processors; memory; and one or more programs stored in memory. The one or more programs including instructions for receiving an expense data object; performing an expense category estimation procedure for the expense data object based in part on a heuristic, wherein the expense category estimation procedure includes: determining whether the heuristic has been identified using an autonomous expense process; providing an initial category assignment for the expense data object based on a determination that the heuristic has not been identified using the autonomous expense process; and providing an expense category estimation for the expense data object based on a determination that the heuristic has been identified using the autonomous expense procedure; and transmitting one of the initial category assignment or the expense category estimation to an external electronic device associated with a user.

In some embodiments, a method comprising: at a network entity including one or more electronic devices (e.g., servers) and a database: receiving a first expense data object; determining whether a second expense data object stored in the database matches the first expense data object; in accordance with a determination that the second expense data object stored in the database matches the first expense data object, determining whether one or both of the first expense data object or the second expense data object satisfy auto-merge criteria; in accordance with a determination that one or both of the first expense data object or the second expense data object do not satisfy auto-merge criteria, transmitting a potential duplicate flag indication to an external electronic device associated with a user; receiving a resolution indication from the external electronic device in response to transmitting the potential duplicate flag indication; and performing an expense resolution procedure using at least the first expense data object in response to receiving user input.

In some embodiments, a computer-readable storage medium comprising one or more programs for execution by one or more processors of an electronic device. The one or more programs includes instructions which, when executed by the one or more processors, cause the electronic device to: receive a first expense data object; determine whether a second expense data object stored in the database matches the first expense data object; in accordance with a determination that the second expense data object stored in the database matches the first expense data object, determine whether one or both of the first expense data object or the second expense data object satisfy auto-merge criteria; in accordance with a determine that one or both of the first expense data object or the second expense data object do not satisfy auto-merge criteria, transmitting a potential duplicate flag indication to an external electronic device associated with a user; receive a resolution indication from the external electronic device in response to transmitting the potential duplicate flag indication; and perform an expense resolution procedure using at least the first expense data object in response to receiving user input.

In some embodiments, an electronic apparatus comprising: one or more processors; memory; and one or more programs stored in memory. The one or more programs including instructions for: receiving a first expense data object; determining whether a second expense data object stored in the database matches the first expense data object; in accordance with a determination that the second expense data object stored in the database matches the first expense data object, determining whether one or both of the first expense data object or the second expense data object satisfy auto-merge criteria; in accordance with a determination that one or both of the first expense data object or the second expense data object do not satisfy auto-merge criteria, transmitting a potential duplicate flag indication to an external electronic device associated with a user, receiving a resolution indication from the external electronic device in response to transmitting the potential duplicate flag indication; and performing an expense resolution procedure using at least the first expense data object in response to receiving user input.

In some embodiments, a method comprising: at a network entity including one or more electronic devices each having a processor: receiving an expense report file including one or more expense data objects; determining that each expense data object from the one or more expense data objects of the expense report qualifies for submission to a reviewing entity in response to receiving the expense report file; disaggregating the expense report file into one or more approval groups of expenses each having distinct reviewing entities based on a determination that each expense data object from the one or more expense data objects of the expense report qualifies for submission to the reviewing entity; transmitting a resolution request indication to an external electronic device associated with the reviewing entity; receiving one or more resolution indications for each of the one or more expense data objects from the external electronic device associated with the reviewing entity; and exporting the one or more expense data objects to one or more target databases each uniquely associated with the one or more electronic devices.

In some embodiments, a computer-readable storage medium comprising one or more programs for execution by one or more processors of an electronic device. The one or more programs includes instructions which, when executed by the one or more processors, cause the electronic device to: receive an expense report file including one or more expense data objects; determine that each expense data object from the one or more expense data objects of the expense report qualifies for submission to a reviewing entity in response to receiving the expense report file; disaggregate the expense report file into one or more approval groups of expenses each having distinct reviewing entities based on a determination that each expense data object from the one or more expense data objects of the expense report qualifies for submission to the reviewing entity; transmit a resolution request indication to an external electronic device associated with the reviewing entity; receive one or more resolution indications for each of the one or more expense data objects from the external electronic device associated with the reviewing entity; and export the one or more expense data objects to one or more target databases each uniquely associated with the one or more electronic devices.

In some embodiments, an electronic apparatus comprising: one or more processors; memory; and one or more programs stored in memory. The one or more programs including instructions for: receiving an expense report file including one or more expense data objects; determining that each expense data object from the one or more expense data objects of the expense report qualifies for submission to a reviewing entity in response to receiving the expense report file; disaggregating the expense report file into one or more approval groups of expenses each having distinct reviewing entities based on a determination that each expense data object from the one or more expense data objects of the expense report qualifies for submission to the reviewing entity; transmitting a resolution request indication to an external electronic device associated with the reviewing entity; receiving one or more resolution indications for each of the one or more expense data objects from the external electronic device associated with the reviewing entity; and exporting the one or more expense data objects to one or more target databases each uniquely associated with the one or more electronic devices.

In some embodiments, a method comprising: at a network entity including one or more electronic devices (e.g., servers) including a first database and a second database: receiving a first expense data object; determining that a second expense data object stored in the first database matches the first expense data object to form a duplicate expense object pair; in accordance with a determination that the second expense data object stored in the first database matches the first expense data object, determining whether a characteristic of each expense data object forming the duplicate expense object pair satisfies auto-merge criteria; in accordance with a determination that the characteristic of each expense data object forming the duplicate expense object pair does not satisfy auto-merge criteria, determining whether the duplicate expense object pair is an exclusion match of an excluded expense data object pair stored in the second database; and in accordance with a determination that the duplicate expense object pair does not match the excluded expense object pair: transmitting a potential duplicate flag indication to an external electronic device associated with a user, receiving a resolution indication from the external electronic device in response to transmitting the potential duplicate flag indication; and performing an expense resolution procedure using at least the first expense data object in response to receiving a first user input.

In some embodiments, a computer-readable storage medium comprising one or more programs for execution by one or more processors of an electronic device. The one or more programs includes instructions which, when executed by the one or more processors, cause the electronic device to: receive a first expense data object; determine that a second expense data object stored in the first database matches the first expense data object to form a duplicate expense object pair, in accordance with a determination that the second expense data object stored in the first database matches the first expense data object, determine whether a characteristic of each expense data object forming the duplicate expense object pair satisfies auto-merge criteria; in accordance with a determination that the characteristic of each expense data object forming the duplicate expense object pair does not satisfy auto-merge criteria, determining whether the duplicate expense object pair is an exclusion match of an excluded expense data object pair stored in the second database; and in accordance with a determination that the duplicate expense object pair does not match the excluded expense object pair:transmit a potential duplicate flag indication to an external electronic device associated with a user; receive a resolution indication from the external electronic device in response to transmitting the potential duplicate flag indication; and perform an expense resolution procedure using at least the first expense data object in response to receiving a first user input.

In some embodiments, an electronic apparatus comprising: one or more processors; memory; and one or more programs stored in memory, the one or more programs including instructions for: receiving a first expense data object; determining that a second expense data object stored in the first database matches the first expense data object to form a duplicate expense object pair, in accordance with a determination that the second expense data object stored in the first database matches the first expense data object, determining whether a characteristic of each expense data object forming the duplicate expense object pair satisfies auto-merge criteria; in accordance with a determination that the characteristic of each expense data object forming the duplicate expense object pair does not satisfy auto-merge criteria, determining whether the duplicate expense object pair is an exclusion match of an excluded expense data object pair stored in the second database; and in accordance with a determination that the duplicate expense object pair does not match the excluded expense object pair: transmitting a potential duplicate flag indication to an external electronic device associated with a user; receiving a resolution indication from the external electronic device in response to transmitting the potential duplicate flag indication; and performing an expense resolution procedure using at least the first expense data object in response to receiving a first user input.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### DESCRIPTION OF THE FIGURES

For a better understanding of the various described embodiments, reference should be made to the description below, in conjunction with the following drawings in which like reference numerals refer to corresponding parts throughout the figures.

FIG. 1A is a block diagram illustrating a system for the collection, categorization, approval and delivery of expenses.

FIG. 1B is a block diagram for a module structure within a computer system for the collection, categorization, approval and delivery of expenses.

FIG. 2 is a block diagram of an expense processing and management system in accordance with some embodiments of the present disclosure.

FIG. 3A is a flow diagram of a collection, categorization, approval and delivery scheme of expense data objects in accordance with some embodiments of the present disclosure.

FIG. 3A-1 is a flow diagram for modifying a set of expense data associated with the autonomous expense procedure in accordance with some embodiments of the present disclosure.

FIG. 3B is a flow diagram for synchronizing with a target system/entity in accordance with some embodiments of the present disclosure.

FIG. 3C is a flow diagram for defining configuration parameters in accordance with some embodiments of the present disclosure.

FIG. 3D is a flow diagram for generating an expense data object in accordance with some embodiments of the present disclosure.

FIG. 3D-I is a flow diagram for generating an expense data object in accordance with some embodiments of the present disclosure.

FIG. 3D-2 is a flow diagram for providing data pre-fill to a user device in accordance with some embodiments of the present disclosure.

FIG. 3D-3a is a flow diagram for an analysis procedure in accordance with some embodiments of the present disclosure.

FIG. 3D-3b is a flow diagram for an additional analysis procedure in accordance with some embodiments of the present disclosure.

FIG. 3D-4 is a flow diagram for a policy verification procedure in accordance with some embodiments of the present disclosure.

FIG. 3D-5 is a flow diagram for a user provided data process in accordance with some embodiments of the present disclosure.

FIG. 3E is a flow diagram for reviewing an expense data object in accordance with some embodiments of the present disclosure.

FIG. 3F is a flow diagram for exporting an expense data object to one or more target systems/entities in accordance with some embodiments of the present disclosure.

FIG. 3F-1 is a flow diagram for exporting (e.g., type A) an expense data object in accordance with some embodiments of the present disclosure.

FIG. 3F-2 is a flowchart for exporting (e.g., type B) an expense data object in accordance with some embodiments of the present disclosure.

FIG. 4 is a functional block diagram of a network entity in accordance with some embodiments of the present disclosure.

FIG. 5 is a functional block diagram of a network entity in accordance with some embodiments of the present disclosure.

FIG. 6 is a functional block diagram of a network entity in accordance with some embodiments of the present disclosure.

FIG. 7 is a functional block diagram of a network entity in accordance with some embodiments of the present disclosure.

FIG. 8 is a functional block diagram of a network entity in accordance with some embodiments of the present disclosure.

FIG. 9 is a functional block diagram of a network entity in accordance with some embodiments of the present disclosure.

FIG. 10 is a functional block diagram of a network entity in accordance with some embodiments of the present disclosure.

### DETAILED DESCRIPTION

The following description is presented to enable a person of ordinary skill in the art to make and use the various embodiments. Descriptions of specific devices, modules, units, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Portions of the following description may be presented in terms of functions, algorithms, flow diagrams/charts, logic blocks, and other symbolic representations of operations pertaining to physical properties that can be performed by a network entity or sophisticated computer system. A procedure, function, computer-executed step, logic block, process, etc., is here conceived to be a self-consistent sequence of one or more steps or instructions intended to manipulate physical quantities for practical results. These quantities may take the form of non-transitory signals (e.g. electrical, magnetic, optical, etc.) capable of being stored, transferred, combined, compared, and otherwise manipulated in a network entity or sophisticated computer system. These signals and information encoded therein may be referred to at times as bits, data, classes, datasets, data objects, parameters, values, elements, or the like. Each step and/or function may be performed by hardware, software, firmware, or any combinations thereof.

The present disclosure generally relates to expense processing, reporting and management. Specifically, the present aspects relate to the collection, categorization, approval, and/or delivery of expense data objects to an integrated computerized system. Expense management may involve the processing of large numbers of expense data objects. For example, a centralized computer system in the form of a network entity may store a plurality of user accounts. Each user account may in turn include or otherwise be associated with one or more expense data objects. As one or more expense data objects are processed and/or managed for a particular user account, the processing or management may be performed based on or otherwise using systems, methods, or procedures that are consistent and non-adaptive. In other words, the network entity may not “learn” or otherwise adaptively determine various behaviors, parameters, and/or patterns for a particular user during the iterative expense processing and/or management. As such, it may be beneficial for an adaptive system that may form or otherwise tailor a unique expense management procedure to individual users based on, for instance, a history of received expense data objects would be beneficial to the processing, reporting, and management of expenses.

Further, for example, a complete and accurate recording (e.g., storing) of expenses often involves numerous complexities. In the simplest cases, a recording may include precise mapping of expenses to appropriate accounts and related reporting attributes (e.g., accounting system classifications, company departments, office locations, etc.) that may draw from a combination of accounting expertise and context of an expense (e.g., project name, a department to which an expense applies, etc.).

Frequently, the additional accounting requirements of an individual business' internal and external financial auditing regulations and policies as well as those imposed by local, state, and federal entities/government agencies may exacerbate the complexities of managing these expenses. For instance, to prove legal and ethical financial practices various entities may require physical copies of supporting source documents, such as canceled checks, vendor credit account statements, sales receipts, and invoices to accompany each expense as validation of accurate expense submission. In other instances, the various entities may require subsequent supporting rationale, such as names of all attendees and a stated business purpose as evidence that expenses were incurred for legitimate business purposes.

To account for the complexities, expense management and accounting systems may employ internal controls aimed to reduce error and fraudulent events. For example, internal control may be a process (e.g., executable by an electronic device) designed to provide reasonable assurance regarding the achievement of objectives relating to operations, reporting, and compliance. Internal controls may be aimed at reducing error and fraud events and may be categorized, in general, as controlling activities and monitoring activities. The controlling activities intend to decrease the likelihood of fraudulent events and may involve, for example, formalized approval structures and strict expense policies. Monitoring activities are intended to identify events that may have passed unnoticed through a control structure and may range in formality but may generally include, at least, periodic or random checks on previously submitted expenses.

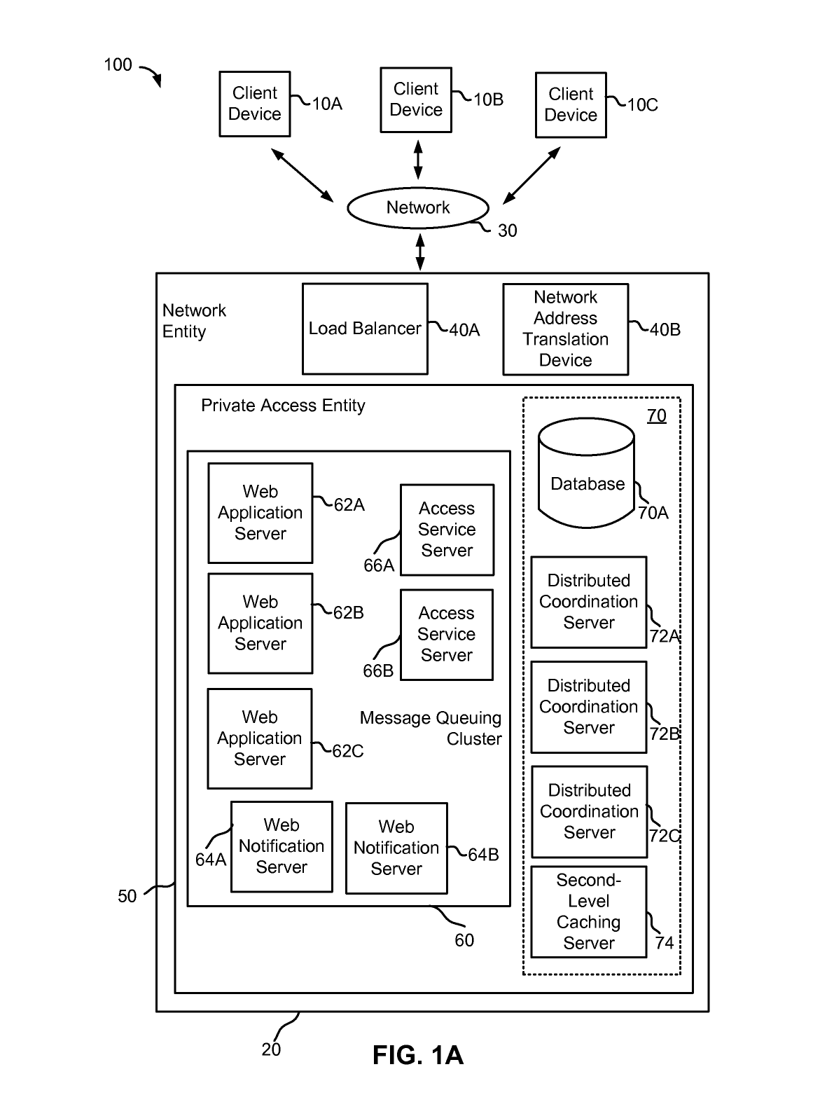

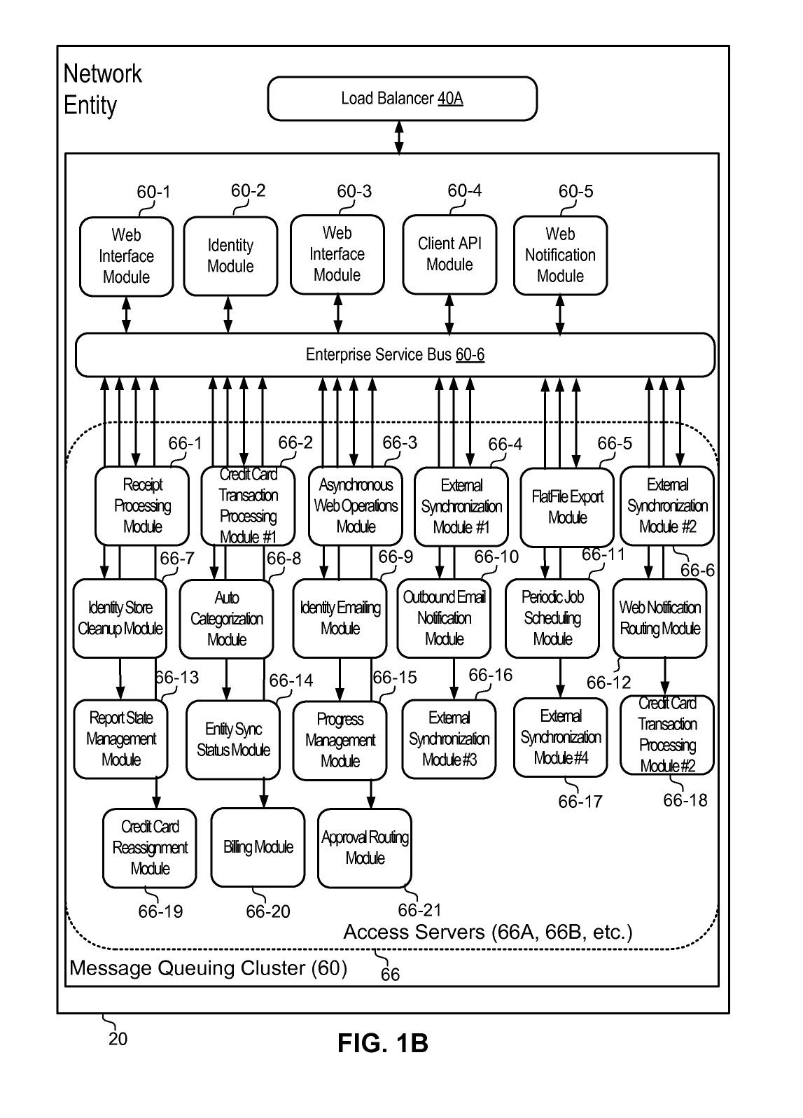

Referring to FIG. 1A, a communication system 100 for managing and/or processing expenses includes one or more client devices in communication with a network entity 20. In some embodiments, network entity 20 may be configured to manage expense processing and analysis to reduce the likelihood of errors during or as part of the collection, categorization, approval, and delivery of the expenses. In some embodiments, expenses may be referred to or take the form of expense data objects. Specifically, in some embodiments, an expense data object may be a representation of structured or unstructured data related to expense information. Expense information may include one or more of receipt data, invoice data, billing data, statement data, or tax data. For example, communication system 100 may include client devices 10A, 10B and/or 10C, network entity 20, and network 30. The client computing devices 10A, 10B, and 10C may each be an electronic device having at least a processing unit and associated with a user. For example, client devices 10A. 10B, and/or 10C may be a desktop computer 10A, a laptop 10B, mobile device 10C.

Further, it should be appreciated that mobile devices 10A, 10B, and/or 10C may include or otherwise be a portable electronic communications and computing device such as a ‘smartphone,’ ‘tablet,’ wearable computing device, and the like. It should also be appreciated that the total number of client computing devices will vary and may be less or more than the number illustrated in FIG. 1A. In particular, the number of client computing devices may be based on the number of clients and devices configured by each client as a client device. For instance, the total number of client devices may be expanded to five for the two clients when: a first client has three mobile device configured as client computing devices 10A, 10B and 10C and a second client has a laptop and ‘tablet’ computer.

Network entity 20 may include one or more components, servers, and/or modules, each of which may be configured, in a synchronous or asynchronous manner, to process, manage and report expense information. Network entity 20 may be a remote based infrastructure with shared resources, software, and information provided to client devices 10A, 10B, and/or 10C and accessible using or via network 30. In some embodiments, the one or more servers and/or modules may be referred to as electronic access devices. In some embodiments, the remote based infrastructure may be a network of remote servers hosted on the Internet and used to store, manage, and process data in place of local servers or personal computers. For example, the remote based infrastructure may also be referred to as a cloud based infrastructure. Network entity 20 may include one or both of physical servers or virtual servers housed within private server cluster 50. The private server cluster 50 may be hosted and managed internally or externally. The private server cluster 50 may be a ‘private cloud’ that includes a network accessible infrastructure.

Network 30 may utilize one or more communication mediums and protocols and may include one or more computer or data networks such as the Internet or an intranet. Client devices 10A, 10B, and 10C, as well as network entity 20, may be coupled, connected or otherwise in communication with network 30 using, any combination of, wired connections, wireless connections, Wi-Fi, Ethernet, Bluetooth, cellular, fiber optic, spread spectrum technologies, or other suitable communication technology enabling or facilitating communication between electronic devices.

Network entity 20 may include load balancer 40A and network address translation device 40B coupled to or otherwise in communication with private access entity 50. Load balancer 40A may be configured to distribute the computational workload over one or more modules and/or servers in private access entity 50 based on a specific function each module and server performs. In some instances, load balancer 40A may be configured to distribute the computational workload to web interface module 60-1, identity module 60-2, web interface module 60-3, client application program interface (API) module 60-4, and web notification module 60-5 may be coupled or connected to the enterprise service bus 60-6 as depicted in FIG. 1B. In some instances, load balancer 40A may control an incoming (e.g., downlink) and outgoing (e.g., uplink) transmission of data packets (e.g., web traffic/data) to/from network entity 20.

Network address translation device 40B may be configured to modify network address parameters in Internet Protocol (IP) packets as they transit in and out of network entity 20. In some instances, network address translation device 40B may be configured to map/remap an IP address space between network entity 20 and client computing devices 10A, 10B and/or 10C, as well as other external computing devices not shown in FIG. 1A. Network address translation device 40B may also be configured so that some or all outbound IP traffic from the private access entity 50 passes through network address translation device 40B.

Further, private access entity 50 may include message queuing cluster 60 and one or more additional databases and/or servers 70. Specifically, message queuing cluster 60, which may be configured to monitor and/or manage a list of data items and/or commands stored so as to be retrievable in a definite order (e.g., in the order of insertion), may include web application servers 62A, 62B, 62C, access service modules/servers 66A, 66B, and web notification servers 64A, 64B.

Web application servers 62A, 62B, 62C may be configured to respond to hypertext transfer protocol secure (HTTPS) requests for interfaces to network entity 20. Web browser interfaces and application program interface (API) related functionality may be provided. Web notification servers 64A, 64B may be configured to provide a browser communication channel for real-time adjustments/updates to a web browser application interface for network entity 20. It should be appreciated that one or more web notification servers, as depicted in FIG. 1A, may be present to optimize throughput. The access service modules 66A, 66B may be configured to provide backend processing, which may include expense processing and real-time synchronization with target accounting systems. Additionally, message queuing cluster 60 may be configured as a scalable architecture for additional web applications, web notifications, and service modules.

The one or more additional servers 70 may include database 70A, distributed coordination servers 72A, 72B, 72C and second-level caching server 74. In some embodiments, the one or more additional servers 70 may include one or more databases including database 70A. Database 70A may be a storage media, such as, but not limited to, magnetic storage media, optical storage media, hard disk drives (HDD), solid state drive (SSD), virtual storage devices, and the like. Database 70A may be integrated into private access entity 50 to provide central data storage of parameters for the servers of server infrastructure 20.

Distributed coordination servers, 72A, 72B, 72C, may be configured to provide a configuration and distributed locking module mechanism utilized by one or more access service modules 66A, 66B in message queuing cluster 60. Second level caching server 74 may be configured to cache one or more parameters between the servers of the private access entity 50 and the one or more databases 70A in order to increase the speed and overall throughput. It should be appreciated that the number of servers in the additional servers 70 may vary in order to accommodate and optimize throughput of the private access entity 50; for example, additional databases 70A may be added to accommodate for more storage. In some embodiments, access service modules 66A and 66B, web applications servers 62A, 62B, 62C, and web notification servers 64A, 64B, of the message queuing cluster 60 may be coupled to or otherwise in communication with a bus (e.g., enterprise service bus 60-6, FIG. 1B).

Referring to FIG. 1B, network entity 20 may include one or more components, servers, and/or modules configured to process, manage and report expense information. For example, network entity 20 may be configured, via one or more modules, to receive expense information and generate expense data objects using the expense information for use in subsequent expense processing. Specifically, the expense processing may encompass various aspects including, but not limited to, account formation and modification, merchant identification of expense data objects, category estimation for expense data objects, duplicate expense data object determination, aggregating and disaggregating expense reports, and adjusting/updating expense data associated with an autonomous expense procedure.

In some embodiments, one or more modules/components of network entity 20, and more specifically, message queuing cluster 60, may be configured to perform one or both of an autonomous expense procedure or a merchant identity procedure. For example, the autonomous expense procedure may be a procedure that receives and analyzes one or more expense data objects to determine whether to adjust a set of valid expense data used in expense processing and management. Further, for instance, the merchant identity procedure may filter extraneous characters from a merchant identity/name (e.g., imaged or read from an expense receipt) associated with an expense data object to obtain a filtered merchant identity/name. One or both of the autonomous expense procedure or the merchant identity procedure may be based or operate according to, at least in part, a string distance procedure such as, but not limited to, the Jaro-Winkler procedure.

D(s,t)=c/Max(|s|,|t|) (1)

where s is the first string, t is the second string, and c equals the count of characters that s and t have in common.

Further, a string distance procedure such as the Jaro-Winkler procedure is a measure of similarity between two strings. The output value of string distance procedure may be indicative of how similar two strings are to each other. As such, a first string and a second string may be considered more similar the higher the output value. In some embodiments, an output value of ‘0’ may indicate no similarity whereas an output value of ‘1’ is an exact match. Accordingly, the output value may be any value in the range of ‘0’ to ‘1’, with the value indicating higher similarity between strings the closer it is to ‘1’.

In some embodiments, the string distance procedure may be based on the number and order of the common characters between the first string s and the second string t. For example, given strings s=a₁ . . . a_{K} and t=b₁ . . . b_{L}, define a character aᵢ in s to be common with t there is a bⱼ=aᵢ in t such that i−H≦j≦i+H, where H=min(|s|,|t|)/2. Let s′=a′₁, . . . a′_{K′} be the characters in s which are common with t (in the same order they appear in s) and let t′=b′₁ . . . b′_{L}, be analogous; now define a transposition for s′, t′ to be a position i such that a′₁≠b′ᵢ. Let T_{s′,t′} be half the number of transpositions for s′ and t′. The Jaro similarity metric for s and t is:

$$Jaro ( s , t ) = \frac{1}{3} \cdot ( \frac{\vert {s}^{′} \vert}{\vert s \vert} + \frac{\vert {t}^{′} \vert}{\vert t \vert} + \frac{\vert {s}^{′} \vert - {T}_{{s}^{′} {t}^{′}}}{\vert {s}^{′} \vert} ) \qquad ( 2 )$$

Further, the Jaro-Winkler may use a length P of the longest common prefix of s and t in its determination. For example, letting P′=max(P,4):

$$Jaro \text{-} Winkler ( s , t ) = Jaro ( s , t ) + \frac{{P}^{′}}{10} \cdot ( 1 - Jaro ( s , t ) ) \qquad ( 3 )$$

In some embodiments, enterprise service bus 60-6 (FIG. 1B) may be a hardware and/or software architecture model facilitating communication between mutually interacting hardware and/or software applications in a service-oriented architecture. As depicted in FIG. 1B, these backend servers of the message queuing cluster 60 may include web interface module 60-1, identity module 60-2, web interface module 60-3, client API module 60-4, and web notification module 60-5 may be coupled/connected to or otherwise in communication with enterprise service bus 60-6.

Each module may function asynchronously and perform specific autonomous functions within or as part of network entity 20. For example, web interface module 60-1 may be configured to provide a web browser user interface wherein user account-based access to network entity 20 may be initiated. Further, identity module 60-2 may be configured to provide user identity management and may establish relationships between or among user accounts and one or more company/organization accounts in addition to granting access to other systems and/or platforms across the Internet that may share similar user authentication protocols.

Web interface module 60-3 may be configured to provide a user interface, which may grant user access to network entity 20 via, for example, a web browser, which in turn may provide platform-independent access to network entity 20 via the world wide web. Client API module 60-4 may be configured to grant access to network entity 20 for a select group of external applications. For example, these external applications may include one or more native mobile applications and/or one or more accounting system parameter translation module providers installed on computing devices to communicate with accounting software (e.g., desktop translation module). Web notification module 60-5 may be configured to provide a method for delivering messages to web browsers, native mobile applications, and accounting software (e.g., desktop translation module via Comet protocol).

In addition, access service modules 66A and 66B may also include modules with specific processing capabilities that are coupled or connected to enterprise service bus 60-6. For instance, the expanded service modules forming part of access service modules 66A and 66B may include, but are not limited to: receipt processing module 66-1, first credit card transaction processing module 66-2, asynchronous web operations module 66-3, first external synchronization module 66-4, flat-file export module 66-5, second external synchronization module 66-6, identity store cleanup module 66-7, auto categorization module 66-8, identity emailing module 66-9, outbound email notification module 66-10, periodic job scheduling module 66-11, web notification routing module 66-12, report state management module 66-13, entity sync status module 66-14, progress management module 66-15, third external synchronization module 66-16, fourth external synchronization module 66-17, second credit card transaction processing module 66-18, credit card reassignment module 66-19, billing module 66-20, and approval routing module 66-21.

In some embodiments, receipt processing module 66-1 may be configured to initiate optical recognition (e.g., via optical character recognition), request turking from a service to read transactional data from a receipt image, determine a confidence level for duplicate receipts, and accommodate multi-page images and one or more file types (e.g., portable document format (PDF)). Additionally, receipt processing module 66-1 may be configured to perform the autonomous expense procedure (e.g, machine learning operations according to string distance procedures) to determine a confidence level for duplicate receipts.

First credit card transaction processing module 66-2 may be configured to determine the integration with one or more transaction card (e.g., credit card) data aggregation module providers with one or more credit card module providers. In some embodiments, first credit card transaction processing module 66-2 may be configured to obtain an integration level between the network entity 20 and a data storage entity (e.g., a data aggregation module provider and/or a transaction card module provider).

Asynchronous web operations module 66-3 may be configured to control and/or direct various asynchronous operations in order to optimize throughput. In some embodiments, asynchronous web operations module 66-3 may be configured to accept a websites' long-running tasks such that the website may continue to perform other operations. In such instances, the parameters of completed asynchronous operations may be delivered via the web notification module 60-5. For example, asynchronous operations may include, but are not limited to, policy calculations on one or more expenses, entity hierarchy checks, and/or analytics parameter generation.

External synchronization modules 66-4, 66-6, 66-16 and 66-17 may be configured to integrate features of the network entity 20 to an integrated accounting service. Additionally, flat file export module 66-5 may be configured to determine and extract data from database 70A and generate a data file according to a specified format (e.g., comma-delimited, pdf, html). Further, identity store cleanup module 66-7 may be configured to provide offline processing of identities (e.g., user accounts and/or company enterprise accounts).

Auto categorization module 66-8 may be configured to perform, for example, an expense categorization or category estimation procedure. For example, auto categorization module 66-9 may be configured to perform an expense category estimation procedure for one or more expense data objects based in part on a categorization probability associated with each of the one or more expense data objects. Additionally, auto categorization module 66-8 may be configured to perform the autonomous expense procedure (e.g, machine learning operations) to adjust or update a set of expense data, for instance, in accordance with performing the expense category estimation procedure.

Identity emailing module 66-9 may be configured to provide email notifications based, at least in part, on user identity management, such as signup flows. Outbound e-mail notification module 66-10 may be configured to control or direct the sending of emails as needed by network entity 20. Further, periodic job scheduling module 66-11 may be configured to determine or otherwise produce schedule-based activities, including, for example, periodic (e.g., hourly, daily, weekly) synchronizations.

Web notification routing module 66-12 may be configured to bridge the enterprise service bus 60-6 and the web notification module 60-5 to provide communication directly to the browser in real-time. In some embodiments, report state management module 66-13 may be configured to control or direct states of expense reports while, for example, an export is in progress.

Entity sync status module 66-14 may be configured to control or direct entity changes. In some instances, changes to an expense parameter and/or a set of expense data used as part of the autonomous expense procedure of the network entity 20 may be routed by entity sync status module 66-14 to an appropriate synchronization module for delivery of the change to each synchronized target system. It should be appreciated that one or more messages provided on or by the enterprise service bus 60-6 may be made available for consumption, acquisition, reception by any one of the external sync modules (e.g., entity sync status module 66-14).

Progress management module 66-15 may be configured to collect and monitor, for example, completion of a variety of synchronization modules and may provide user interface (UI) information pertaining to one or more synchronization modules.

Second credit card transaction processing module 66-18 may be configured to enable parsing of credit card transaction files that may be manually uploaded to network entity 20 in lieu of a credit card transaction accessed via first credit card transaction processing module 66-2. In some embodiments, receipt processing module 66-1 may be configured to perform a merchant identity procedure including identifying, extracting and modifying (e.g., removing) data pertinent in receipt or invoice data.

Credit card reassignment module 66-19 may be configured to redirect and process expenses across identities from a credit card setup by a first user via the first credit card transaction processing module 66-2 or second credit card transaction processing module 66-18 to a second user. In some embodiments, billing module 66-20 may be configured to receive and/or provide billing information to network entity 20. Further, approval routing module 66-21 may be configured to support submission of expense reports and may control or direct approval routing processing.

In some embodiments, an advantage of coupling or connecting the backend servers and modules to enterprise service bus 60-6 is that the modules in the message queuing cluster 60 may communicate via a message queuing pattern in enterprise service bus 60-6. In some instances, the enterprise service bus 60-6 may automatically distribute messages from module-to-module based, at least in part, upon a message's usage throughout the network entity 20. Further, the enterprise service bus 60-6 may be configured to grant durable delivery of those messages across the private access entity 50, thereby replicating the messages across multiple machines and increasing likelihood of delivery in the instance of a failure of one or more processing entities in the private access entity 50.

A further advantage of coupling or connecting the backend servers and modules to enterprise service bus 60-6 may be that each server and module operates relatively independently to transmit and receive adjustments/updates to and from central enterprise service bus 60-6. That is, the modules may function as independent elements of the message queuing cluster 60 that may perform individual functions that may not depend on other modules (e.g., a first module that does not depend on operations of a second module to perform a specific function). This results in an asynchronous interaction between modules and servers in any permutation and combination to synergistically form a highly configurable expense processing, reporting, and management system.

Additionally, the interconnectivity of servers and modules with specific processing capabilities facilitates a service-oriented architecture. This results in a highly scalable architecture as the interconnectivity supports or otherwise enables the reduction or addition of servers and modules to accommodate specific processing capabilities of network entity 20.

In some embodiments, network entity 20 and/or each one of the modules, servers, and/or components of network entity 20 may include a processor. Further, in some embodiments, network entity 20 and/or each one of the modules, servers, and/or components of network entity 20 may include memory, which may be or otherwise take the form of one or more computer-readable storage mediums. The computer-readable storage mediums may be tangible and non-transitory. The memory may include high-speed random access memory and may also include non-volatile memory, such as one or more magnetic disk storage devices, flash memory devices, or other non-volatile solid-state memory devices. A corresponding memory controller may control access to memory by other components of network entity 20 and/or one or more modules, servers, and/or components of network entity 20. Executable instructions for performing these functions are, optionally, included in a transitory computer-readable storage medium or other computer program product configured for execution by one or more processors.

Further, the memory of network entity 20 and/or each one of the modules, servers, and/or components of network entity 20 may be a non-transitory computer-readable storage medium, for storing computer-executable instructions, which, when executed by one or more computer processors, for example, can cause the computer processors to perform the techniques described herein. The computer executable instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In some embodiments, a “non-transitory computer-readable storage medium” may be any medium that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

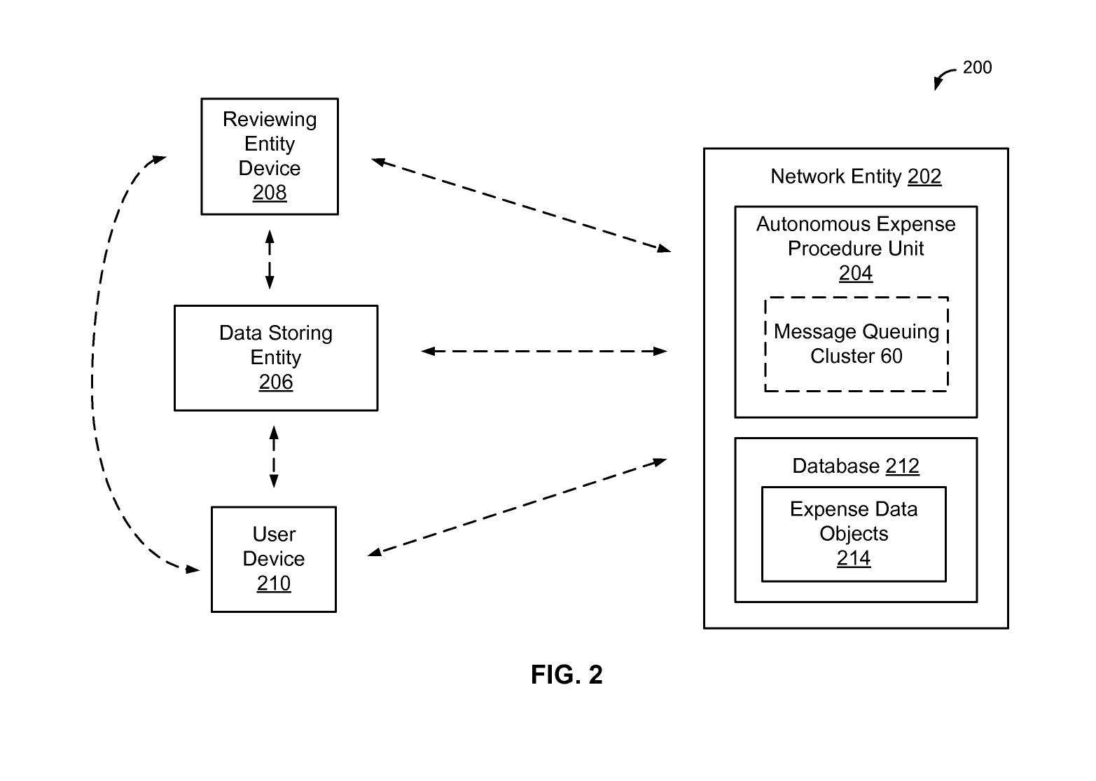

Referring to FIG. 2, a communication system 200 includes network entity 200, data storing entity 206, reviewing entity device 208, and user device 210. In some embodiments, network entity 200 may be the same as or similar to network entity 20 (FIGS. 1A and 1B). Additionally, each of reviewing entity 206 and user device 210 may be the same as or similar to one of client devices 10A, 10B, and 10C. Communication system 200 may facilitate expense information transfer, processing, reporting, and management via, for example, network entity 202.

In some embodiments, network entity 202 may be configured to process and manage received expense data. Network entity 202 may include autonomous expense procedure unit 204, which may be configured to perform an autonomous expense procedure using the one or more expense data objects 214. In some instances, autonomous expense procedure unit 204 may include message queuing cluster 60. Further, network entity 202 may include database 212, which may be the same as or similar to database 70A (FIG. 1B), for storing one or more expense data objects 214.

Specifically, network entity 202 may be configured to receive expense data (e.g., in the form of expense datasets from one or both of data storing entity 206 or user device 210. In some embodiments, network entity 202 may, based on an expense transfer instruction received from user device 210, receive one or more datasets each associated with a financial transaction record from data storing entity 206. The one or more datasets may be expense information stored or formatted in a format specific to the data storing entity 206. Network entity 202 may be configured to generate or otherwise process/convert the one or more datasets to the one or more expense data objects 214. In some embodiments, the received expense datasets, and in turn, the generated one or more expense data objects 214, may be associated with one or more user accounts.

Further, in some embodiments, network entity 202 may receive one or more expense data objects 214 directly from data storing entity 206 or user device 210 without having to process or otherwise generate the expense data objects 214 from received expense datasets. Network entity 202 may be configured to perform one or more expense processing and/or management procedures on or using the expense data objects 214 so as to “learn” (e.g., in a machine context) or adapt with respect to various characteristics of each user account to provide increasingly accurate expense results.

For example, in some embodiments, network entity 202 may be configured, via first credit card transaction processing module 66-2 (FIG. 1B), receipt processing module 66-1 (FIG. 1B), and/or second credit card transaction processing module 66-18 (FIG. 1B), to perform a merchant identity procedure on or using the one or more expense data objects 214 to identify and filter (e.g., remove) characters or symbols not part of a merchant identifier (e.g., merchant name). Specifically, an expense data object corresponding to a transaction (e.g., credit) card expense may include, as part of the information, a first merchant identifier. However, the first merchant identifier may include, as part of the data string forming the identifier, extraneous characters or symbols.

As such, network entity 202 may determine that the first merchant identifier includes extraneous characters or symbols not part of a stored merchant identifier or name. Accordingly, network entity 202 may be configured to perform the merchant identity procedure to obtain a second merchant identifier from the first merchant identifier by filtering the extraneous characters or symbols from the first merchant identifier. Additionally, in some embodiments, the merchant identity procedure may be performed based on a determination that the expense data object includes a transaction (e.g., credit) card indication.

Network entity 202 may be configured to then effectively assign the expense data object based on the filtered merchant identifier. In some embodiments, network entity 202 may be configured to perform an expense category estimation procedure for the expense data object based in part on a heuristic representative of a categorization probability associated with the expense data object. For example, network entity 202 may provide an expense category estimation when a heuristic has been identified by the autonomous expense procedure unit 204. The category assignment may be useful in accurately identifying the type of expense associated with the expense data object for which the category is determined.

In some embodiments, network entity 202, via receipt processing module 66-1 (FIG. 1B), may be configured to perform an expense resolution procedure as part of an expense data object duplicate determination. In particular, network entity 202 may actively monitor for and/or determine whether one or more of expense data objects 214 have already been stored in database 212 to prevent duplicate storage of expense data objects that may occupy limited storage space and/or interfere with efficient processing and management of expense data.

The various expense processing and management procedures described herein provide an adaptive system that may form or otherwise tailor a unique expense management procedure to individual users (e.g., associated with a user account). Network entity 202 may also be configured to send or transmit one or more resolution request indication (e.g., expense approval request) to, for example, reviewing entity device 208 for review of one or more of the categorized expense data objects. Accordingly, network entity 202 may be configured to receive one or more resolution indications (e.g., approval/denial indications) for each of the one or more expense data objects from reviewing entity device 208.

In some embodiments, a resolution indication in the affirmative, that is, approving the expense data object, may be permitted to, or otherwise directed to a set of expense data associated with the autonomous expense procedure. Specifically, network entity 202 may be configured to, following reception of the resolution indication, export one or more expense data objects 214 to one or more target databases (e.g., database 212). Consequently, in an adaptive manner, as the expense data object has been identified or determined as a valid expense, the set of expense data representative of valid data used for performing the autonomous expense procedure may be adjusted or updated. As such, subsequent expense processing and determinations (e.g., category assignment) may be more accurate and based on currently valid information

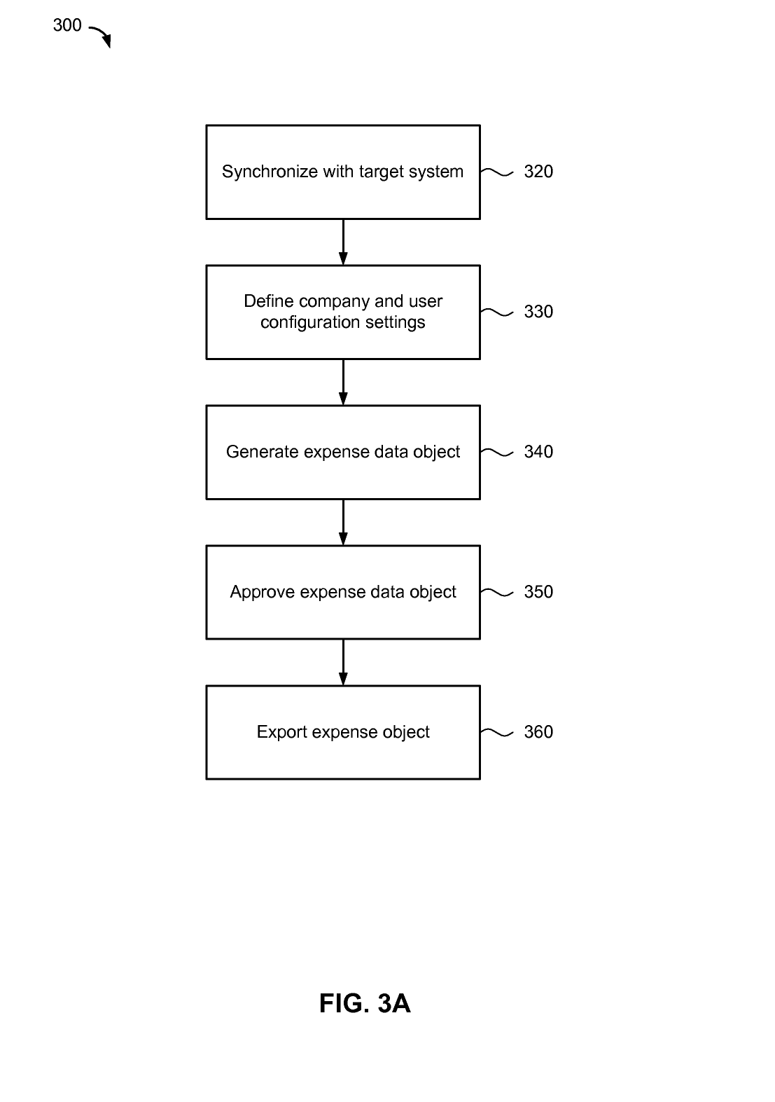

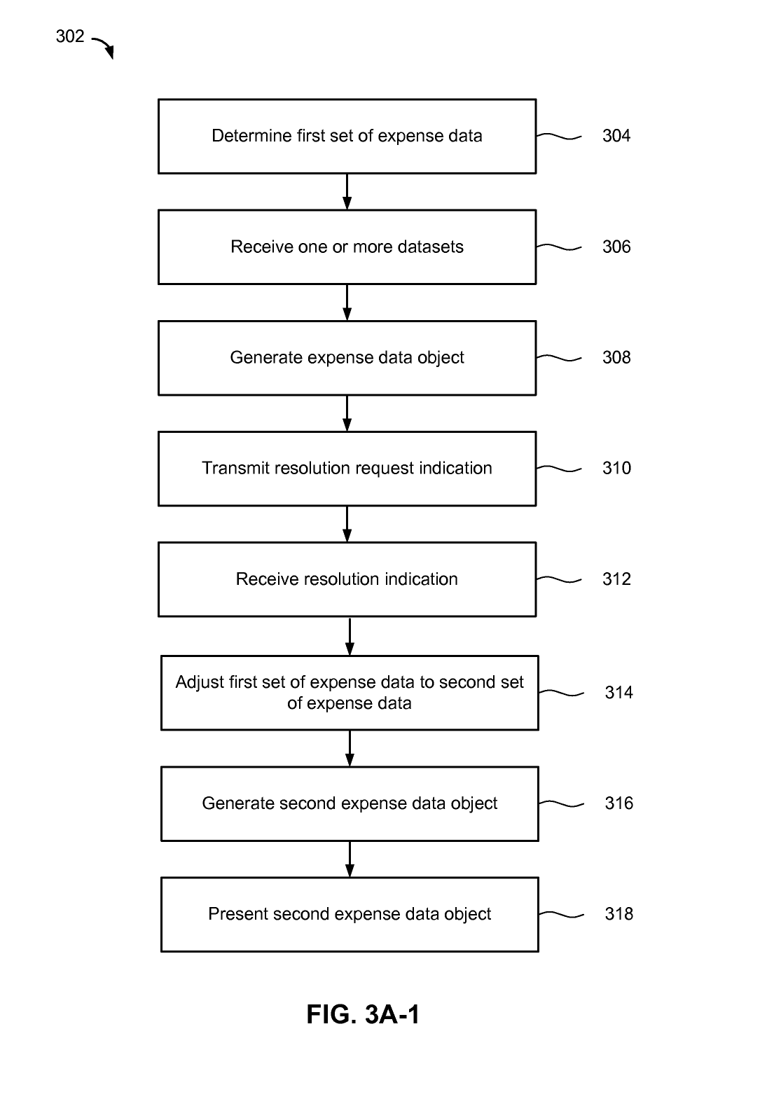

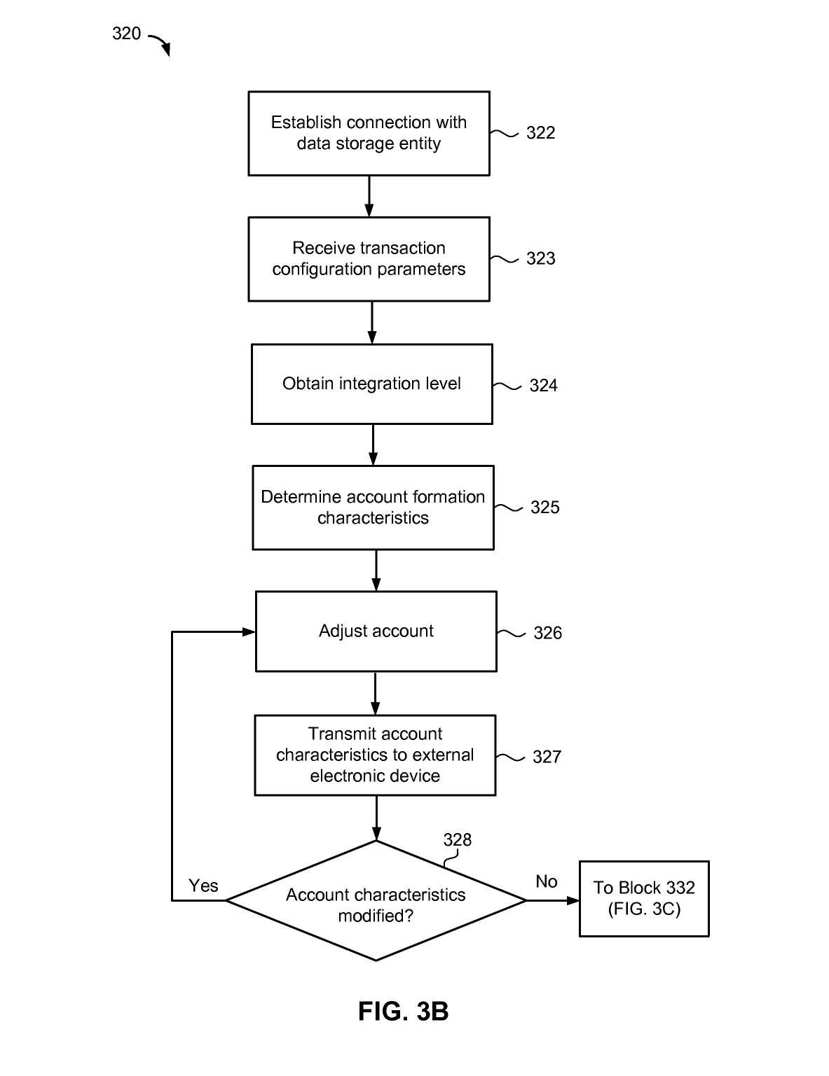

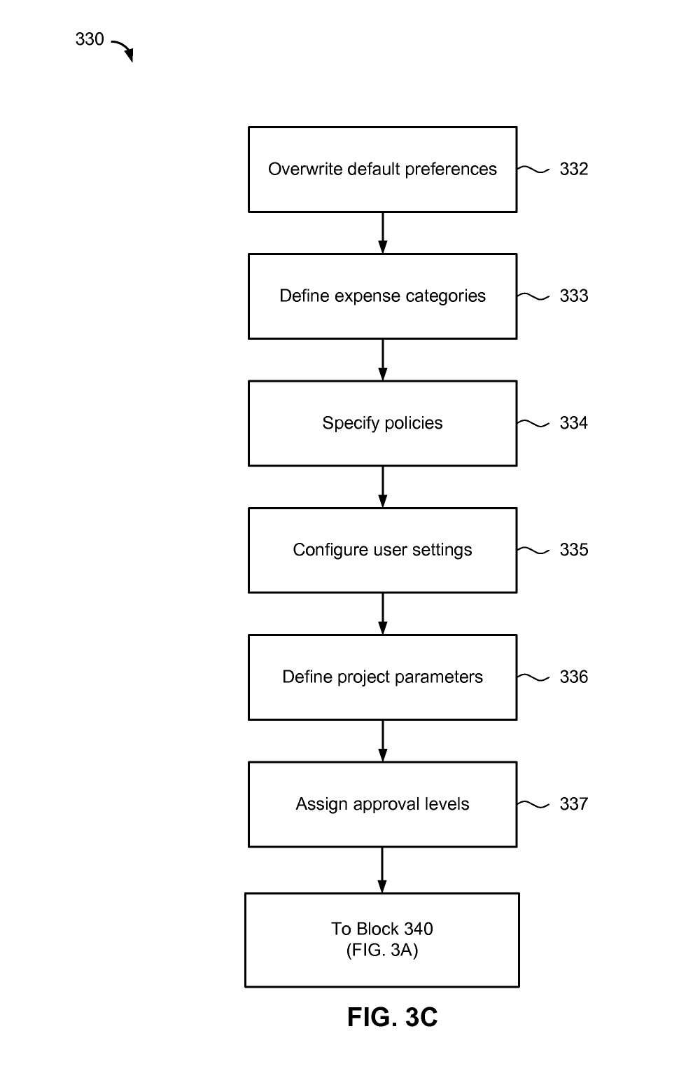

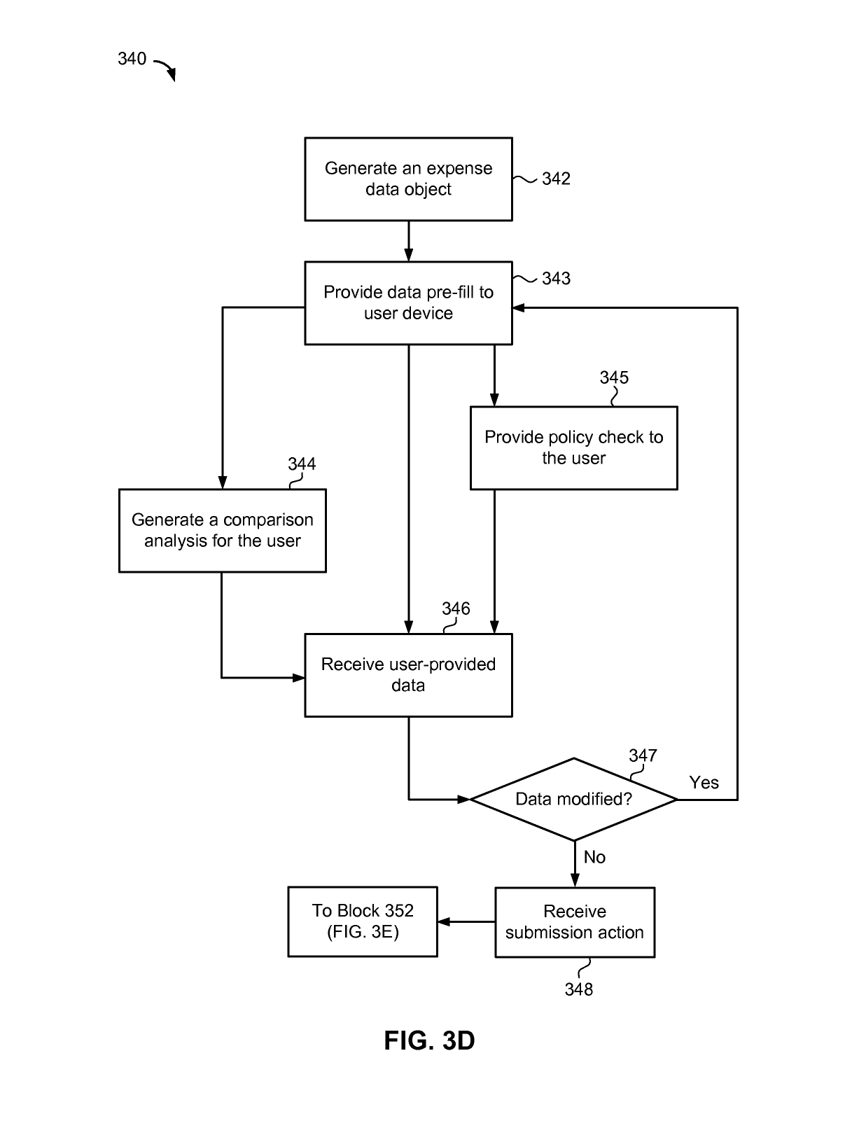

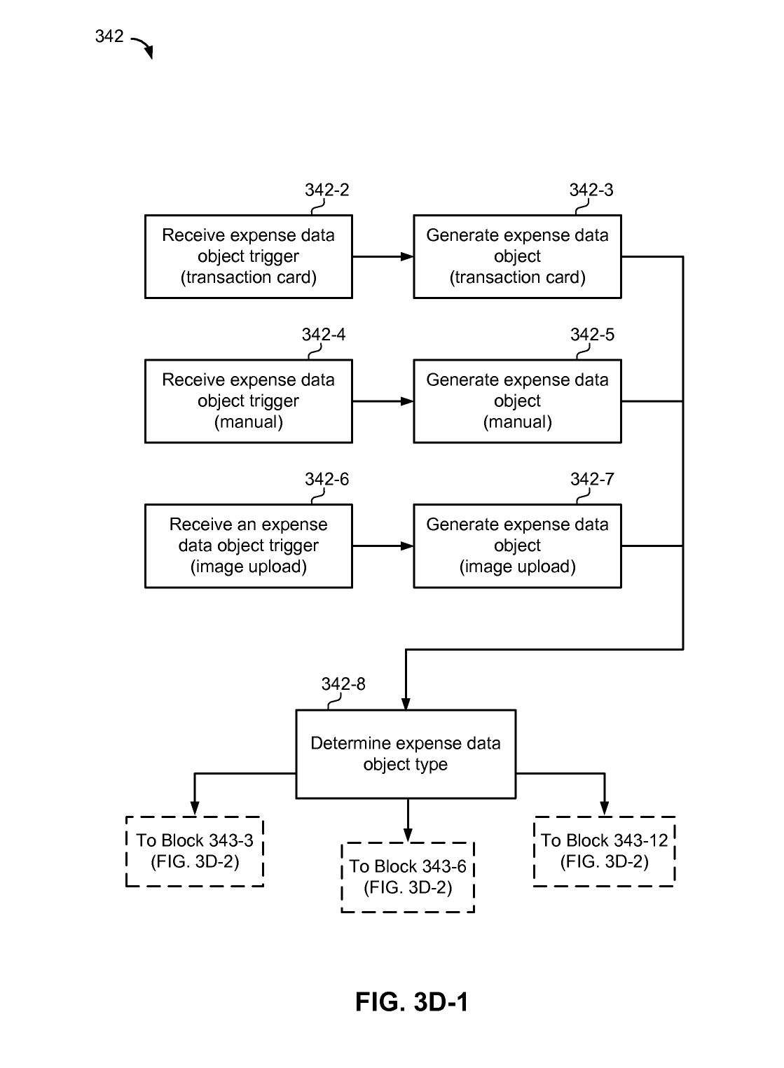

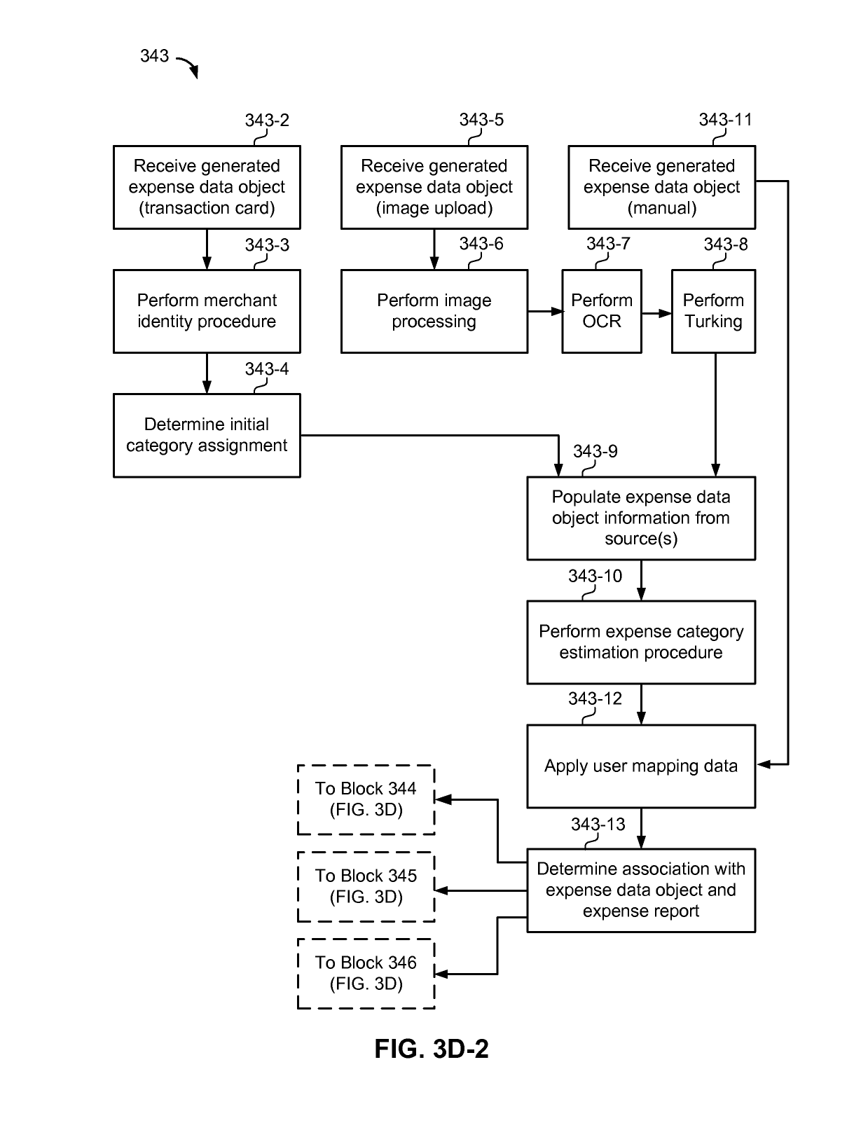

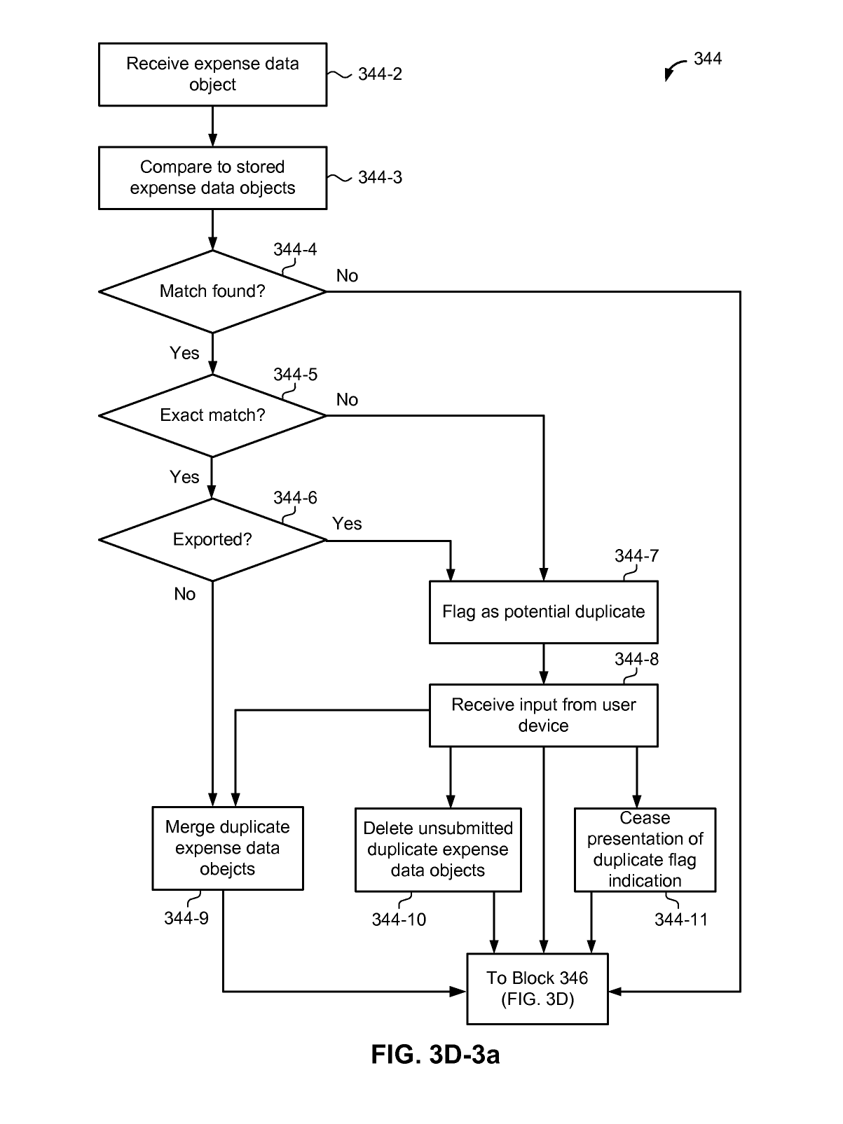

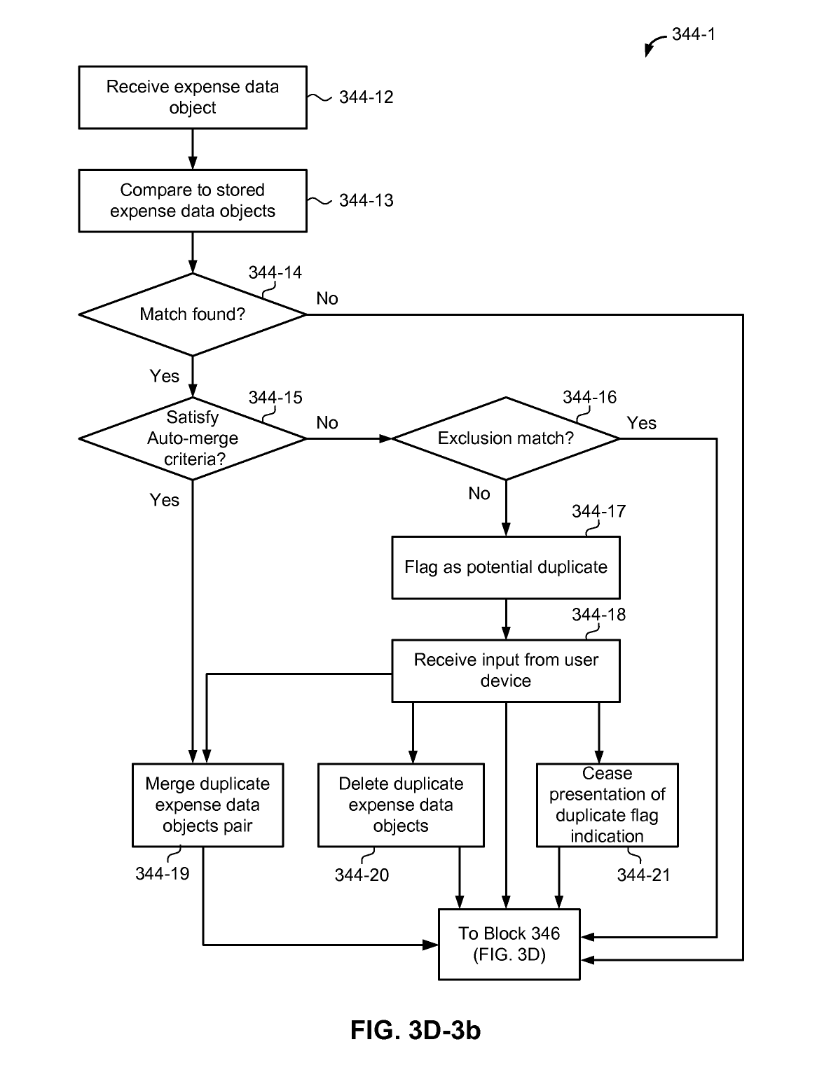

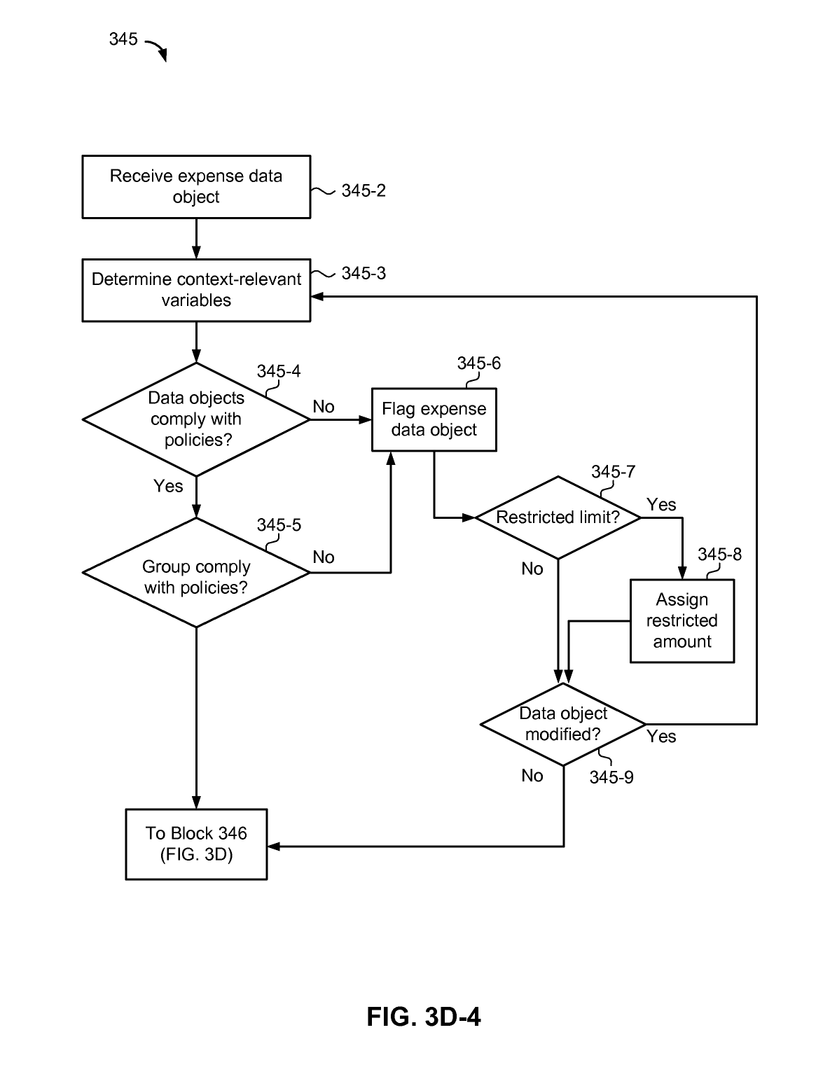

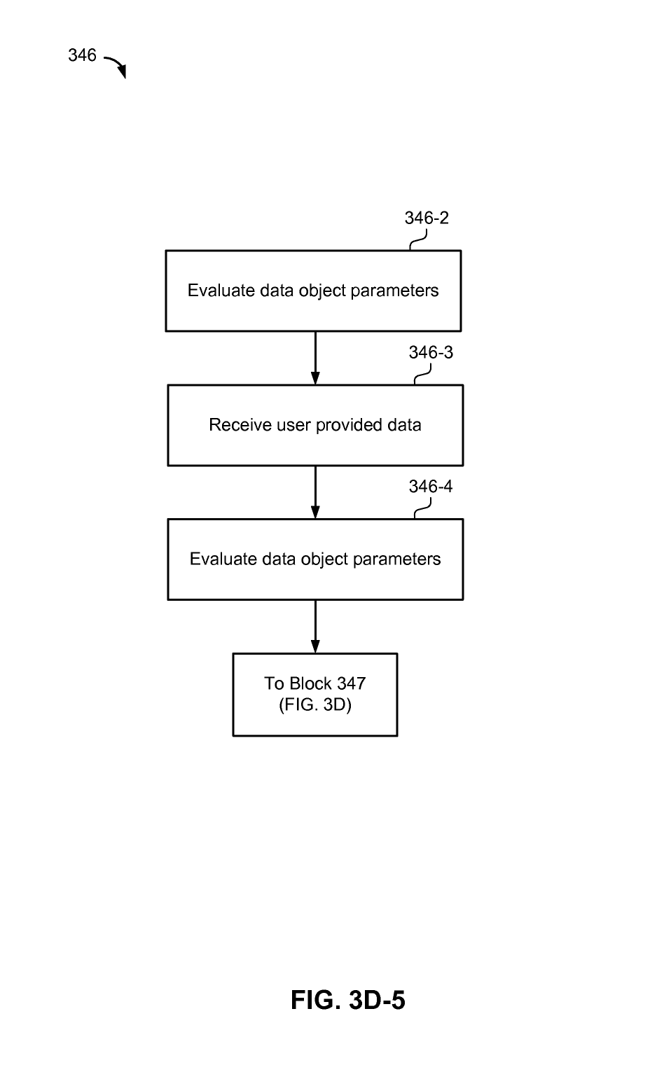

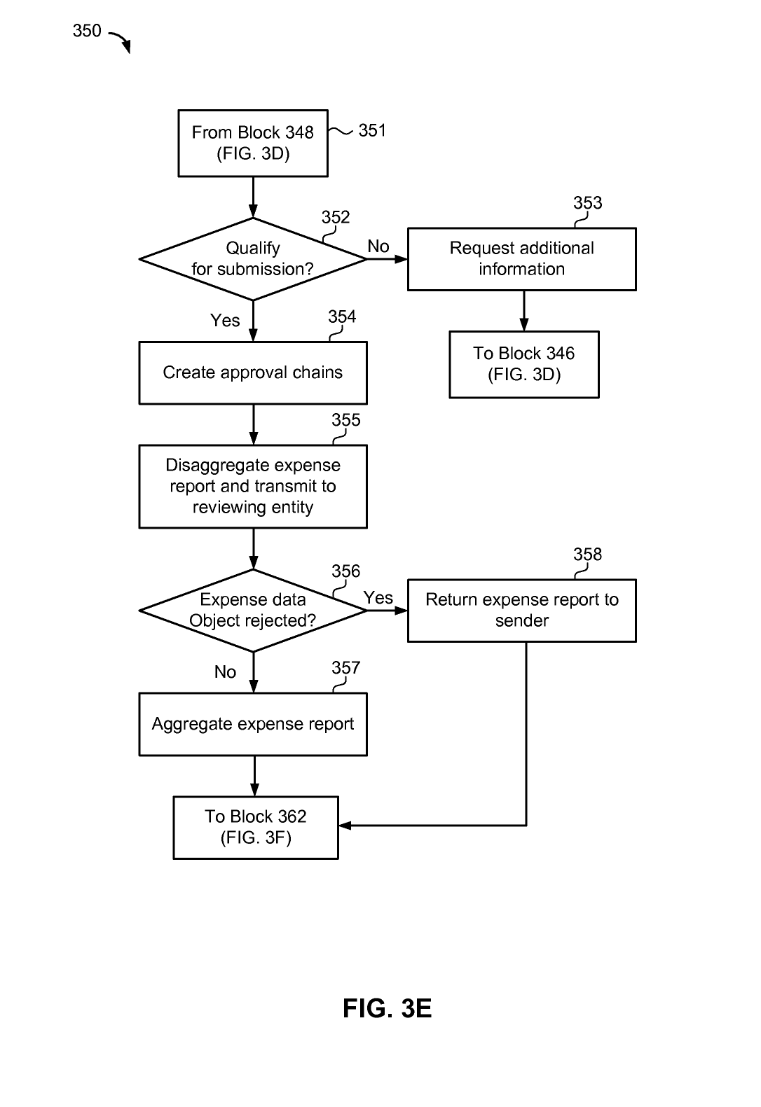

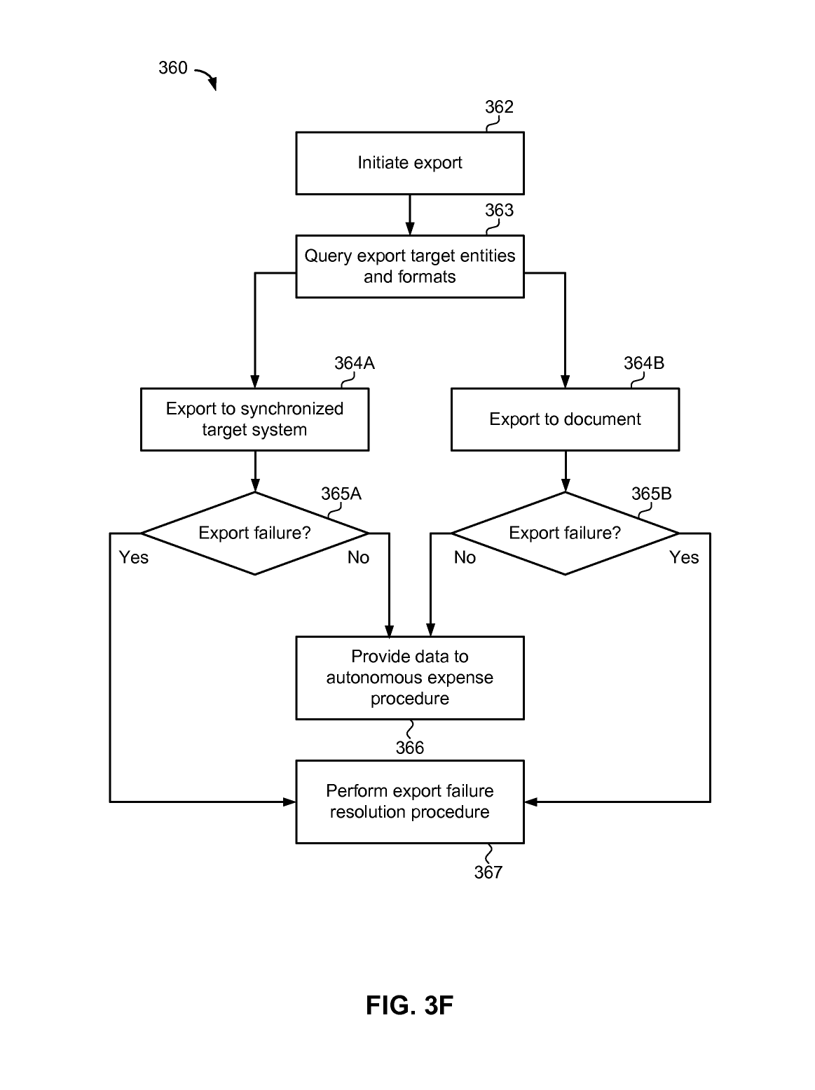

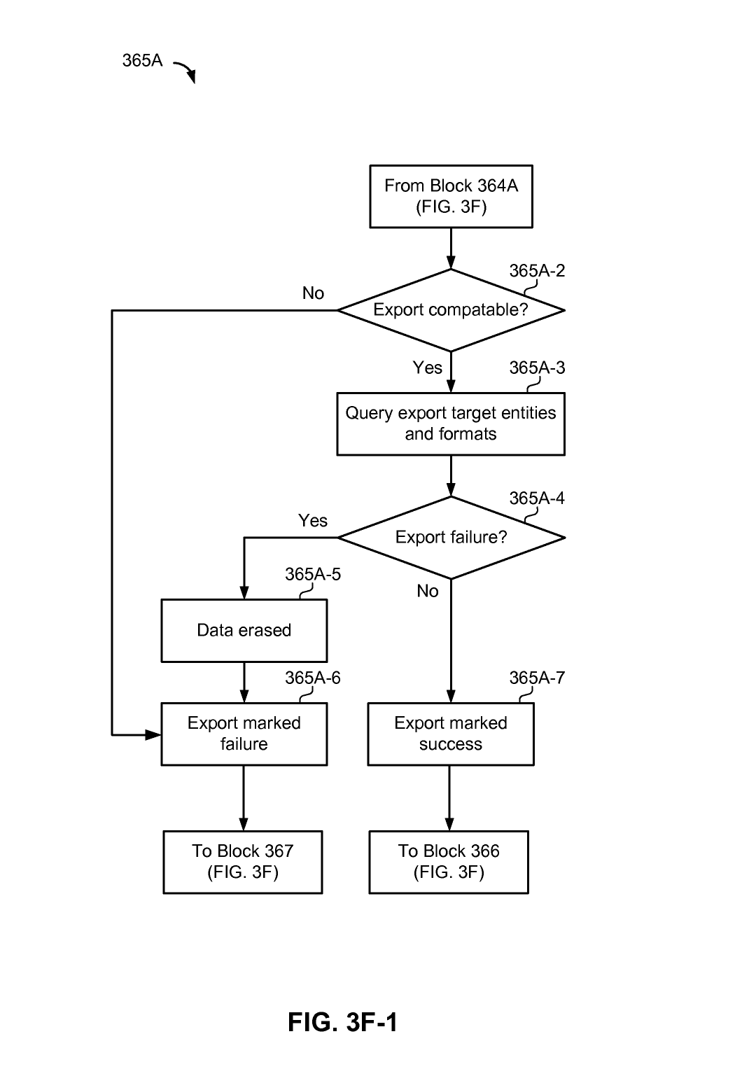

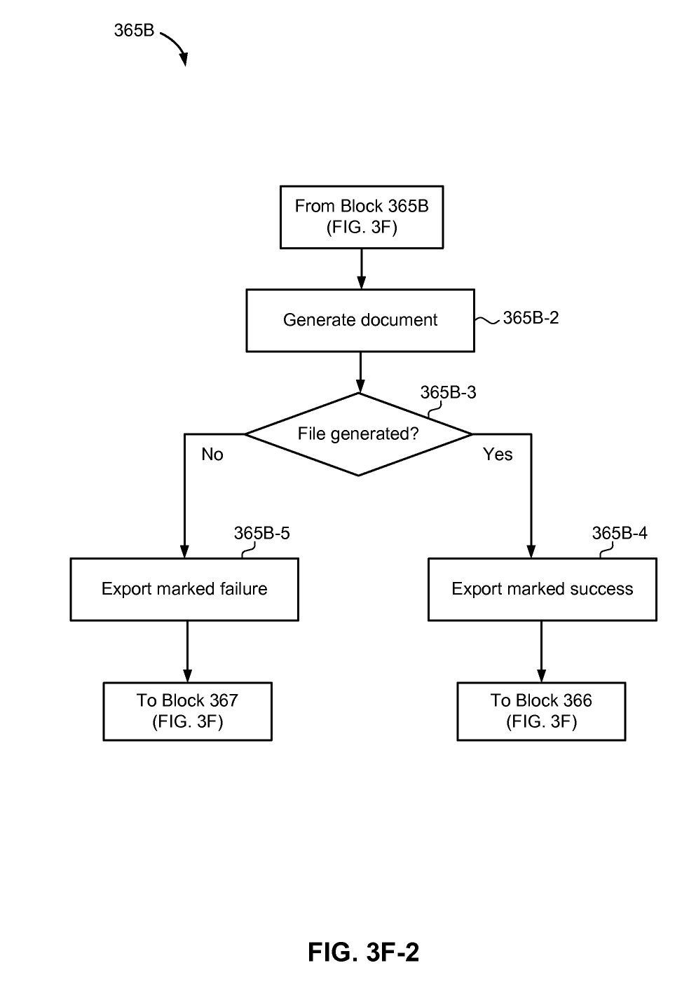

FIG. 3A is a flow diagram illustrating method 300 for expense processing, management, and reporting. Specifically, method 300 provides for collecting, categorizing, approving, and delivering electronic expense data in accordance with some embodiments. In some embodiments, method 300 may be performed at network entity 20 (FIGS. 1A and 1B) including one or more electronic access devices (e.g., modules and/or servers) as part of an automated workflow system. Some operations in method 300 may be combined, the order of some operations may be changed, and some operations may be omitted.

In some embodiments, functional blocks may include system synchronization (block 320), company and user configuration (block 330), expense item creation (block 340), approval (block 350), and export (block 360). In some embodiments, the blocks 340, 350, and 360 may be performed with reduced functionality that does not involve operation of blocks 320 and/or 330, for example.

At block 320, method 300 may synchronize with one or more target systems. For example, network entity 20 (FIGS. 1A and 1B) may be configured to execute one or more modules or components (e.g., one or more of synchronization modules 66-4, 66-6, 66-16, 66-17, FIG. 1B) to synchronize with one or more target systems. In some embodiments, system synchronization may include operations pertaining to coupling or connecting to one or more target systems, transfer of one or more expense parameter lists, and determination of preferences based on integration, which may be further described with reference to FIG. 3B.

At block 330, method 300 may define one or more organization and user configuration settings. For example, network entity 20 (FIGS. 1A and 1B) may be configured to execute one or more modules or components to define one or more organization and user configuration settings. In some embodiments, defining the organization and user configuration settings may include determining expense categories, specifying expense policies, configuring user settings, defining project parameters and assign monetary approval levels, for example, which may be further described with reference to FIG. 3C.

At block 340, method 300 may generate an expense data object. For example, network entity 20 (FIGS. 1A and 1B) may be configured to execute one or more modules or components to generate an expense data object. In some embodiments, generating the expense data object may include one or more of providing an electronic data structure representing the expense data objects having one or more pre-filled fields to a user, generating a comparison analysis for a user, providing a user policy check, or receiving user provided data, which may be further described with reference to FIGS. 3D, 3D-1, 3D-2, 3D-3a, 3D-3b, 3D-4 and 3D-5.

At block 350, method 300 may approve an expense data object. For example, network entity 20 (FIGS. 1A and 1B) may be configured to execute one or more modules or components to approve an expense data object. In some embodiments, approving an expense object includes qualifying an expense submission, disaggregating an expense report by expense data object, rejecting or approving an expense data object, and re-aggregating one or more expense data objects into the expense report, as further described in FIG. 3C.

At block 360, method 300 may export the expense data object. For example, network entity 20 (FIGS. 1A and 1B) may be configured to execute one or more modules or components to export the expense data object to a database and/or an autonomous expense procedure. In some embodiments, an export of an expense data object may include initiating export, validating transfer of the expense data object, generating destination parameters and providing parameters to the autonomous expense procedure (e.g., machine learning), as further described with reference to FIG. 3E.

FIG. 3A-1 is a flow diagram illustrating method 302 for modifying a set of expense data associated with the autonomous expense procedure based on generated expense data objects. In some embodiments, method 300 may be performed at network entity 20 (FIGS. 1A and 1B) including one or more electronic access devices (e.g., modules and/or servers) as part of an automated workflow system. Some operations in method 300 may be combined, the order of some operations may be changed, and some operations may be omitted.

At block 304, method 302 may determine a first set of expense data using an autonomous expense procedure and based in part on one or more expense parameters. For example, network entity 20 (FIGS. 1A and 1B) may be configured to execute one or more modules or components to determine a first set of expense data (e.g., learning data output by machine learning procedure) using an autonomous expense procedure (e.g., machine learning procedure) and based in part on one or more expense parameters.

In some embodiments, the first set of expense data may include one or more of a merchant indication (e.g., merchant identifier), a date indication (e.g., date of expense transaction and/or date expense data object received), an amount indication (e.g., expense amount in a given currency), a currency indication (e.g., dollars, euros, pounds), an expense category indication (e.g., an expense category associated with the expense data object), or a duplicate match indication (e.g., indication corresponding to whether a first expense data object matches a second expense data object). Additionally, the expense parameters may be user defined configuration parameters, policy parameters, and/or one or more of the parameters described in FIG. 3C.

In accordance with some embodiments, prior to determining the first set of expense data, method 302 may include receiving one or more of a defined expense category, an expense policy, a configured user settings, a defined object parameter, or an assigned monetary approval levels. In accordance with some embodiments, one or both of the expense policy or the assigned monetary approval levels are determined based on a policy engine.

At block 306, method 302 may receive one or more datasets each associated with a financial transaction record from a data storing entity. For example, network entity 20 (FIGS. 1A and 1B) may be configured to execute one or more modules or components to receive one or more datasets each associated with a financial transaction record from a data storing entity (e.g., accounting software residing on electronic device, camera, credit card processing entity).

In some embodiments, the one or more datasets may be expense information including one or more transaction records. For example, the one or more datasets may include one or more of a credit/debit card transaction record, a manually entered transaction record, or a transaction image record. In accordance with some embodiments, the data storing entity may include one or more of an accounting program, a camera, or a credit card processing entity.

Further, at block 308, method 302 may generate an expense data object for each of the one or more datasets in response to receiving the one or more datasets. For instance, network entity 20 (FIGS. 1A and 1B) may be configured to execute one or more modules or components to generate an expense data object for each of the one or more datasets in response to receiving the one or more datasets and based on the determined first set of expense data. In some embodiments, the one or more transaction records forming the one or more datasets may each be processed to determine, for example, a merchant identifier, a transaction amount, a category indication, and thereby used in generating the expense data object. In some embodiments, the expense data object may include the merchant identifier, transaction amount, and category indication.

At block 310, method 302 may transmit a resolution request indication (e.g., expense approval request) to an external electronic device associated with a reviewing entity. For example, network entity 20 (FIGS. 1A and 1B) may be configured to execute one or more modules or components to transmit a resolution request indication (e.g., expense approval request) to an external electronic device associated with a reviewing entity for one or more of the generated expense data objects. In some embodiments, the resolution request indication may be a message sent to a reviewing entity (e.g., approver) including a request to approve or deny the one or more expense data objects.

At block 312, method 302 may receive one or more resolution indications (e.g., approval/denial indications) for one or more of the generated expense data object from the external electronic device associated with the reviewing entity. For example, network entity 20 (FIGS. 1A and 1B) may be configured to execute one or more modules or components to receive one or more resolution indications (e.g., approval/denial indications) for one or more of the generated expense data object from the external electronic device associated with the reviewing entity.

At block 314, method 302 may adjust the first set of expense data to a second set of expense data using the autonomous expense procedure and based at least in part on receiving the one or more resolution indications. For example, network entity 20 (FIGS. 1A and 1B) may be configured to execute one or more modules or components to adjust the first set of expense data to obtain or otherwise form a second set of expense data using the autonomous expense procedure and based at least in part on receiving the one or more resolution indications.

In accordance with some embodiments, the second set of expense data may include one or more of a merchant indication, a date indication, an amount indication, a currency indication, an expense category indication, or a duplicate match indication. For example, the second set of expense data may include one or more adjusted or modified expense information relative to the first set of expense data (e.g., currency indication and/or merchant indication may be adjusted). In some embodiments, an adjustment of the first set of expense data to the second set of expense data may alter a generation and/or providing of pre-filled data of or associated with a subsequent expense data object.

As such, upon receiving a resolution request indication for one or more expense data objects, and to adjust the first set of expense data to the second set, method 302 may determine whether the resolution indication corresponds to or otherwise includes an approval indication. In accordance with a determination that the resolution indication corresponds to or otherwise includes an approval indication, at least a portion of the expense data forming the first set of expense data (e.g., merchant indication, a date indication, an amount indication, a currency indication, an expense category indication, or a duplicate match indication) may be adjusted to form or obtain the second set of expense data. Accordingly, subsequent generating of expense data objects and performance of one or more expense procedures (e.g., merchant identity procedure, autonomous expense procedure, expense category estimation procedure), may be based on the second set of expense data.

At block 316, method 302 may generate a second expense data object for a second dataset based on the second set of expense data. For example, network entity 20 (FIGS. 1A and 1B) may be configured to execute one or more modules or components to generate a second expense data object for a second dataset based on the second set of expense data. In some embodiments, the second expense data object is different from the first expense data object.

At block 318, method 302 may present the second expense data object for display to the external electronic device associated with the reviewing entity. For example, network entity 20 (FIGS. 1A and 1B) may be configured to execute one or more modules or components to present the second expense data object for display to the external electronic device associated with the reviewing entity. In accordance with some embodiments, presenting for display the second expense data object may include transmitting a second resolution request indication associated with the second expense data object to the external electronic device associated with the reviewing entity.

In accordance with some embodiments, the autonomous expense procedure may be a string distance determination process. In accordance with some embodiments, the autonomous expense procedure may be stored at one or more of the one or more electronic devices.

FIG. 3B is a flow diagram illustrating method 320 for synchronizing one or more datasets associated with a user account according to one or more transaction configuration parameters. For example, method 320 provides for the determination of preferences based on integration level with data storing entity. In some embodiments, method 320 may be performed at network entity 20 (FIGS. 1A and 1B) including one or more electronic access devices (e.g., modules and/or servers) as part of an automated workflow system. Some operations in method 320 may be combined, the order of some operations may be changed, and some operations may be omitted.

At block 322, method 320 may establish a connection with a data storage entity. For example, network entity 20 (FIGS. 1A and 1B) may be configured to execute one or more modules or components (e.g., communication module/component) to establishing a connection (e.g., via network 30, FIG. 1A) with a data storage entity that manages one or more datasets associated with a first account (e.g., account at data storage entity) according to one or more transaction configuration parameters (e.g., also referred to as list data). Further, in some embodiments, the connection with the data storage entity may be established on a periodic basis (e.g., once per hour, twice per hour, or at other intervals, such as every two hours) according to an identity of the data storage entity (e.g., specific organization/entity identifier). Additionally, the one or more datasets may be financial data including expense data.

In accordance with some embodiments, private access entity 50 may utilize network 30 to establish a connection with a data storage entity. In accordance with some embodiments, a dedicated communication link may establish a connection with a data storage entity. In accordance with some embodiments, prior to establishing a connection with a data storage entity, the data storage entity may be identified and one or more users may be authenticated with the data storage entity. A user may be authenticated using suitable identification credentials (e.g., password, encrypted token delivered via shared authentication protocols such as, but not limited to, OAuth or OpenID, or by way of one or more additional security parameters, which may include use of biometric identification). In some embodiments, the identity of the target entity/system may be confirmed after establishing a connection.

At block 323, method 320 may receive the one or more transaction configuration parameters from the data storage entity. For example, network entity 20 (FIGS. 1A and 1B) may be configured to execute one or more modules or components (e.g., communication module/component) to receive the one or more transaction configuration parameters from the data storage entity in response to establishing the connection with the data storage entity. In accordance with some embodiments, the transaction configuration parameters (e.g., list data) include parameters that allocate transactions according to one or more criteria and specific to the data storage entity. For instance, a first set of transaction configuration parameters associated with a first data storage entity may allocate, organize, and/or process expense data including transactions differently from a second set of transaction configuration parameters associated with a second data storage entity.

In some embodiments, the one or more transaction configuration parameters (e.g., list data) may be transferred from a data storing entity (e.g, target system) during, for example, complete system synchronization. In some embodiments, the one or more transaction configuration parameters may include parameters indicating or otherwise including dimensions utilized, for example, by an accounting system to process and allocate transactions in accordance with one or more accounting parameters (e.g., people, project, location, department, class, item, vendor, account, term, merchant, additional naming according to convention, and/or custom-configured fields).

At block 324, method 320 may obtain an integration level between the network entity and the data storage entity. For example, network entity 20 (FIGS. 1A and 1B) may be configured to execute one or more modules or components (e.g., first credit card transaction processing module 66-2, FIG. 1B) to obtain an integration level between the network entity and the data storage entity.

At block 325, method 320 may determine one or more account formation characteristics based on one or both of the one or more transaction configuration parameters or the integration level. For example, network entity 20 (FIGS. 1A and 1B) may be configured to execute one or more modules or components to determine one or more account formation characteristics (e.g., preferences) based on one or both of the one or more transaction configuration parameters or the integration level.

In accordance with some embodiments, to determine one or more account formation characteristics, network entity 20 (FIGS. 1A and 1B) may be configured to execute one or more modules or components to assign one or more billing preferences to the user. Further, in some embodiments, in order to assign one or more billing preferences to the user, network entity 20 (FIGS. 1A and 1B) may be configured to execute one or more modules or components to assign based in part on the one or more transaction configuration parameters.

In some embodiments, to determine the one or more account formation characteristics, one or more expense categories may be mapped to one or more datasets based on the account formation characteristics. Additionally, the one or more expense categories may be mapped according to a string distance determination process. In accordance with some embodiments, the mapping includes mapping the one or more expense categories according to a string distance process such as, but not limited to, the Jaro-Winkler process.

In some embodiments, the one or more account formation characteristics may be determined based, at least in part, upon system integration (e.g., integration level at block 324). In some embodiments, the determined preferences based, at least in part, on the integration level may include automated matching of general ledger accounts to system default expense categories, configuration of user access to one or more imported lists, automated creation of user accounts for vendors when email addresses match company domain rules, general feature preferences (e.g., currency and/or expense item data parameter requirements) and/or default export configurations, which may include target destinations and/or data parameter formatting. Further, expense categories may be mapped to general ledger accounts or to items to realize transaction records in target export destinations using, for example, a string distance process such as, but not limited to, the Jaro-Winkler process.

In accordance with some embodiments, network entity 20 (FIGS. 1A and 1B) may be configured to execute one or more modules or components to determine based on the one or more account formation characteristics on one or more of determining a match of one or more general ledger accounts to one or more expense categories, determining a configuration of a user access level to the one or more transaction configuration parameters, or determining one or more expense item data parameter requirements.

At block 326, method 320 may adjust an account, for example, associated with a user at the network entity based on the one or more account formation characteristics. For example, network entity 20 (FIGS. 1A and 1B) may be configured to execute one or more modules or components to adjust a second account associated with a user at network entity 20 (FIGS. 1A and 1B) based on the one or more account formation characteristics. In some embodiments, an adjustment made at block 326 may be sent from the data storing entity (e.g., target system) to network entity 20, or vice versa, via one of the sync modules. Further, in some embodiments, the first account, which may be associated with and/or stored at data storage entity (e.g., accounting system) may be different from the second account associated with and/or stored at network entity 20 (FIGS. 1A and 1B).

At block 327, method 320 may transmit one or more account characteristics of the adjusted second account to an external electronic device associated with the user. For example, network entity 20 (FIGS. 1A and 1B) may be configured to execute one or more modules or components to transmit one or more account characteristics of the adjusted second account to an external electronic device associated with the user. In some embodiments, the one or more account characteristics may include one or more transaction card profiles, assigned permissions, mapped accounting system entries, policy rules, or approval permissions.

At block 328, method 320 may determine whether one or more account characteristics have been modified. For example, network entity 20 (FIGS. 1A and 1B) may be configured to execute one or more modules or components to determine whether one or more account characteristics have been modified. In accordance with a determination that the one or more account characteristics have been modified, method 320 may return to block 326. Otherwise, in accordance with a determination that the one or more account characteristics have not been modified, method 320 may proceed to block 332 (FIG. 3C).

In some embodiments, the one or more account characteristics may include one or more of the transaction configuration parameters (e.g., list data). In accordance with some embodiments, network entity 20 (FIGS. 1A and 1B) may be configured to execute one or more modules or components to form the account associated with the user at the network entity, receive one or more indications of an adjustment of the one or more account formation characteristics, and adjust/update the second account based on the one or more adjusted account formation characteristics.

In some embodiments, a modification to the account characteristics may include changes to one or more parameters, deletion of one or more parameters, addition of one or more parameters, parameter archiving, parameter un-archiving, and adjustments to parameters in any other way in either the target system or network entity 20, for example. In some embodiments, network entity 20 (FIGS. 1A and 1B) may be configured to execute entity sync status module 66-14 (FIG. 1B) may be used to detect changes made in network entity 20. Further, changes may be detected utilizing a variety of other approaches. For example, periodic job scheduling module 66-11 (FIG. 1B) may be configured to initiate regularly scheduled transaction configuration parameter (e.g., list data parameter) checks in a data storing entity (e.g., target system) conducted by a respective synchronization module systems dependent on the data storing entity (e.g., target system).

In some embodiments, the module controlling and/or directing connection to a target module/system as well as subsequent synchronization and/or export actions may be dependent on the data storing entity (e.g., target system). For example, network entity 20 (FIGS. 1A and 1B) may be configured to execute second external synchronization module 66-6 (FIG. 1B) to interface with a first class of one or more accounting systems that include a first set of accounting parameters. In another example, network entity 20 (FIGS. 1A and 1B) may be configured to execute fourth external synchronization module 66-17 (FIG. 1B) to interface with a second class of one or more accounting software systems that include a second set of accounting parameters.

FIG. 3C is a flow diagram illustrating method 330 for configuring account formation characteristics. In some embodiments, method 330 may be performed at network entity 20 (FIGS. 1A and 1B) including one or more electronic access devices (e.g., modules and/or servers) as part of an automated workflow system. Some operations in method 330 may be combined, the order of some operations may be changed, and some operations may be omitted.

In some embodiments, operations and procedures of method 300 (FIG. 3A) may function to retrieve information (e.g., company and user preferences parameters) gathered in method 330. In some instances, network entity 20 (FIGS. 1A and 1B) may be configured to execute one or more modules or components to define company and user preferences that include one or more aspects (e.g., assignment of approvers, and/or specification of company policies) that forms a basis for functionality in operations and procedures. Further, in some embodiments, the assignment of approvers/reviewing entities and the specification of company policies may include one or more rule engines.

At block 332, method 330 may overwrite default account formation characteristics. For example, network entity 20 (FIGS. 1A and 1B) may be configured to execute one or more modules or components to overwrite default account formation characteristics (e.g., company and user preferences). In some embodiments, account formation characteristics determined at block 325 (FIG. 3B) may be overwritten and/or re-configured.

At block 333, method 330 may define or determine expense categories. For example, network entity 20 (FIGS. 1A and 1B) may be configured to execute one or more modules or components to define or determine one or more expense categories. In some embodiments, defining expense categories may include creating, editing, or deleting default categories, mapping one or more expenses to accounts or items, assigning expenses to a general type, specifying custom expense-related fields, restricting by groups, and the like. In some instances, general expense category types may be determined by way of a defined list of expense category varieties (e.g., travel, postage, marketing collateral, business entertainment). It should be appreciated that expense types may be used to configure specific control and direction of expense categories assigned to a type without regard to a category's account-configured name. For example, an administrator may configure an interface for parameter entry of network entity 20 (FIGS. 1A and 1B) to comply with entities/government agencies guidelines and/or policies.

In some embodiments, expense categories may include one or more configurable fields. For example, a configurable field (e.g., an attendee field to an entertainment category type may be assigned in order to comply with entities/government agencies or internal control reporting standards) for expense categories. In some embodiments, one or more fields may be specified upon creation or defining of the expense category. In some embodiments, one or more groups (e.g., a list of expense submitters and a list of expense categories) may be formed as part of the expense category determination or assignment that permit or restrict access to particular expense categories. In some instances, an expense submitter or network entity 20 (FIGS. 1A and 1B) may assign or attribute an expense item to a category if the submitter is included in a group within a given category (e.g., a group-to-category mapping).

At block 334, method 330 may specify policies. For example, network entity 20 (FIGS. 1A and 1B) may be configured to execute one or more modules or components (e.g., asynchronous web operations module 66-3, FIG. 1B) to specify one or more expense policies (e.g., applying rules, selecting outcomes, and setting required fields). In some embodiments, one or more policies may be specified when determining an expense category and may apply to some or all expenses that are submitted within a particular category or across multiple categories. In some embodiments, policies may be established based, at least in part, on an expense, on the amount of an expense, and/or whether an expense is intended to be billed to a client, for example. It should be appreciated that these policies may be specified on an individual expense basis or these policies may be specified across a group of expenses.

In some embodiments, when specifying policies across a group of expenses, network entity 20 (FIGS. 1A and 1B) may be configured to execute one or more modules or components to utilize an aggregation mechanism to analyze variables associated with one or more policy specifications. Further, in some embodiments, policies may be specified based, at least in part, on external factors (e.g., a date range, location, submitting user, etc.). Additionally, one or more rules engines may be used to adjust policy specification requirements based on the external factors. In some embodiments, outcomes associated with a policy violation may be provided (e.g., simple flagging of a violation for submitter, approver, and/or administrator, restriction from submission of a violating expense until violation is resolved, and/or partial reimbursement of a violating expense up to a predefined limit).

At block 335, method 330 may configure user settings. For example, network entity 20 (FIGS. 1A and 1B) may be configured to execute one or more modules or components to configure user settings (e.g., feature access, approvers, credit cards and export rules). In some embodiments, varying degrees of user access may be granted to users (e.g., access, including but not limited, to expense submission, expense approval, access to company-wide expense data, expense export, and system administration). In some instances, access to expense submission may be further restricted by limiting a user's access to a subset of the company's list data (e.g, including, but not limited to, expense categories, projects, departments, and/or classes).

In some embodiments, user accounts may be granted for one or more credit card profiles. Additionally, a direct connection, a credit card profile, may be established via a credit card data aggregation modules provider or credit card module provider, which may later provide a real-time list of credit card transactions associated with a credit card account. In some instances, the profile may be configured for compatibility with one or more transaction import preferences, which may include importing transactions as expense items.

In some embodiments, as expense items are incurred, expense items may be automatically imported in real-time or substantially in real time (auto-import) and/or provisioning a profile with transactions as they are incurred, which may rely, at least in part, on a user to select and import targeted transactions. For example, first credit card transaction processing module 66-2 (FIG. 1B) may be configured to control and/or direct transaction/credit card connections.

In addition, one or more profiles may be generated manually by providing basic account details and supplementing a profile with one or more uploaded transaction lists. In some embodiments, second credit card transaction processing module 66-18 (FIG. 1B) may be configured control and/or direct manual card profiles and related transaction file parsing. In some instances, an individual user or by way of an account administrator on a user's behalf may create one or more credit card profiles. Further, credit card reassignment module 66-19 (FIG. 1B) may be configured to control and/or direct management of transaction cards assigned to one or more other users.

In some embodiments, one or more credit card profiles may be designated as either reimbursable (e.g., a personal card used by an individual to incur expenses on behalf of the company for later reimbursement) or as non-reimbursable (e.g., a company issued card for business use). For example, designations may trigger a custom set of export preferences for expense items incurred on cards of various types (e.g., reimbursable, non-reimbursable, and so forth).

Further, export preferences may be assigned to an individual user, for example, to override a configured export preference for a company account. In some instances, overriding may result in custom target destination providing control and/or direction for expenses incurred in a user account. It should be appreciated that some export preferences may be supported by mapping a user to a vendor record in a target destination location.

At block 336, method 330 may define project parameters. For example, network entity 20 (FIGS. 1A and 1B) may be configured to execute one or more modules or components to define one or more project parameters (e.g., approval rules, default status of expense items as billable to clients and allowed expense submitter).

At block 337, method 330 may assign approval levels. For example, network entity 20 (FIGS. 1A and 1B) may be configured to execute one or more modules or components to assign one or more monetary approval levels (e.g., creation of levels and assignment of levels to one or more users). For example, assignment of monetary approval levels may include creation or determination of levels and assignment of levels to one or more users.

In some embodiments, the reviewing entity may be referred as approvers. In some embodiments, one or more approvers may be assigned to a user or to a project, or a combination thereof. Further, one or more default approvers may be assigned to one or more users when approvers have not been specified or globally for all expenses submitted within a company account. Additionally, one or more approvers may be assigned to a specific set of expenses, such as expenses assigned to a project. In some embodiments, an approver may be assigned to expenses as the expenses relate to a configurable amount threshold.

In some embodiments, one or more approvers may be specified or identified as alternates of one another when more than one approver is assigned for any type of approval. The foregoing may permit any single member of the group to approve a variety of transactions. In some embodiments, approvers may be specified as additions to one another for instances where approval is required for all members of a group.

FIG. 3D is a flow diagram illustrating method 340 for expense data object generation. In some embodiments, method 340 may be performed at network entity 20 (FIGS. 1A and 1B) including one or more electronic access devices (e.g., modules and/or servers) as part of an automated workflow system. Some operations in method 340 may be combined, the order of some operations may be changed, and some operations may be omitted.

At block 342, method 340 may generate an expense data object. For example, network entity 20 (FIGS. 1A and 1B) may be configured to execute one or more modules or components to generate one or more expense data objects. In some embodiments, a number of expense data object generation triggers (e.g., a credit/debit card transaction, an image upload, and/or or manual entry) may initiate or otherwise trigger the generation of an expense data object. An expense data object generation trigger may be initiated from a variety of sources, including but not limited to, a web browser, a credit card data module provider, a mobile app, and/or an e-mail.

At block 343, method 340 may provide data pre-fill to a user device. For example, network entity 20 (FIGS. 1A and 1B) may be configured to execute one or more modules or components to provide data pre-fill to a user device. In some instances, the source for the data pre-fill may be provided from credit card data, turking, optical character recognition, category estimation procedure, user mapped data, and/or report rules, for example.

In some embodiments, the data/information provided to the user may include, for example, data pre-fill of particular fields (e.g., name, project name, department, location etc.), comparison analysis, and/or comparison with one or more applicable policies. Further, after completion of providing the data pre-fill, including during an automated process, a user may edit, adjust, update and/or augment parameters provided by a user or data pre-fill, for example.

Method 340 may proceed to one or more of blocks 344, 345, and/or 346 following block 343. For example, at block 344, method 340 may generate a comparison analysis for a user. For example, network entity 20 (FIGS. 1A and 1B) may be configured to execute one or more modules or components to generate a comparison analysis (e.g., confident merging and/or non-confident flagging) for a user. Upon generating the comparison analysis, method 340 may proceed to block 346.

At block 345, method 340 may provide a policy check to a user. For example, network entity 20 (FIGS. 1A and 1B) may be configured to execute one or more modules or components to provide a policy check to a user that may be based on a single expense data object, a group of expense data objects, and/or context-dependent variables of expense data objects. Upon providing the policy check to the user, method 340 may proceed to block 346.

At block 346, method 340 may receive user-provided data. For example, network entity 20 (FIGS. 1A and 1B) may be configured to execute one or more modules or components to receive user-provided data. For example, the user-provided data may include one or more numeric values entered into any expense data object data field through an user interface such as a web browser and/or a native mobile application.

At block 347, method 340 may determine whether one or more data objects have been modified. For example, network entity 20 (FIGS. 1A and 1B) may be configured to execute one or more modules or components to determine whether one or more data objects provided by the user have been modified. In accordance with a determination that the one or more data objects have been modified, method 340 may return to block 343. Otherwise, in accordance with a determination that the one or more data objects have not been modified, method 340 may proceed to block 348.

At block 348, method 340 may receive submission action. For example, network entity 20 (FIGS. 1A and 1B) may be configured to receive submission action. Once the submission action is received, method 340 may proceed to block 352 (FIG. 3E).

In some embodiments, the edits or modifications to data objects may include one or more changes, adjustments, updates, and/or or augmentations to expense data object parameters. In accordance with some embodiments, the data object or data object parameters may be edited without user interaction. That is, the edits or modifications may be conducted by an electronic device or as part of network entity 20 (FIGS. 1A and 1B). Further, a user interface may be provided to the user where the user may edit the data objects or data object parameters. It should be appreciated that because the modules of network entity 20 (FIGS. 1A and 1B) may function asynchronously, after completion of data pre-fill, a user may edit, update and/or augment parameters provided by a user or data pre-fill. It should also be appreciated that editing, updating and/or augmenting parameters provided by a user may initiate a repeat of some of the method 340, such as, for example, a comparison analysis (e.g., confident merging and/or non-confident flagging), and/or a policy checking module.

FIG. 3D-1 is a flow diagram illustrating method 342 for expense data object generation. In some embodiments, method 342 may be performed at network entity 20 (FIGS. 1A and 1B) including one or more electronic access devices (e.g., modules and/or servers) as part of an automated workflow system. Some operations in method 342 may be combined, the order of some operations may be changed, and some operations may be omitted.

At block 342-2, method 342 may receive a transaction expense item trigger associated with or corresponding to, a financial account. In some embodiments, the financial account may be or may include, a bank account, a trust account, and a transaction card, which may in turn may be a credit card, debit card, or stored value card. For example, network entity 20 (FIGS. 1A and 1B) may be configured to execute one or more modules or components to receive a credit card transaction expense item trigger (e.g., an indication of a credit/debit card). In some embodiments, a credit card transaction expense item trigger may be received without user input (e.g., through a credit card data aggregation modules provider or credit card module provider as the charge is incurred such as auto-import). For instance, when a user books a hotel accommodation using a credit card, a record of the transaction may be directly communicated and/or posted to one or more modules/components of network entity 20 (FIGS. 1A and 1B).

Subsequently, at block 342-3, method 342 may generate an expanse data object. For example, network entity 20 (FIGS. 1A and 1B) may be configured to execute one or more modules or components to generate expanse data object (e.g., associated with a credit/debit card).

At block 342-4, method 342 may receive an expense item trigger via, for example, a user interface. For example, in response to a user editing, updating and/or augmenting parameters at a user interface (e.g., manual entry), network entity 20 (FIGS. 1A and 1B) may be configured to execute one or more modules or components to receive an expense item trigger. In some embodiments, an expense data object may be manually triggered through user action involving at least one interface (e.g., web browser and native mobile apps). For example, in some embodiments, an expense data object associated with a credit card transaction may be triggered in response to a user manually selecting, at a user interface, from a list provided by a credit card parameter aggregation modules provider or credit card module provider (e.g., manual import of credit card transaction parameters).

At block 342-5, method 342 may generate an expense data object. For example, network entity 20 (FIGS. 1A and 1B) may be configured to execute one or more modules or components to generate the expense data object received at block 342-4. It should be appreciated that manual-type expense data objects may include a variety of formats (e.g., cash expenses, fixed-rate expenses and mileage expenses) depending on the expense category selected by the user.

At block 342-6, method 342 may receive an expense item trigger via, for example, an image upload or transfer. For example, in response to uploading an image (e.g., image upload), network entity 20 (FIGS. 1A and 1B) may be configured to execute one or more modules or components to receive an expense item trigger. In some embodiments, an image upload expense data object may be triggered by an upload of an image or PDF file to a web browser interface, for example. In some embodiments, an image upload expense data object may be triggered by the generation of an image from the text of a forwarded email or an image attachment from a forwarded email. In some embodiments, an image upload expense data object may be triggered by capture of a photo within a native mobile app or upload of a photo from a photo library within a native mobile app.

Subsequently, at block 342-7, method 342 may generate an expense data object. For example, in response to uploading an image (e.g., image upload), network entity 20 (FIGS. 1A and 1B) may be configured to execute one or more modules or components to generate an expense data object in or corresponding to the image upload.

After generating one or more expense data objects, at block 342-8, method 342 may determine expense data object type. For example, network entity 20 (FIGS. 1A and 1B) may be configured to execute one or more modules or components to determine the expense data object type. Once the expense data object type is determined, method 342 may proceed to either block 343-3 (FIG. 3D-2), 343-6 (FIG. 3D-2), 343-12 (FIG. 3D-2).

Further, one or more modules/components of network entity 20 (FIGS. 1A and 1B), may be dependent upon an interface used to access the system (e.g., network entity 20, FIGS. 1A and 1B) if and when accessing via a native mobile app or any other API-enabled interface, for example. In some embodiments, client application program interface module 60-4 may be utilized to access the system. Additionally, if accessing via a web browser, either on a desktop, laptop, mobile phone or other device, for example, web interface module 60-3 may be utilize the system.

In accordance with some embodiments, modules or components of network entity 20 (FIGS. 1A and 1B) may be configured to execute and utilizes a combination of blocks 342-2 through 342-8. For example, in some embodiments, method 342 may utilize first credit card transaction processing module 66-2 (FIG. 1B) to trigger and generate a credit card transaction expense data object. Further, in some embodiments, method 342 may use block 342-2 (e.g., auto-import) in conjunction with block 342-4 (e.g., manual import) to trigger the generation of a credit card transaction expense data object. Further, in some embodiments, a credit card transaction expense data object may be triggered manually by uploading a credit card transaction file and selecting transactions for import and may include manually uploading a credit card transaction file. Further, in some embodiments, a file upload method of triggering a credit card transaction expense data object may be enabled by second credit card transaction processing module 66-18 (FIG. 1B).

In some embodiments, method 342 may automatically obtain one or more expense data objects and/or triggers based on stored expense data objects. For example, method 342 may actively monitor and automatically determine whether an expense data object that was received was subsequently deleted and/or whether an expense data object that was not automatically obtained was nonetheless entered or provided manually by the user. Accordingly, method 342 may, as part of the autonomous expense procedure, identify and learn which expense data objects associated with one or more transactions are entered and/or removed directly by the user. As such, future expense data objects having similar characteristics (e.g., merchant name/identifier string) may be automatically obtained from a transaction source (e.g., credit card data feed). In some embodiments, the one or more characteristics may be a merchant identifier.

FIG. 3D-2 is a flow diagram illustrating method 343 for providing data pre-fill to a user device. In some embodiments, method 343 may be performed at network entity 20 (FIGS. 1A and 1B) including one or more electronic access devices (e.g., modules and/or servers) as part of an automated workflow system. Some operations in method 343 may be combined, the order of some operations may be changed, and some operations may be omitted.

At block 343-2, method 343 may receive a generated expense data object. For example, network entity 20 (FIGS. 1A and 1B) may be configured to execute one or more modules or components to receive a generated expense data object (e.g., expense item) having a first merchant identifier.

Further, in some embodiments, method 343 may also, as part of block 343-2, determine whether the expense data object having the first merchant identifier includes a transaction source indication (e.g., credit/debit card). In accordance with some embodiments, the transaction source indication of first merchant identifier may be one of a credit card indication or a debit card indication. In some embodiments, the generated expense data object having the first merchant identifier (e.g., merchant name) may be received from a credit card parameter aggregation module provider or credit card module provider.

At block 343-3, method 343 may perform a merchant identity procedure using, for example, the generated expense data object. For example, network entity 20 (FIGS. 1A and 1B) may be configured to execute one or more modules or components to perform a merchant identity procedure (e.g., character scrubbing procedure) on the first merchant identifier of the expense data object to obtain a second merchant identifier associated with the expense data object based on a determination that the expense data object includes the transaction source indication.

In accordance with some embodiments, performing the merchant identity procedure may include modifying (e.g., removing) a portion of the first merchant identifier based on one or more filtering characteristics to obtain the second merchant identifier. Specifically, the merchant identity procedure may include determining that a portion of the first merchant identifier includes one or more characters qualifying for removal. In some embodiments, as part of the determination, the merchant identity procedure may identify one or more portions of the first merchant identifier for removal. Additionally, the second merchant identifier may be stored while maintaining a record of the first merchant identifier.

In accordance with some embodiments, the one or more filtering characteristics may include one or both of a readability characteristic or a character repetition characteristic. Further, the merchant identity procedure may be based, at least in part, on human readability and/or repeating characters. For instance, in some embodiments, the merchant identity procedure may erase or hide extraneous tracking or contact information. In some embodiments, the merchant identity procedure may remove extraneous characters and/or text of the first merchant identifier.

In an example not to be construed as limiting, a string of characters forming the first merchant identifier (and part of the expense data object) may be received from transaction card provides (e.g., aggregated credit card data provider) or an uploaded transaction file (e.g., expense data including one or more expense data objects). For instance, the first merchant identifier may include the string “****Merchant???**”, where the characters adjacent the term “Merchant” may be considered extraneous and not part of the merchant name or identifier. The merchant identity procedure may identify and remove substrings or portions of the received string based on one or more filtering characteristics including rules identified from patterns across transaction file merchant strings.

In some embodiments, the substrings may include cities, states, asterisks, store numbers, phone numbers, or other extraneous characters not part of the merchant identifier. As such, the merchant identity procedure may identify the extraneous substrings in “****Merchant???** to obtain the second merchant identifier including the modified string “Merchant”. Further, network entity 20 (FIGS. 1A and 1B) may store a record of both the original string of the first merchant identifier and the modified string forming the second merchant identifier.

At block 343-4, method 343 may determine an initial category assignment. For example, network entity 20 (FIGS. 1A and 1B) may be configured to execute one or more modules or components to determine an initial category assignment for the expense data object having the second merchant identifier based on performing the merchant identity procedure. In accordance with some embodiments, the initial category assignment may be determined based on a merchant categorization code associated with a transaction card entity (e.g., credit card) and/or a system categorization code provided by a transaction card entity. Further, network entity 20 (FIGS. 1A and 1B) may be configured to execute the first credit card transaction processing module 66-2 (FIG. 1B) to provide an initial category assignment when a card profile is established via direct connection or manually established via a user interface.

Additionally, upon performing the merchant identity procedure at block 343-3 and/or upon determining an initial category assignment at block 343-4, method 343 may determine a first set of expense output data (e.g., learning data output by machine learning procedure) using an autonomous expense procedure (e.g., machine learning procedure). For example, the second merchant identifier of the expense data object may be provided to the autonomous expense procedure to adjust/update a set of expense output data. In some embodiments, the autonomous expense procedure may be based in part on one or more expense parameters (e.g., user defined configuration, policy, and/or parameters). Following a determination of the initial category assignment, method 343 may proceed to block 343-9 to populate expense data object information from one or more sources.

At block 343-5, method 343 may receive a generated expense data object associated with, or otherwise in the form of, for example, an image upload. For example, network entity 20 (FIGS. 1A and 1B) may be configured to execute one or more modules or components to receive a generated expense data object associated with, for example, an image upload).

Further, at block 343-6, method 343 includes performing image processing. For example, network entity 20 (FIGS. 1A and 1B) may be configured to execute one or more modules or components to perform image processing on the received image upload of the generated expense data object. In some embodiments, imaging processing techniques may include one or more of rotating the uploaded image or enhancing the quality of an image (e.g., convolution edge detection, mathematics, filters, trend removal, and image analysis).

At block 343-7, method 343 may perform optical character recognition (OCR) on the uploaded image received at block 343-5 or the processed image from block 343-6. For example, network entity 20 (FIGS. 1A and 1B) may be configured to execute one or more modules or components to perform optical character recognition on the uploaded image received at block 343-5 or the processed image from block 343-6. In some embodiments, performing optical character recognition may extract data object parameters (e.g., merchant name/identifier, transaction date, and/or expense amount parameters such as total and/or tip). Further, a confidence rating may be assigned based, at least in part, on a likelihood of correctness of the pre-filled expense parameters extracted when performing optical character recognition. In some embodiments, receipt processing module 66-1 (FIG. 1B) of network entity 20 (FIGS. 1A and 1B) may be configured to perform optical character recognition.

At block 343-8, method 343 may perform turking. For example, network entity 20 (FIGS. 1A and 1B) may be configured to execute one or more modules or components to perform turking on the image of the generated expense data object. In some embodiments, the term “turking” may refer to a service that converts images of typed, handwritten or printed text into machine-encoded text that is relayed to an interface connected to network entity 100 (e.g. receipt processing module 66-1, FIG. 1B). This may involve user intervention to interpret, transcribe, and/or review the text to ensure a high degree of accuracy. In some embodiments, performing turking may provide data object parameters (e.g., merchant name, transaction date, and/or expense amount parameters such as total and/or tip). In some embodiments, receipt processing module 66-1 (FIG. 1B) of network entity 20 (FIGS. 1A and 1B) may be configured to perform or otherwise facilitate the performance of turking.

It should be appreciated that prefilled parameters of an image upload expense data object may be replaced or augmented. For instance, some embodiments may include an external receipt processing module that interfaces with network entity 20 (FIGS. 1A and 1B) and provides a merchant, transaction date, transaction amount, and/or other receipt parameters using, for example, a receipt processing module's proprietary process.

At block 343-9, method 343 may populate the expense data object information from at least one source. For example, network entity 20 (FIGS. 1A and 1B) may be configured to execute one or more modules or components to populate one or more data fields of the expense data object based on one or both of the merchant identity procedure or the initial category assignment. In some embodiments, the data object information may include a merchant name, transaction date, transaction amount, and/or initial category assignment parameters from a credit card transaction process. In some embodiments, the populated expense data object may be provided to an external electronic device associated with a user.

At block 343-11, method 343 includes performing an expense category estimation procedure. For example, network entity 20 (FIGS. 1A and 1B) may be configured to execute one or more modules or components to perform expense category estimation procedure for the expense data object based in part on a heuristic. In accordance with some embodiments, a “heuristic” may refer to solving, learning, or discovery that employs a practical methodology not guaranteed to be optimal or perfect, but sufficient for the immediate goals as applied to the computer science. In accordance with some embodiments, the heuristic is a categorization probability associated with the expense data object. Further, the heuristic may be identified based in part on one or more of a merchant identity, a transaction date, or a transaction amount. In some embodiment, auto categorization module 66-8 of network entity 20 (FIGS. 1A and 1B) may perform heuristics. It should be appreciated that heuristics are not stagnant and may be adjusted/updated based, at least in part, on machine learning outcomes.

In accordance with some embodiments, the expense category estimation procedure may include determining whether the heuristic has been identified using an autonomous expense process (e.g., machine learning procedure), providing an initial category assignment for the expense data object based on a determination that the heuristic has not been identified using the autonomous expense process, and providing an expense category estimation for the expense data object based on a determination that the heuristic has been identified using the autonomous expense procedure. In accordance with some embodiments, the expense category estimation procedure may include having network entity 20 (FIGS. 1A and 1B) configured to transmit one of the initial category assignment or the expense category estimation to an external electronic device associated with a user. In accordance with some embodiments, determining whether the heuristic has been identified using the autonomous expense process may include comparing one or more of a merchant identity, a transaction date, or a transaction amount to one or more previously exported expense data objects stored in one or more databases (e.g., database 70A) to identify the most probable expense category assignment.

In accordance with some embodiments, the expense data object may be associated with a corresponding expense report based on one or more association rules. Further, the heuristic may be adjusted/updated using the autonomous expense process and in accordance with performing the expense category estimation procedure. Additionally, in some embodiments, network entity 20 (FIGS. 1A and 1B) may be configured to execute one or more modules or components to determine whether the heuristic has been identified using an autonomous expense process includes determining for a transaction card expense associated with the expense data object.

In some embodiments, an expense category may be assigned to any expense data object when a heuristic has been identified based on machine learning outcomes (initiate export 362 of FIG. 3F). For example, an initial category may be assigned in lieu of a category estimation when a heuristic has not been identified as a category estimate. It should be appreciated that an expense data object may be assigned an estimation based on the status of the heuristics at the time an expense data object is generated.

In some embodiments, prior to, or as part of performing the expense category estimation procedure at block 343-11, a merchant identifier and an amount value are compared and/or analyzed to one or more previously exported expense data objects within the one or more databases to identify one or more expense category identifiers having the highest probability values. Subsequently, the one or more expense category identifier having the highest probability values are compared or analyzed against a list of a category identifiers to determine whether the one or more identified expense category identifiers are the same as any of the category identifier in the list. When such a match is established, the expense category identifier is assigned.

At block 343-11, method 343 may, through a user interface, manually receive an expense data object having a first merchant identifier associated with an expense item trigger. For example, network entity 20 (FIGS. 1A and 1B) may be configured to execute one or more modules or components through a user interface, to manually receive a generated expense data object (e.g., an image upload that contains an expense data object (e.g., expense item) having a first merchant identifier associated with an expense item trigger and determine whether the expense data object having the first merchant identifier includes a transaction source indication (e.g., credit/debit card)). Method 343 may proceed to block 343-11 upon receiving the expense data object at block 343-10.

It should be appreciated that the particular configuration may at least partially depend on the type of expense data object generated, as determined at block 342 and is not limited to type of expense data object specific to blocks 343-2, 343-5, or 343-10 of network entity 20 (FIGS. 1A and 1B). Additionally, in some embodiments, the expense data object received at one or more of 343-2, 343-5, or 343-10 may be a previously stored expense data object or a newly received expense data object.

At block 343-12, method 343 may apply the user map data. For example, network entity 20 (FIGS. 1A and 1B) may be configured to execute one or more modules or components to apply the user map data. In some embodiments, the user mapping parameters may include the parameters for configuring account formation characteristics (method 330 FIG. 3C). In some embodiments, applying parameters obtained in connection with method 330 may indicate the user's expenses are attributed to specific accounting dimension values. In some embodiment, network entity 20 (FIGS. 1A and 1B) may be configured to execute one or more modules or components to apply user mapping parameters across expense item generation triggers and/or expense item input types.

At block 343-13, method 343 may determine association with expense data object and expense report. For example, network entity 20 (FIGS. 1A and 1B) may be configured to execute one or more modules or components to determine association with expense data object and expense reporting. In some embodiments, expense reports may have a container structure. In some embodiments, a pointer may be used from an expense item to a report container to represent an association of an expense data object with a report. In some embodiments, rules may be utilized to establish one or more relationships between or among expense items and expense reports.

In some embodiments, newly received expense data objects may be assigned to a “new expenses” expense report. In some instances, previously stored expense data objects may be assigned to an “existing expenses” expense report. Further, one or more data objects may be assigned to a different report with or without user input. Additionally, a user interface may be provided so a user may manually associate an expense data object with a different report prior to submission of the expense report for approval. In some embodiments, one or more expense data objects may be associated via a search or filter configurations to dynamically generate a new report. In some embodiments, one or more expense data objects from the “new expenses” expense report may be provided or diverted to one or more different expense reports based on predetermined criteria (e.g., without a search or filter). For example, the one or more expense data objects may be diverted or provide from transaction onto a report organized by the statement date without ever assigning them to a new expenses report.

In some embodiments, receipt processing modules 66-1 (FIG. 1B) of network entity 20 (FIGS. 1A and 1B) may control and/or direct blocks 343-12 through blocks 343-13. Once the association with expense data object and expense report is determined, method 343 may proceed to either block 344 (FIG. 3D), 345 (FIG. 3D), 346 (FIG. 3D).

FIG. 3D-3a is a flow diagram illustrating method 344 for performing an expense resolution procedure based on one or more of an expense data object match or export determinations. In some embodiments, method 344 may be performed at network entity 20 (FIGS. 1A and 1B) including one or more electronic access devices (e.g., modules and/or servers) as part of an automated workflow system. Some operations in method 344 may be combined, the order of some operations may be changed, and some operations may be omitted.

At block 344-2, method 344 may receive a first expense data object. For example, network entity 20 (FIGS. 1A and 1B) may be configured to execute one or more modules or components to receive a first expense data object.

At block 344-3, method 344 may compare the received expense data object to stored data objects. For example, network entity 20 (FIGS. 1A and 1B) may be configured to execute one or more modules or components to compare the received expense data object to stored (e.g., database 70A) data objects for detection of duplicate expense data objects. In some embodiments, an expense data object may be compared with one or more other expense items in a user's account (e.g., expense data objects pending approval, exported expense data objects).

At block 344-4, method 344 may determine whether an expense data object represents a possible match of another expense data object based, at least in part, on confidence level thresholds. For example, network entity 20 (FIGS. 1A and 1B) may be configured to execute one or more modules or components to determine whether an expense data object represents a possible match of another expense data object based, at least in part, on confidence level thresholds. In some embodiments, determining whether the expense data object presents a possible match includes determining whether a second expense data object stored in the database matches the first expense data object.

In accordance with a determination that the expense data object represents a possible match of another expense data object based, at least in part, on confidence level thresholds, method 344 may proceed to block 344-5. Otherwise, in accordance with a determination that the expense data object does not represent a possible match of another expense data object based, at least in part, on one or more confidence level thresholds, method 344 may return to block 346 (FIG. 3D). In some embodiments, comparison analysis may also be based on machine learning (e.g., autonomous expense procedure) and may include a comparison of expense data object parameters (e.g., merchant name, transaction date, expense amount, etc.) to assist in determining the likelihood of a possible match.

At block 344-5, method 344 may determine whether the match is an exact match. For example, network entity 20 (FIGS. 1A and 1B) may be configured to execute one or more modules or components to determine whether the match (e.g., determined at block 344-4) is an exact match. In some embodiments, an exact match may be determined based on a whether a confidence level associated with the determination at block 344-4 exceeds a confidence level threshold. For example, the confidence level threshold may be a numeric value (e.g., probability in the form of a percentage value) indicating sufficient levels of certainty with respect to a duplicate expense data object.

Further, in some embodiments, determining whether the match is an exact match may also or alternatively include determining whether one or both of the first expense data object or the second expense data object satisfy auto-merge criteria (e.g., block 344-15). That is, in some instances, method 344 may determine whether one or both of the first expense data object or the second expense data object satisfy auto-merge criteria in accordance with a determination that the second expense data object stored in the database matches the first expense data object. As a result, method 344 may, in some embodiments, transmit a potential duplicate flag indication to an external electronic device associated with a user in accordance with a determination that one or both of the first expense data object or the second expense data object do not satisfy auto-merge criteria.

In some embodiments, the determinations at one or both of block 344-4 or block 344-5 may include determining according to one or more confidence level thresholds and/or determining whether the second expense data object is an exact match according to a confidence percentage to the expense data object. In accordance with a determination that the match (e.g., determined at block 344-4) is an exact match, method 344 may proceed to block 344-6. Otherwise, in accordance with a determination that the match (e.g., determined at block 344-4) is not an exact match, method 344 may advance to block 344-7. For example, a first confidence level threshold may be used in the determination at block 344-4 and a second confidence level threshold higher than the first confidence level threshold may be used at block 344-5.

At block 344-6, method 344 may determine whether a match has been exported. For example, network entity 20 (FIGS. 1A and 1B) may be configured to execute one or more modules or components to determine whether a match has been exported to, for example, reviewing entity. In some embodiments, determining whether the match has been exported includes determining whether the duplicate expense data object of a newly generated expense data object has been exported. In some embodiments, determining whether a match has been exported includes determining whether an identified match has been exported. Additionally, in some embodiments, a determination of whether a match has been exported includes determining whether a match has been submitted to one or more of a reviewing entity, a user's device, or to an autonomous expense procedure at a database (e.g., database 70A, FIG. 1A).

Further, in some embodiments, determining whether the match has been exported includes determining whether the first expense data object has been exported to a reviewing entity based on a determination that one or more second expense data object stored in the database matches the first expense data object. In some embodiments, determining whether the match has been exported includes determining whether the first expense data object and/or the second data object has been exported.

In accordance with a determination that the duplicate expense data object of the expense data object has been exported, method 344 may proceed to block 344-7. Otherwise, in accordance with a determination that the duplicate expense data object of the generated expense data object has not been exported, method 344 may advance to block 344-9.

At block 344-7, method 344 may flag the received expense data object as a potential duplicate. For example, network entity 20 (FIGS. 1A and 1B) may be configured to execute one or more modules or components to flag an original expense data object and one or more detected duplicates as potential duplicates. In some embodiments, flagging at block 344-7 includes transmitting a potential duplicate flag indication to an external electronic device associated with a user based on a determination that the second expense data object stored in the database does not match to the first expense data object.

At block 344-8, method 344, may receive an input from a user device. For example, network entity 20 (FIGS. 1A and 1B) may be configured to execute one or more modules or components to receive an input from a user device. In some embodiments, a user interface may be provided at a user device and configured to receive input from a user to confirm duplicates. In some embodiments, receiving the input from the user device may include receiving a resolution indication from the external electronic device in response to transmitting the potential duplicate flag indication (e.g., at block 344-7). In some embodiments, receiving the input from the user device may include presenting for display the possible duplicates side-by-side for a user to review. In some embodiments, the input received from the user may be an indication to delete one or more possible duplicate expenses. In some embodiments, the input received from the user may be an indication to keep each of the possible duplicate expenses. In some embodiments, the input received from the user may be an indication to merge one or more duplicate expense data objects. In some embodiments, the user input may include one of a merge expenses indication, a delete duplicate expense indication, or a hide potential duplicate flag indication.

Further, upon receiving the input from the user device, method 344 may proceed to one or more of blocks 344-9, 344-10, or 344-11. Specifically, method 344, at one or more of block 344-9, 344-10, or 344-11, may perform an expense resolution procedure using at least the first expense data object, for example, in response to receiving the user input.

At block 344-9, method 344 may merge duplicate expense data objects. For example, network entity 20 (FIGS. 1A and 1B) may be configured to execute one or more modules or components to merge duplicate expense data objects (e.g., confident merging). In some embodiments, merging the duplicate expense data objects may include merging the first expense data object with the second expense data object based on a determination that the first expense data object has not been exported to the review entity.

At block 344-10, method 344, may delete duplicate expense data objects. For example, when one or more likely duplicates have been previously exported, network entity 20 (FIGS. 1A and 1B) may be configured to execute one or more modules or components to delete duplicate expense data objects. In some embodiments, alternatively, at block 344-10, method 344 may forego storing of the first expense data object associated with a duplicate match indication and an status.

At block 344-11, method 344 may cease presentation of duplicate flag indication. For example, when the user input elects to keep each of the possible duplicates, network entity 20 (FIGS. 1A and 1B) may be configured to execute one or more modules or components to hide the possible duplicate flag from the user. In some embodiments, the presentation of the duplicate flag indication may be ceased at the user device.

It should be appreciated that the procedure of flagging of possible duplicates (e.g., block 344-8) and a receiving of a user input (e.g., block 344-9) may provide parameters to a machine learning process and may improve one or more computer-implemented processes. Further, it should be appreciated that method 344 may find more than one match, for instance, method 344 may resume searching a database for additional matches even after an exact match is found. Further, it should be appreciated that method 344 may find more than one match, for instance, method 344 may resume searching a database for additional matches even after an exact match is found. In some embodiments, receipt processing modules 66-1 may control or direct blocks 344-3 through 344-9.

FIG. 3D-3b is a flow diagram illustrating method 344-1 for analyzing duplicate expense object pairs based on historical characteristics. In some embodiments, method 344-1 may be performed at network entity 20 (FIGS. 1A and 1B) including one or more electronic access devices (e.g., modules and/or servers) as part of an automated workflow system. Some operations in method 344-1 may be combined, the order of some operations may be changed, and some operations may be omitted.

At block 344-12, method 344-1 may receive a first expense data object. For example, network entity 20 (FIGS. 1A and 1B) may be configured to execute one or more modules or components to receive a first expense data object.

At block 344-13, method 344-1 may compare the received expense data object to stored data objects. For example, network entity 20 (FIGS. 1A and 1B) may be configured to execute one or more modules or components to compare the received expense data object to stored (e.g., database 70A) data objects for detection of duplicate expense data objects. In some embodiments, an expense data object may be compared with one or more other expense items in a user's account (e.g., expense data objects pending approval, exported expense data objects).

Further, as part of, or in addition to the comparison of the received expense data object to stored data objects, method 344-1 may determine whether a first transaction source indication associated with the first expense data object corresponds to a second transaction source indication of the second expense data object. In such instance, the first transaction source indication corresponds to the second transaction source indication when an expense data source or transaction data file (corresponding to the second transaction source) is obtained from the same source or account as or associated with a first credit card account (corresponding to the first transaction source).

At block 344-14, method 344-1 may determine whether a second expense data object stored in a first database matches the first expense data object to form a duplicate expense object pair. For example, network entity 20 (FIGS. 1A and 1B) may be configured to execute one or more modules or components to determine whether a second expense data object stored in a first database matches the first expense data object to form a duplicate expense object pair based, at least in part, on confidence level threshold values. In some embodiments, one or more of the confidence level threshold values may be adjusted based on a currency conversion. In some embodiments, determining whether the expense data object presents a possible match includes determining whether a second expense data object stored in the database matches the first expense data object.

In accordance with a determination that the second expense data object stored in the first database matches the first expense data object, method 344-14 may proceed to block 344-15. Otherwise, in accordance with a determination that the expense data object does not represent a possible match of another expense data object based, at least in part, on one or more confidence level thresholds, method 344-1 may return to block 346 (FIG. 3D), where one or more expense data object parameters may be evaluated. In some embodiments, comparison analysis may also be based on machine learning (e.g., autonomous expense procedure) and may include a comparison of expense data object parameters (e.g., merchant name, transaction date, expense amount, etc.) to assist in determining the likelihood of a possible match.

At block 344-15, method 344-1 may determine whether a characteristic of each expense data object forming the duplicate expense object pair satisfies auto-merge criteria. For example, network entity 20 (FIGS. 1A and 1B) may be configured to execute one or more modules or components to determine whether a characteristic of each expense data object (e.g., first expense data object and/or second expense data object) forming the duplicate expense object pair (e.g., determined at block 344-14) satisfies auto-merge criteria.

In some embodiments, satisfying the auto-merge criteria may be determined based on an origin or source of one or both of the first and second expense data objects that forms the duplicate expense object pair. For example, the duplicate expense object pair may include an expense data object that originates from a credit card statement and another expense data object that originates from the corresponding credit card receipt. In such an instance, the credit card receipt and statement satisfy the auto-merge criteria since the credit card receipt is a duplicate record of the credit card statement and correspond to the same transaction.

Alternatively, the duplicate expense object pair and another expense data object may include an expense data object that originates from the same credit card statement. In this instance, the expense object pair and another expense data object are separate transactions and therefore may not satisfy the auto-merge criteria. In some embodiments, the characteristic of each expense data object forming the duplicate expense object pair may include one or more of a transaction source indication, a merchant identifier, a date indication, or an amount indication. Accordingly, the auto-merge criteria may include a determination that one or more of the merchant identifier, the date indication, or the amount indication of the first expense data object and the second expense data object are the same.

In accordance with a determination that the characteristic of each expense data object forming the duplicate expense object pair satisfies auto-merge criteria, method 344-1 may advance to block 344-19. Otherwise, in accordance with a determination that the characteristic of each expense data object forming the duplicate expense object pair (e.g., determined at block 344-14) does not satisfy auto-merge criteria, method 344-1 may proceed to block 344-16.

At block 344-16, method 344-1 may determine whether a duplicate expense object pair is an exclusion match of an excluded expense data object pair. For example, network entity 20 (FIGS. 1A and 1B) may be configured to execute one or more modules or components to determine whether a duplicate expense object pair is an exclusion match of an excluded expense data object pair stored in a second database (e.g., database 70A). In some embodiments, determining whether a duplicate expense object pair is an exclusion match of an excluded expense data object pair includes comparing one or more of a transaction source indications (e.g., a merchant identifier, a date indication, or an amount indication).

For example, an excluded expense object pair may correspond to an indication of a previous determination that the two expense data objects do not match. That is, previous input from a user (e.g., at block 344-18) may indicate that the duplicate expense object pair are not duplicates. In accordance with a user indication that a duplicate expense object pair are not a duplicates (e.g. should not be merged), the duplicate expense object pair may be added to the excluded expense object pair database at export (e.g. block 366 of FIG. 3F).

In accordance with a determination that the duplicate expense object pair is an exclusion match of an excluded expense data object pair, method 344-1 may return to block 346 (FIG. 3D). Otherwise, in accordance with a determination that the duplicate expense object pair is not an exclusion match of an excluded expense data object pair, method 344-1 may advance to block 344-17.

At block 344-17, method 344-1 may flag the received expense data object as a potential duplicate. For example, network entity 20 (FIGS. 1A and 1B) may be configured to execute one or more modules or components to flag an original expense data object and one or more detected duplicates as potential duplicates. In some embodiments, flagging at block 344-17 includes transmitting a potential duplicate flag indication to an external electronic device associated with a user based on a determination that the second expense data object stored in the database does not match to the first expense data object.

At block 344-18, method 344-1, may receive an input from a user device. For example, network entity 20 (FIGS. 1A and 1B) may be configured to execute one or more modules or components to receive an input from a user device. In some embodiments, a user interface may be provided at a user device and configured to receive input from a user to confirm duplicates. In some embodiments, receiving the input from the user device may include receiving a resolution indication from the external electronic device in response to transmitting the potential duplicate flag indication (e.g., at block 344-17).

Additionally, receiving the input from the user device may include presenting for display the possible duplicates side-by-side for a user to review. In some embodiments, the input received from the user may be an indication to delete one or more possible duplicate expenses. In some embodiments, the input received from the user may be an indication to keep each of the possible duplicate expenses. In some embodiments, the input received from the user may be an indication to merge one or more duplicate expense data objects. In some embodiments, the user input may include one of a merge expenses indication, a delete duplicate expense indication, or a hide potential duplicate flag indication.

Further, upon receiving the input from the user device, method 344-1 may proceed to one or more of blocks 344-19, 344-20, or 344-21. Specifically, method 344-1, at one or more of block 344-19, 344-20, or 344-21, may perform an expense resolution procedure using at least the first expense data object, for example, in response to receiving the user input.

At block 344-19, method 344-1 may merge duplicate expense data objects. For example, network entity 20 (FIGS. 1A and 1B) may be configured to execute one or more modules or components to merge duplicate expense data objects (e.g., confident merging). In some embodiments, merging the duplicate expense data objects may include merging the first expense data object with the second expense data object based on a determination that the duplicate expense object pair match.

At block 344-20, method 344-1, may delete duplicate expense data objects. For example, network entity 20 (FIGS. 1A and 1B) may be configured to execute one or more modules or components to delete duplicate expense data objects. In some embodiments, alternatively, at block 344-20, method 344-1 may forego storing of the first expense data object associated with a duplicate match indication.

At block 344-21, method 344 may cease presentation of duplicate flag indication. For example, when the user input elects to keep each of the possible duplicates, network entity 20 (FIGS. 1A and 1B) may be configured to execute one or more modules or components to hide the possible duplicate flag from the user. In some embodiments, the presentation of the duplicate flag indication may be ceased at the user device.

It should be appreciated that the procedure of flagging of possible duplicates (e.g., block 3441-8) and a receiving of a user input (e.g., block 344-19) may provide parameters to a machine learning process and may improve one or more computer-implemented processes. Further, it should be appreciated that method 344 may find more than one match, for instance, method 344-1 may resume searching a database for additional matches even after an exact match is found. Further, it should be appreciated that method 344-1 may find more than one match, for instance, method 344 may resume searching a database for additional matches even after an exact match is found. In some embodiments, receipt processing modules 66-1 may control or direct blocks 344-3 through 344-9.

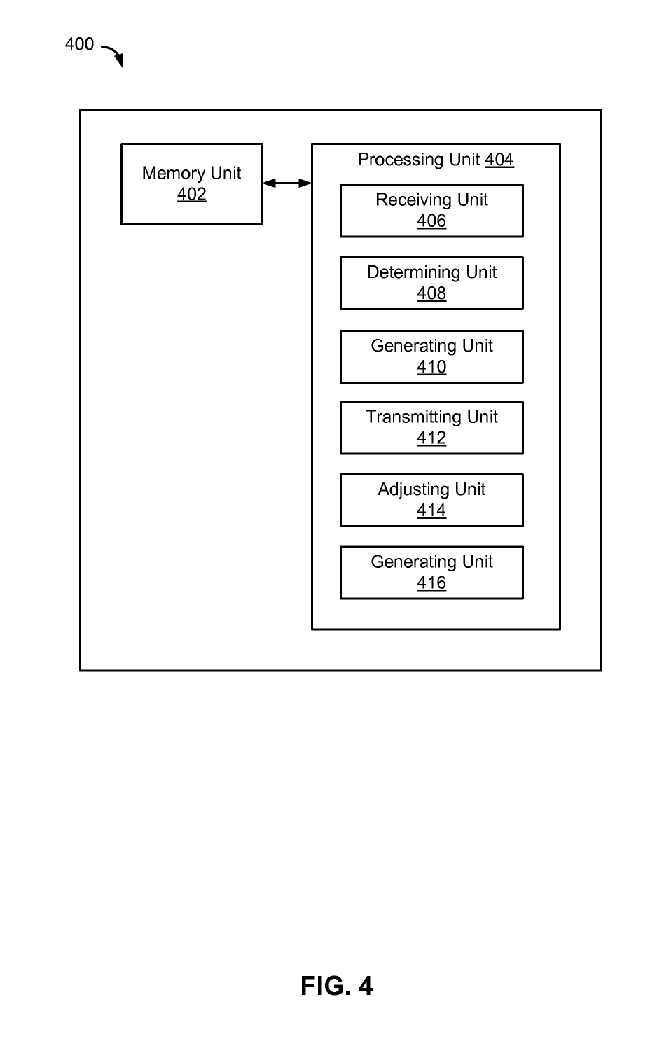

FIG. 3D-4 is a flow diagram illustrating method 345 for checking that an expense data objects complies with one or more policies established in the company and user configuration section or established using method 330. In some embodiments, method 345 may be performed at network entity 20 (FIGS. 1A and 1B) including one or more electronic access devices (e.g., modules and/or servers) as part of an automated workflow system. Some operations in method 345 may be combined, the order of some operations may be changed, and some operations may be omitted.

At block 345-2, method 345 may receive an expense data object. For example, network entity 20 (FIGS. 1A and 1B) may be configured to execute one or more modules or components to receive one or more expense data objects.

At block 345-3, method 345 may determine content-relevant variables. For example, network entity 20 (FIGS. 1A and 1B) may be configured to execute one or more modules or components to determine content-relevant variables. In some embodiments, an expense data object may be compared with one or more other expense objects in a user's account (e.g., expense data objects pending approval, exported expense data objects) to determine the context-relevant variables. In some embodiments, context-dependent policy variables may include one or more date ranges, one or more locations or submitting users. Further, if one or more data points are determined to be relevant to a context dependent policy, a context-dependent policy may be considered in the subsequent operations 345-4 and 345-5, for example.

At block 345-4, method 345 may determine whether one or more expense data objects comply with one or more policies. For example, network entity 20 (FIGS. 1A and 1B) may be configured to execute one or more modules or components to determine whether one or more expense data objects comply with one or more policies. In accordance with a determination that the single expense data object complies with one or more policies, method 345 may proceed to block 345-5. Otherwise, in accordance with a determination that the single expense data object does not comply with one or more policies, method 345 may advance to block 345-6.

At block 345-5, method 345 may determine whether a group of expense data objects complies with one or more policies. For example, network entity 20 (FIGS. 1A and 1B) may be configured to execute one or more modules or components to determine whether a group of expense data objects complies with one or more policies. In accordance with a determination that the group of expense data object complies with one or more policies, method 345 may proceed to block 346 (FIG. 3D). Otherwise, in accordance with a determination that the single expense data object does not comply with one or more policies, method 345 may advance to block 345-6. In some embodiments, the network entity 20 (FIGS. 1A and 1B) may utilize an aggregation mechanism that may analyze variables of a company policy across a group of expense data objects.

At block 345-6, method 345 may flag the expense data object or the group of expense data objects. For example, network entity 20 (FIGS. 1A and 1B) may be configured to execute one or more modules or components to flag one or more expense data objects or the group of expense data objects in accordance with a determination that the one or more data objects do not comply with one or more policies and/or a group of expense data objects does not comply with one or more policies. In some embodiments, the flag may initiate a notification procedure to the user that an expense is in violation of policy.

At block 345-7, method 345 may determine whether a violated policy involves a pre-defined restricted reimbursement threshold. For example, network entity 20 (FIGS. 1A and 1B) may be configured to execute one or more modules or components to determine whether a violated policy involves a pre-defined restricted reimbursement threshold. In accordance with a determination that the violated policy involves a pre-defined restricted reimbursement threshold, method 345 may proceed to block 345-8. Otherwise, in accordance with a determination that the single expense data object does not comply with one or more policies, method 345 may advance to block 345-9.

At block 345-8, method 345 includes assigning a restricted amount to the expense data object. For example, network entity 20 (FIGS. 1A and 1B) may be configured to execute one or more modules or components to assign a restricted amount to the expense data object. In some embodiments, the restricted amount may be equal to a predefined limit.

At block 345-9, method 345 may determine whether a user has modified any expense data object parameter. For example, network entity 20 (FIGS. 1A and 1B) may be configured to execute one or more modules or components to determine whether a user has modified any expense data object parameter (e.g., parameter fields). In accordance with a determination that the user has modified any expense data object parameter (e.g., parameter fields), method 345 may revert to block 345-3. Otherwise, in accordance with a determination that the user has not modified any expense data object parameter (e.g., parameter fields), method 345 may advance to block 346 (FIG. 3D). In some embodiments, network entity 20 (FIGS. 1A and 1B) may be configured to provide an interface to edit one or more data object parameters. In some embodiments, asynchronous web operations module 66-3 (FIG. 1B) may be configured to control or direct of process 345.

FIG. 3D-5 is a flow diagram illustrating method 346 for evaluating one or more expense data object parameters. In some embodiments, method 346 may be performed at network entity 20 (FIGS. 1A and 1B) including one or more electronic access devices (e.g., modules and/or servers) as part of an automated workflow system. Some operations in method 346 may be combined, the order of some operations may be changed, and some operations may be omitted.

At block 346-2, method 346 may evaluate one or more expense data object parameters. For example, network entity 20 (FIGS. 1A and 1B) may be configured to execute one or more modules or components to evaluate one or more expense data object parameters (e.g. currency conversion, mileage expense conversion, etc.).

At block 346-3, method 346 may receive user provided data. For example, network entity 20 (FIGS. 1A and 1B) may be configured to execute one or more modules or components to receive user provided data.

At block 346-4, method 346 may evaluate one or more data object parameters. For example, network entity 20 (FIGS. 1A and 1B) may be configured to execute one or more modules or components to evaluate one or more data object parameters. In some embodiments, the data object parameters may include evaluating distances to calculate an amount parameter of an expense data object based on point-to-point address entry and a distance rate (e.g. cost/mile, cost/kilometer). In some embodiments, the data object parameters may include evaluating the physical location of the client device 10A, 10B, or 10C to provide appropriate units (e.g., miles or kilometers) for browser display.

In some embodiments, account formation characteristics (e.g. account preferences) may be utilized to evaluate currency transactions based on a currency exchange rate. In some instances, currency exchange rates may be applied to evaluate individual expense data object amounts when currencies associated with expense items do not match an exchange rate assigned to the company or user account.

In some embodiments, the data object parameters may include evaluating an amount based on a number of units of an expense data object entered and a value per unit when an expense data object is categorized as a fixed-rate expense item. In some embodiments, evaluating data object parameters may include presenting for display one or more data object parameters and one or more evaluated parameters.

In some embodiments, module or component that controls and/or directs blocks 346-2 through 346-4 may depend on the interface utilized to access network entity 20 (FIGS. 1A and 1B). For example, in some embodiments, client API module 60-4 (FIG. 1B) may control or direct blocks 346-2 through 346-4 when a smartphone application or similar API-enabled interface accesses network entity 100. Likewise, in some embodiments, web interface module 60-3 may control or direct blocks 346-2 (FIG. 1B) through 346-4 (FIG. 1B) when accessing network entity 20 via, for example, a web-browser.

FIG. 3E is a flow diagram illustrating method 350 for approving expense data objects. In some embodiments, method 350 may be performed at network entity 20 (FIGS. 1A and 1B) including one or more electronic access devices (e.g., modules and/or servers) as part of an automated workflow system. Some operations in method 350 may be combined, the order of some operations may be changed, and some operations may be omitted.

At block 352, method 350 may determine whether an expense report and associated expense data objects qualify for submission. For example, network entity 20 (FIGS. 1A and 1B) may be configured to execute one or more modules or components to determine whether an expense report and associated expense data objects qualify for submission. In some embodiments, the determination of whether an expense data object qualifies for submission may be based, at least in part, on policy and expense data object requirements checks. Further, in some embodiments, determining whether an expense data object qualifies for submission includes determining whether the expense data object qualifies for exporting to, for example, a reviewing entity or synchronized target system.

In accordance with some embodiments, determining whether an expense report and associated expense items qualify for submission may include receiving an expense report file including one or more expense data objects. In some embodiments, receiving the expense report file may include receiving one or more resolution indications (e.g., approval/denial indications) for each of the one or more expense data objects from the external electronic device associated with the reviewing entity.

In accordance with some embodiments, determining whether each expense data object from the expense report qualifies for submission to the reviewing entity may include determining based in part on one or more policy parameters. Further, in some embodiments, determining whether an expense report and associated expense items qualify for submission may include determining that each expense data object from the one or more expense data objects of the expense report qualifies for submission to a reviewing entity in response to receiving the expense report file. In some embodiments, method 350, and in particular at block 352, the qualification determination may be performed in real time as expense reports including one or more expense data objects are submitted.

In accordance with a determination that an expense report and associated expense data objects qualify for submission, method 352 may proceed to block 354. Otherwise, in accordance with a determination that an expense report and associated expense data objects do not qualify for submission, method 350 may advance to block 343. In some embodiments, the determination of whether an expense data object qualifies for submission may compare expense data objects against data established in the account characteristics including any updated edits or adjustments applied the account characteristics.

At block 353, in accordance with a determination that the expense report and/or one or more expense data objects do not qualify for submission, method 350 may request additional information. For example, network entity 20 (FIGS. 1A and 1B) may be configured to execute one or more modules or components to request additional information from at least one approver or user. In some embodiments, requesting additional information may include requesting instructions from at least one user to resolve one or more issues that prevents an expense report and associated expense data objects from qualifying. Once the additional information is requested, method 350 may proceed to block 346 (FIG. 3D).

At block 354, method 350 may create approval chains for each expense data object associated with an expense report. For example, network entity 20 (FIGS. 1A and 1B) may be configured to execute one or more modules or components to creating approval chains for each expense data object associated with an expense report. In some embodiments, the approval chains may be dynamically constructed based, at least in part, on rules determined by the company and user configuration setting of method 330. In some embodiments, creating approval chains may include generating an approval scheme associated with one or more reviewing entities including the reviewing entity. In some embodiments, creating the approval chains may include reviewing entity information (e.g., project, people, approval levels and other parameters from configuration setting method 330) in an approval chain. In some embodiments, one or more reviewing entities may be notified by e-mail (or another form of electronic communication) when an expense report is received for approval.

At block 355, method 350 may disaggregate the expense report and send or transmit the expense report to a reviewing entity. For example, network entity 20 (FIGS. 1A and 1B) may be configured to execute one or more modules or components to disaggregate the expense report and send or transmit the expense report to a reviewing entity. In some embodiments, disaggregation of an expense report may include partitioning or dividing an expense report into groups of expenses with the same approver or approvers. For identical expense data objects, the expense reports may be grouped and presented to each approver as a single report for approval, even when a total number of expense data objects does not include the total number of expense data objects initially submitted.

In accordance with some embodiments, disaggregating the expense report and transmitting it to a reviewing entity may include disaggregating the expense report into one or more approval groups of expenses each having distinct reviewing entities based on a determination that each expense data object from the one or more expense data objects of the expense report qualifies for submission to the reviewing entity. In accordance with some embodiments, transmitting the expense report to a reviewing entity may include transmitting a resolution request indication (e.g., expense approval request) to an external electronic device associated with the reviewing entity.

At block 356, method 350 may determine whether an expense data object has been rejected. For example, network entity 20 (FIGS. 1A and 1B) may be configured to execute one or more modules or components to determine whether an expense data object has been rejected. In some embodiments, a determination of whether a data object associated with an expense report is rejected may be based, at least in part, on email, in-app or online approval and/or a direct to next approver function.

In accordance with a determination that an expense data object is rejected, method 350 may proceed to block 357. Otherwise, in accordance with a determination that an expense report and associated expense data objects do not qualify for submission, method 345 may return expense report to sender (block 358). In some embodiments, the same possible duplicate flags and policy check flags may be presented for display of each expense data object to assist one or more approvers to review. In some embodiments, one or more approvers may reject or approve of an expense report via a link in email. Further, outbound e-mail notification module 66-10 (FIG. 1B) may be configured to control and/or direct delivery and configuration of approval c-mails. In some embodiments, one or more approvers may complete an expense report and/or rejection through a user interface (e.g. a web application or native smartphone application).

It should be appreciated that an expense object's approval chain may be considered as “completed” when, for example, each approver in an approval chain has approved the expense data object. In some embodiments, two or more approvers may be determined or identified in an approver chain or process. However, having two or more approvers receive, review, and transmit one or more indications may be redundant and result in inefficiencies in the expense management process. As such, a set of approver chains or sequence of approvers may be established such that a report may be considered valid or approved as a whole when each approver in the chain or sequence of approvers provides one or more indications associated with one or more expense data objects (e.g., which are disaggregated).

At block 357, in accordance with a determination that an expense data object is rejected, method 350 may aggregate the expense report. For example, network entity 20 (FIGS. 1A and 1B) may be configured to execute one or more modules or components to aggregate the expense report. In accordance with some embodiments, aggregating the expense report may include aggregating one or more approval groups of expenses into the expense report. In some instances, each expense data object in the aggregated expense report may be associated with a corresponding resolution indication (e.g., insert after the receiving feature).

In some embodiments, when the approval chain has completed, a re-aggregated expense report may include one or more expense data objects originally mapped to a report prior to disaggregation. Additionally, each report may be re-aggregated when an approval section of method 350 is complete for expense data objects pointing to a corresponding expense report. Once the expense report is aggregated, method 350 may proceed to block 362 (FIG. 3F).

At block 358, in accordance with a determination that expense data object has not been rejected, method 350 may return a disapproved expense report to the sender. For example, network entity 20 (FIGS. 1A and 1B) may be configured to execute one or more modules or components to returning a disapproved (e.g., rejected) expense report to the sender prior to initiating an export (at block 362 FIG. 3F). In some embodiments, a disapproved (e.g., rejected) report may be represented in its entirety as originally submitted. In some embodiments, a disapproved (e.g., rejected) report may include notes (e.g., reasons for rejection) provided by one or more approvers who rejected the expense data object or data objects. In some embodiments, an annotated disapproved (e.g., rejected) report such an expense report may be edited and/or amended. In some embodiments, an annotated disapproved (e.g., rejected) report may be re-eligible for submission. In some embodiments, approval routing module 66-21 (FIG. 1B) may control or direct blocks 353 through 358 of method 350. Once the expense report is returned to sender, method 350 may proceed to block 362 (FIG. 3F).

FIG. 3F is a flow diagram illustrating method 360 for exporting expense data objects. In some embodiments, method 360 may be performed at network entity 20 (FIGS. 1A and 1B) including one or more electronic access devices (e.g., modules and/or servers) as part of an automated workflow system. Some operations in method 360 may be combined, the order of some operations may be changed, and some operations may be omitted.

At block 362, method 360 may initiate export of one or more expense data objects. For example, network entity 20 (FIGS. 1A and 1B) may be configured to execute one or more modules or components to initiate export of one or more expense data objects to one or more databases.

At block 363, method 360 may query export target entities and formats. For example, network entity 20 (FIGS. 1A and 1B) may be configured to execute one or more modules or components to query export target entities and formats. In some embodiments, each of the expense data objects marked for export may identify the export target and/or formats. In some embodiments, each of the expense data objects marked for export may identify the appropriate transactional record type. Further, a determination of export target and transactional record type may depend, at least in part, on the expense data object generation method and/or user configurations for the expense data object submitter.

For instance, querying export target entities and formats may include mapping expense data objects to one or more destinations or target systems. In some embodiments, expense data objects may be mapped to one or more target systems and/or marked for export in one or more document formats. Additionally, expense items on a report may be mapped to target systems or documents independently of the mapping of other expense items on the expense report. In some embodiments, querying export target entities and formats may include mapping an expense report for delivery to a storage system. In some embodiments, module second external synchronization module 66-6 (FIG. 1B) may support document integration.

In some embodiments, the mapping of expense items to target system may be automated. In some embodiments, automation of the mapping to target systems may depend on data parameters provided by a company's and/or user's account configuration. Further, expense items may be mapped to list parameters in the target system. In some instances, list parameters of the target system may be used to map expense items or data objects, for example, during the synchronize with target system 320 of method 300.

At block 364A, method 360 may export to a synchronized target system. For example, network entity 20 (FIGS. 1A and 1B) may be configured to export to one or more synchronized target systems (e.g., first external synchronization service 66-4, FIG. 1B), second external synchronization service 66-6 (FIG. 1B), third external synchronization service 66-16 (FIG. 1B)).

At block 364B, method 360 includes exporting to one or more documents. For example, network entity 20 (FIGS. 1A and 1B) may be configured to export to one or more documents. In some embodiments, the document may be a file format (e.g., portable document format (pdf), comma separated file (csv), tab or space-delimited file, xml, etc.).

In some embodiments, at one or both of blocks 364A or 364B, exporting to a synchronized target system and/or a document may include exporting the one or more expense data objects to one or more target databases each uniquely associated with the one or more electronic devices. In accordance with some embodiments, exporting the one or more expense data objects may include identifying the one or more target databases based in part on one or more export characteristics and mapping the one or more expense data objects to the one or more target databases based in part on one or more expense parameters (e.g., list parameters).

At block 365A, method 360 may determine whether exporting to a synchronized target system failed. For example, network entity 20 (FIGS. 1A and 1B) may be configured to execute one or more modules or components to determine whether exporting to a synchronized target system failed. In accordance with a determination that exporting to a synchronized target system failed, method 346 may proceed to block 367. Otherwise, in accordance with a determination that exporting to a synchronized target system does not fail, method 364A may advance to block 366.

Likewise at block 365B, method 360 may determine whether exporting to document failed. For example, network entity 20 (FIGS. 1A and 1B) may be configured to execute one or more modules or components to determine whether exporting to document failed. In accordance with a determination that exporting to document failed, method 346 may proceed to block 367. Otherwise, in accordance with a determination that exporting to document does not fail, method 364A may advance to block 366.

In some embodiments, in accordance with performing block 364A, any number of additional processes, such as process 364B, process 364C, etc. may be performed or executed in parallel, for example. In an embodiment, supported export types may include export to target synchronized systems, export to document format such as PDF or comma-delimited file, and export to document. Export types used for any given export may be one or many, and are merely represented by 364A and 364B in the diagram.

At block 366, method 360 may provide data to autonomous expense procedure. For example, network entity 20 (FIGS. 1A and 1B) may be configured to provide data to autonomous expense procedure. In some embodiments, data parameters may include incorporating data parameter field values into autonomous expense procedure. In some embodiments, data parameters provided on each expense data object may be provided for heuristics that enable machine learning, for example, during expense data object generation (FIG. 3D, method 340). In some embodiments, the autonomous expense procedure may be a string distance determination process.

For example, providing data to autonomous expense procedure may include adjusting a first set of expense output data to a second set of expense output data using an autonomous expense procedure based on receiving the one or more resolution indications and in response to exporting the one or more expense data objects to the one or more target databases. In some instances, the first set of expense output data and the second set of expense output data may be associated with one or more data parameter field values of the one or more expense data objects.

At block 367, method 360 may perform export failure resolution procedure. For example, network entity 20 (FIGS. 1A and 1B) may be configured to perform export failure resolution procedure. In some embodiments, export failure resolution procedure may include reverting back to block 364A in an attempt to export to synchronized target system. In some embodiments, export failure resolution procedure may include reverting back to block 364B in an attempt to export to document. In some embodiments, export failure resolution procedure may include requesting additional instructions from a user. In some embodiments, auto categorization module 66-8 (FIG. 1B) may be configured to control and/or direct the autonomous expense procedure.

FIG. 3F-1 is a flow diagram illustrating method 364A for exporting to synchronized target systems. In some embodiments, method 364A may be performed at network entity 20 (FIGS. 1A and 1B) including one or more electronic access devices (e.g., modules and/or servers) as part of an automated workflow system. Some operations in method 364A may be combined, the order of some operations may be changed, and some operations may be omitted.

At block 364A-2, method 364A may initiate expense data object export for an established connection with a target system. For example, network entity 20 (FIGS. 1A and 1B) may be configured to execute one or more modules or components to initiate an expense data object export for an established connection with a target system.

At block 364A-3, method 364A may determine whether exporting expense data object to a target system is compatible. For example, network entity 20 (FIGS. 1A and 1B) may be configured to execute one or more modules or components to determine whether exporting expense data object to a target system is compatible. In some embodiments, the compatibility determination of the export of an expense data object may be based, at least in part, on a requirements check. In some embodiments, the compatibility determination of the export of an expense data object may be based, at least in part, on a determination that one or more destination list parameters may be created to support an expense data object export.

In accordance with a determination of exporting expense data object to a target system is compatible, method 346A may proceed to block 346A-4. Otherwise, in accordance with a determination exporting expense data object to a target system is not compatible, method 346A may advance to block 346A-8.

At block 364A-4, method 364A may query export target entities and formats. For example, network entity 20 (FIGS. 1A and 1B) may be configured to execute one or more modules or components to query export target entities and formats. In some embodiments, querying export target entities and formats may include generating destination list data parameters based on queried export target entities and formats. Further, the generation of destination parameters may include populating list data parameters, generating documents, and/or generating accounting system transaction records (e.g., bills, checks, journal entries, and/or credit card line items).

In some embodiments, querying export target entities and formats may include generating missing list data parameters or elements in the target system. Additionally, an export process may continue once a missing list data parameter or element is generated in the target system.

In some embodiments, the format of parameters delivered into the target system may depend, at least in part, on company and user account characteristics of method 330. Moreover, the one or more modules handling parameter adjustments/updates and export actions may be dependent, at least in part, on the target system.

At block 364A-5, method 364A may determine whether exporting expense data object to a target system failed. For example, network entity 20 (FIGS. 1A and 1B) may be configured to execute one or more modules or components to determine whether exporting expense data object to a target system failed.

In accordance with a determination of exporting expense data object to a target system failed, method 364A may proceed to block 364A-7. Otherwise, in accordance with a determination exporting expense data object to a target system did not fail, method 364A may advance to block 364A-6, where the export may be marked as a success. For instance, the determination of exporting expense data object may include monitoring the export of expense data objects while expense data object parameters are transferred to a target system. In some instances, the monitoring may occur during the export process.

It should be appreciated that export fails, when at point during transfer, one or more aspects of the transfer process does not complete properly (e.g., an error is encountered during the export process). In some instances, a checksum may be used during export to ensure the integrity of the data remains intact.

At block 364A-7, method 364A may erase the data parameters generated in the target system. For example, network entity 20 (FIGS. 1A and 1B) may be configured to execute one or more modules or components to erase (e.g., delete) the data parameters generated in the target system. In some embodiments, erasing the data parameters may include generated data parameters in the target system such that the export process may easily be re-initiated. Once the expense report is marked a success, method 365A may proceed to block 366 (FIG. 3F).

At block 364A-8, method 364A may mark the export as failed. For example, network entity 20 (FIGS. 1A and 1B) may be configured to execute one or more modules or components to mark (e.g., associate the export of data with a failure indication) the export as failed. Once the expense report is marked a failure, method 365A may proceed to block 367 (FIG. 3F).

FIG. 3F-2 is a flow diagram illustrating method 364B for exporting to a document (e.g., portable document format (pdf), comma separated file (csv), tab or space-delimited file, xml, etc.). In some embodiments, method 364B may be performed at network entity 20 (FIGS. 1A and 1B) including one or more electronic access devices (e.g., modules and/or servers) as part of an automated workflow system. Some operations in method 364B may be combined, the order of some operations may be changed, and some operations may be omitted.

At block 364A-2, method 364A may generate a document. For example, network entity 20 (FIGS. 1A and 1B) may be configured to execute one or more modules or components to generate a document. In some embodiments, the generation of document may include populating list data parameters, generating documents, and/or generating accounting system transaction records (e.g., bills, checks, journal entries, and/or credit card line items).

In some embodiments, exporting to a document may provide an accounting distribution in the document. For instance, the accounting distribution may represent the summation of expenditure across expense categories. Further, the format of a parameter delivered into the document may depend, at least in part, on company and user account characteristics of method 330. In some embodiments, the FlatFile Export Module 66-5 of network entity 20 (FIGS. 1A and 1B) may be configured to generate the document.

At block 364B-3, method 364B may determine whether the document was generated accurately. For example, network entity 20 (FIGS. 1A and 1B) may be configured to execute one or more modules or components to determine whether the document was generated accurately. In accordance with a determination that the document was generated accurately, method 346B may proceed to block 346B-4. Otherwise, in accordance with a determination that the document was not generated accurately, method 346B may advance to block 346B-5.

At block 364B-4, method 364B may mark the exported document as a success. For example, network entity 20 (FIGS. 1A and 1B) may be configured to execute one or more modules or components to mark the exported document as a success. Once the expense report is marked a success, method 365A may proceed to block 366 (FIG. 3F).

At block 364B-5, method 364B may mark the exported document as failed. For example, network entity 20 (FIGS. 1A and 1B) may be configured to execute one or more modules or components to mark the exported document as failed. Once the expense report is marked a failure, method 365A may proceed to block 367 (FIG. 3F).

In accordance with some embodiments, FIGS. 4-9 show example functional block diagrams of an electronic devices 400, 500, 600, 700, 800, and 900 configured in accordance with the principles of the various described embodiments. In accordance with some embodiments, the functional blocks of electronic devices 400, 500, 600, 700, 800, and 900 are configured to perform the techniques described herein. The functional blocks of electronic device 400, 500, 600, 700, 800, and 900 are, optionally, implemented by hardware, software, or a combination of hardware and software to carry out the principles of the various described examples. It is understood by persons of skill in the art that the functional blocks described in FIGS. 4-9 are optionally combined or separated into sub-blocks to implement the principles of the various described examples. Therefore, the description herein optionally supports any possible combination or separation or further definition of the functional blocks described herein.

As shown in FIG. 4, an electronic device 400, which may be the same as or similar to network entity 20 (FIGS. 1A and 1B) includes memory unit 402, which may be configured to store data for retrieval, and processing unit 404 coupled to the memory unit 402. In some embodiments, processing unit 404 includes receiving unit 406, determining unit 408, generating unit 410, transmitting unit 412, and adjusting unit 414.

Processing unit 404 may be configured to determine (e.g., via determining unit 408) a first set of expense data using an autonomous expense procedure based in part on one or more expense parameters; receive (e.g., via receiving unit 406) one or more datasets each associated with a financial transaction record from a data storing entity; generate (e.g., via generating unit 410) an expense data object for each of the one or more datasets in response to receiving the one or more datasets; transmit (e.g., via transmitting unit 412) a resolution request indication to an external electronic device associated with a reviewing entity for one or more of the generated expense data objects; receive (e.g., via receiving unit 406) one or more resolution indications for one or more of the generated expense data object from the external electronic device associated with the reviewing entity; adjust (e.g., via adjusting unit 414) the first set of expense data to a second set of expense data using the autonomous expense procedure and based at least in part on receiving the one or more resolution indications; generate (e.g., via generating unit 410) a second expense data object for a second dataset based on the second set of expense data, wherein the second expense data object is different from the first expense data object; and present (e.g., via presenting unit 416) for display the second expense data object to the external electronic device associated with the reviewing entity.

In accordance with some embodiments, in order to present for display the second expense data object, processing unit 404 may be configured to transmit (e.g., via transmitting unit 412) a second resolution request indication associated with the second expense data object to the external electronic device associated with the reviewing entity.

In accordance with some embodiments, processing unit 404 may be configured to receive one or more of a defined expense category, an expense policy, a configured user settings, a defined object parameter, or an assigned monetary approval levels.

In accordance with some embodiments, one or both of the expense policy or the assigned monetary approval levels are determined based on a policy engine (e.g., at electronic device 400).

In accordance with some embodiments, the first set of expense data and the second set of expense data include one or more of a merchant indication, a date indication, an amount indication, a currency indication, an expense category indication, or a duplicate match indication (e.g., at electronic device 400).

In accordance with some embodiments, the data storing entity includes one or more of an accounting program, a camera, or a credit card processing entity (e.g., at electronic device 400).

In accordance with some embodiments, the autonomous expense procedure is a string distance determination process (e.g., at electronic device 400).

In accordance with some embodiments, the autonomous expense procedure is stored at one or more of the one or more electronic devices (e.g., at electronic device 400).

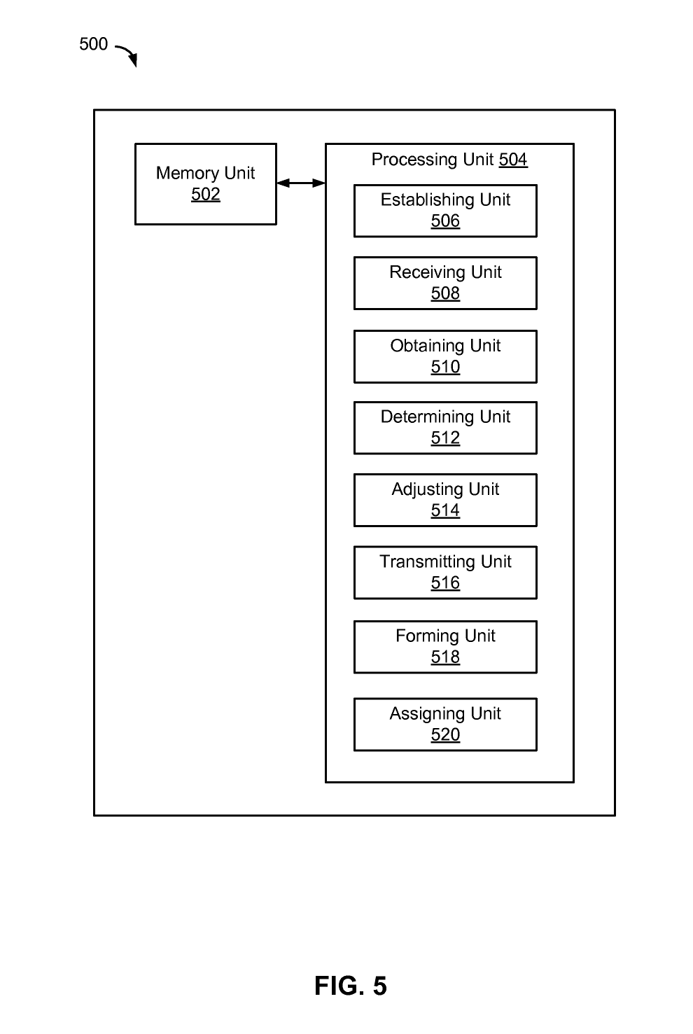

As shown in FIG. 5, an electronic device 500, which may be the same as or similar to network entity 20 (FIGS. 1A and 1B) includes memory unit 502, which may be configured to store data for retrieval, and processing unit 504 coupled to the memory unit 502. In some embodiments, processing unit 504 includes establishing unit 506, receiving unit 508, obtaining unit 510, determining unit 512, adjusting unit 514, transmitting unit 516, forming unit 518, and assigning unit 520.

Processing unit 504 may be configured to establish (e.g., via establishing unit 506) a connection with a data storage entity that manages one or more datasets associated with a first account according to one or more transaction configuration parameters; receive (e.g., via receiving unit 508) the one or more transaction configuration parameters from the data storage entity in response to establishing the connection with the data storage entity; obtain (e.g., via obtaining unit 510) an integration level between the network entity and the data storage entity; determine (e.g., via determining unit 512) one or more account formation characteristics (e.g., preferences) based on one or both of the one or more transaction configuration parameters or the integration level; adjust (e.g., via adjusting unit 514) a second account associated with a user at the network entity based on the one or more account formation characteristics; and transmit (e.g., via transmitting unit 516) one or more account characteristics of the adjusted second account to an external electronic device associated with the user.

In accordance with some embodiments, the transaction configuration parameters include parameters that allocate transactions according to one or more criteria and specific to the data storage entity (e.g., at electronic device 500).

In accordance with some embodiments, determining the one or more account formation characteristics includes mapping one or more expense categories to one or more datasets based on the account formation characteristics (e.g., at electronic device 400).

In accordance with some embodiments, the account formation characteristics include one or more preferences associated with the user.

In accordance with some embodiments, the mapping includes mapping the one or more expense categories according to a string distance determination process (e.g., at electronic device 500).

In accordance with some embodiments, in order to determine the one or more account formation characteristics, processing unit 504 may be configured to determine (e.g., via determining unit 512) a match of one or more general ledger accounts to one or more expense categories; determine (e.g., via determining unit 512) a configuration of a user access level to the one or more transaction configuration parameters; and/or determine (e.g., via determining unit 512) one or more expense item data parameter requirements.

In accordance with some embodiments, processing unit 504 may be configured to form (e.g., via forming unit 518) the second account associated with the user at the network entity; receive (e.g., via receiving unit 508) one or more indications of an adjustment of the one or more account formation characteristics; and adjust (e.g., via adjusting unit 514) the second account based on the one or more adjusted account formation characteristics.

In accordance with some embodiments, in order to establish the connection with the data storage entity that manages one or more datasets associated with the first account, processing unit 504 may be configured to establish (e.g., via establishing unit 506) the connection with the data storage entity on a periodic basis according to an identity of the data storage entity.

In accordance with some embodiments, in order to determine one or more account formation characteristics, processing unit 504 may be configured to assign (e.g., via assigning unit 520) one or more billing preferences to the user.

In accordance with some embodiments, in order to assign one or more billing preferences to the user, processing unit 504 may be configured to assign (e.g., via assigning unit 520) based in part on the one or more transaction configuration parameters.

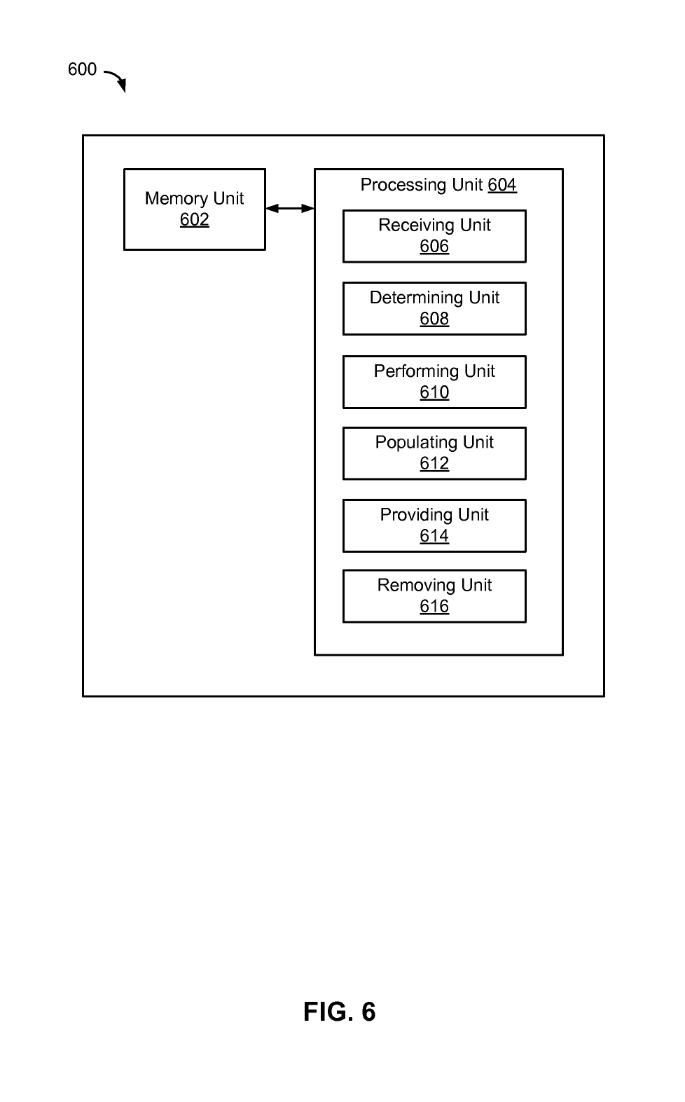

As shown in FIG. 6, an electronic device 600, which may be the same as or similar to network entity 20 (FIGS. 1A and 1B) includes memory unit 602, which may be configured to store data for retrieval, and processing unit 604 coupled to the memory unit 602. In some embodiments, processing unit 604 includes receiving unit 606, determining unit 608, performing unit 610, populating unit 612, providing unit 614, and removing unit 616.

Processing unit 504 may be configured to receive (e.g., via receiving unit) an expense data object (e.g., expense item) having a first merchant identifier associated with an expense item trigger in response to receiving the expense item trigger; determine (e.g., via determining unit 608) whether the expense data object having the first merchant identifier includes a transaction source indication (e.g., credit/debit card); and perform (e.g., via performing unit 610) a merchant identity procedure (e.g., character scrubbing procedure) on the first merchant identifier of the expense data object to obtain a second merchant identifier associated with the expense data object based on a determination that the expense data object includes the transaction card indication.

In accordance with some embodiments, in order to perform the merchant identity procedure, processing unit 604 may be configured to remove (e.g., via removing unit 616) a portion of the first merchant identifier based on one or more filtering characteristics to obtain the second merchant identifier.

In accordance with some embodiments, the one or more filtering characteristics includes one or both of a readability characteristic or a character repetition characteristic (e.g., at electronic device 600).

In accordance with some embodiments, processing unit 604 may be configured to determine (e.g., via determining unit 608) an initial category assignment (e.g., preliminary category assignment) for the expense data object having the second merchant identifier based on performing the merchant identity procedure; populate (e.g., via populating unit 612) one or more data fields of the expense data object based on one or both of the merchant identity procedure or the initial category assignment; and provide (e.g., via providing unit 614) the populated expense data object to an external electronic device associated with a user.

In accordance with some embodiments, in order to determine the initial category assignment, processing unit 604 may be configured to determine (e.g., via determining unit 608) based on a merchant categorization code associated with a transaction card entity.

In accordance with some embodiments, in order to populate the one or more data fields of the expense data object, processing unit 604 may be configured to populate (e.g., via populating unit 610) according to one or more of the initial category assignment, the second merchant identifier, a transaction date, or a transaction amount.

In accordance with some embodiments, processing unit 604 may be configured to determine (e.g., via determining unit 608) a first set of expense output data using an autonomous expense procedure.

In accordance with some embodiments, in order to determine the first set of expense output data using the autonomous expense procedure, processing unit 604 may be configured to determine (e.g., via determining unit 608) based in part on one or more expense parameters.

In accordance with some embodiments, processing unit 604 may be configured to provide (e.g., via providing unit 614) the second merchant identifier of the expense data object to the autonomous expense procedure to adjust a set of expense output data.

In accordance with some embodiments, the transaction source indication is one of a credit card indication or a debit card indication (e.g., at electronic device 600).

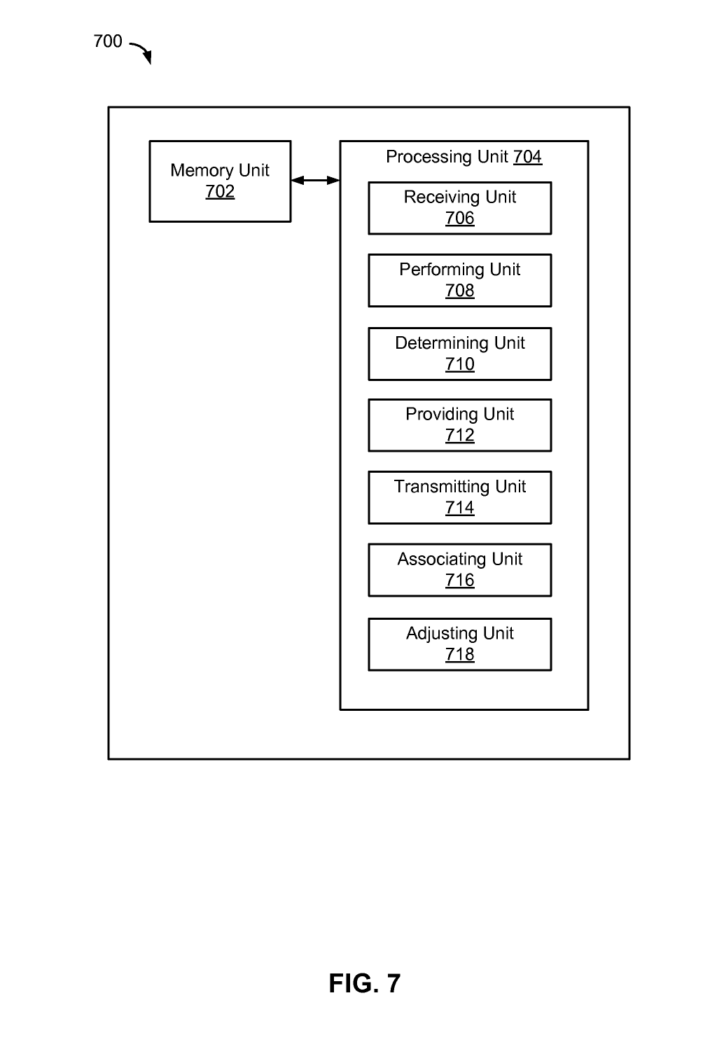

As shown in FIG. 7, an electronic device 700, which may be the same as or similar to network entity 20 (FIGS. 1A and 1B) includes memory unit 702, which may be configured to store data for retrieval, and processing unit 704 coupled to the memory unit 702. In some embodiments, processing unit 704 includes receiving unit 706, performing unit 708, determining unit 710, providing unit 712, transmitting unit 714, associating unit 716, and adjusting unit 718.

Processing unit 504 may be configured to receive (e.g., via receiving unit 706) an expense data object; perform (e.g., via performing unit 708) an expense category estimation procedure for the expense data object based in part on a heuristic, wherein the expense category estimation procedure includes: determine (e.g., via determining unit 710) whether the heuristic has been identified using an autonomous expense process (e.g., machine learning procedure); provide (e.g., via providing unit 712) an initial category assignment (e.g., preliminary category assignment) for the expense data object based on a determination that the heuristic has not been identified using the autonomous expense process; provide (e.g., via providing unit 712) an expense category estimation for the expense data object based on a determination that the heuristic has been identified using the autonomous expense procedure; and transmit (e.g., via transmitting unit 714) one of the initial category assignment or the expense category estimation to an external electronic device associated with a user.

In accordance with some embodiments, the heuristic is a categorization probability associated with the expense data object (e.g., at electronic device 700).

In accordance with some embodiments, processing unit 704 may be configured to associate (e.g., via associating unit 716) the expense data object with a corresponding expense report based on one or more association rules.

In accordance with some embodiments, processing unit 704 may be configured to adjust (e.g., via adjusting unit 718) the heuristic using the autonomous expense process and in accordance with performing the expense category estimation procedure.

In accordance with some embodiments, in order to determine whether the heuristic has been identified using an autonomous expense process, processing unit 704 may be configured to determine (e.g., via determining unit 710) for a transaction card expense associated with the expense data object.

In accordance with some embodiments, the heuristic is identified based in part on one or more of a merchant identity, a transaction date, or a transaction amount (e.g., at electronic device 700).

In accordance with some embodiments, the autonomous expense procedure is a string distance determination process (e.g., at electronic device 700).

In accordance with some embodiments, the autonomous expense procedure is stored at one or more of the one or more electronic devices (e.g., at electronic device 700).

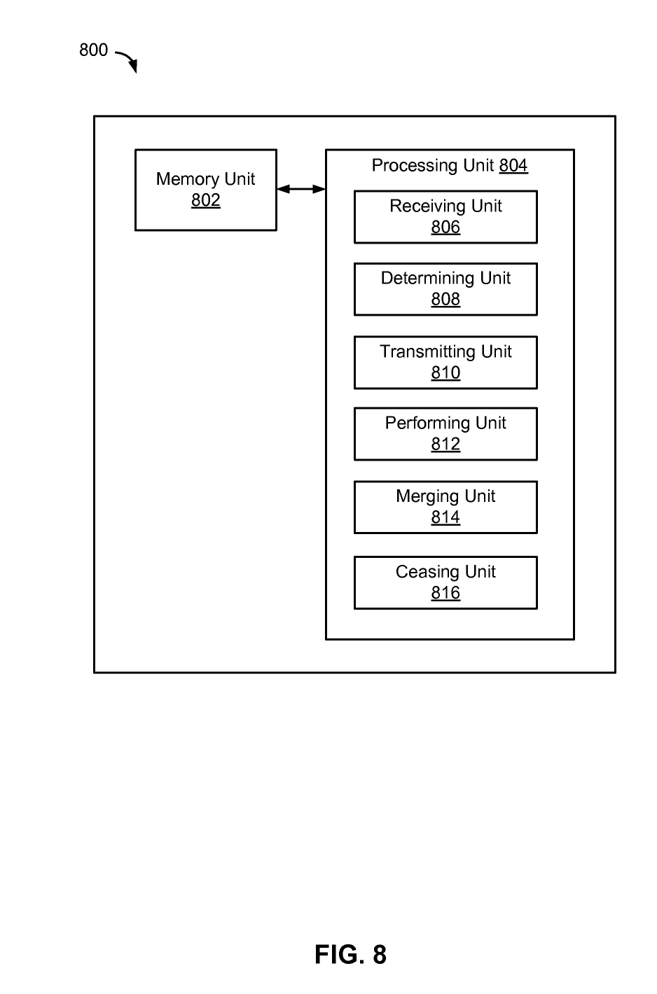

As shown in FIG. 8, an electronic device 800, which may be the same as or similar to network entity 20 (FIGS. 1A and 1B) includes memory unit 802, which may be configured to store data for retrieval, and processing unit 804 coupled to the memory unit 802. In some embodiments, processing unit 804 includes receiving unit 806, determining unit 808, transmitting unit 810, performing unit 812, merging unit 814, and ceasing unit 816.

Processing unit 804 may be configured to receive (e.g., via receiving unit 806) a first expense data object; determine (e.g., via determining unit 808) whether a second expense data object stored in the database matches the first expense data object; in accordance with a determination that the second expense data object stored in the database matches the first expense data object, determine (e.g., determining unit 808) whether one or both of the first expense data object or the second expense data object satisfy auto-merge criteria; in accordance with a determination that one or both of the first expense data object or the second expense data object do not satisfy auto-merge criteria, transmit (e.g., via transmitting unit 810) a potential duplicate flag indication to an external electronic device associated with a user, receive (e.g., via receiving unit 806) a resolution indication from the external electronic device in response to transmitting the potential duplicate flag indication; and perform (e.g., via performing unit 812) an expense resolution procedure using at least the first expense data object in response to receiving user input.

In accordance with some embodiments, processing unit 804 may be further configured to determine (e.g., via determining unit 808) whether the first expense data object has been exported to an integrated entity based on a determination that one or more second expense data object stored in the database matches the first expense data object; and transmit (e.g., via transmitting unit 810) the potential duplicate flag indication to the external electronic device associated with the user based on a determination that the first expense data object has been exported to the integrated entity.

In accordance with some embodiments, in order to perform the expense resolution procedure, processing unit 804 may be configured to merge (e.g., via merging unit 814) the first expense data object with the second expense data object based on a determination that the first expense data object has not been exported to the review entity.

In accordance with some embodiments, in order to perform the expense resolution procedure, processing unit 804 may be configured to forego store of the first expense data object associated with a duplicate match indication and an exported status.

In accordance with some embodiments, in order to perform the expense resolution procedure, processing unit 804 may be configured to cease (e.g., via ceasing unit 816) presentation of the potential duplicate flag indication.

In accordance with some embodiments, in order to determine whether the second expense data object stored in the database matches the expense data object, processing unit 804 may be configured to determine (e.g., via determining unit 808) according to one or more confidence level thresholds.

In accordance with some embodiments, in order to determine whether one or both of the first expense data object or the second expense data object satisfy auto-merge criteria, the processing unit 804 is further configured to determine (e.g., via determining unit 808) whether the second expense data object is an exact match to the first expense data object according to a confidence percentage value.

In accordance with some embodiments, the user input includes one of a merge expenses indication, a delete duplicate expense indication, or a hide potential duplicate flag indication (e.g., at electronic device 800).

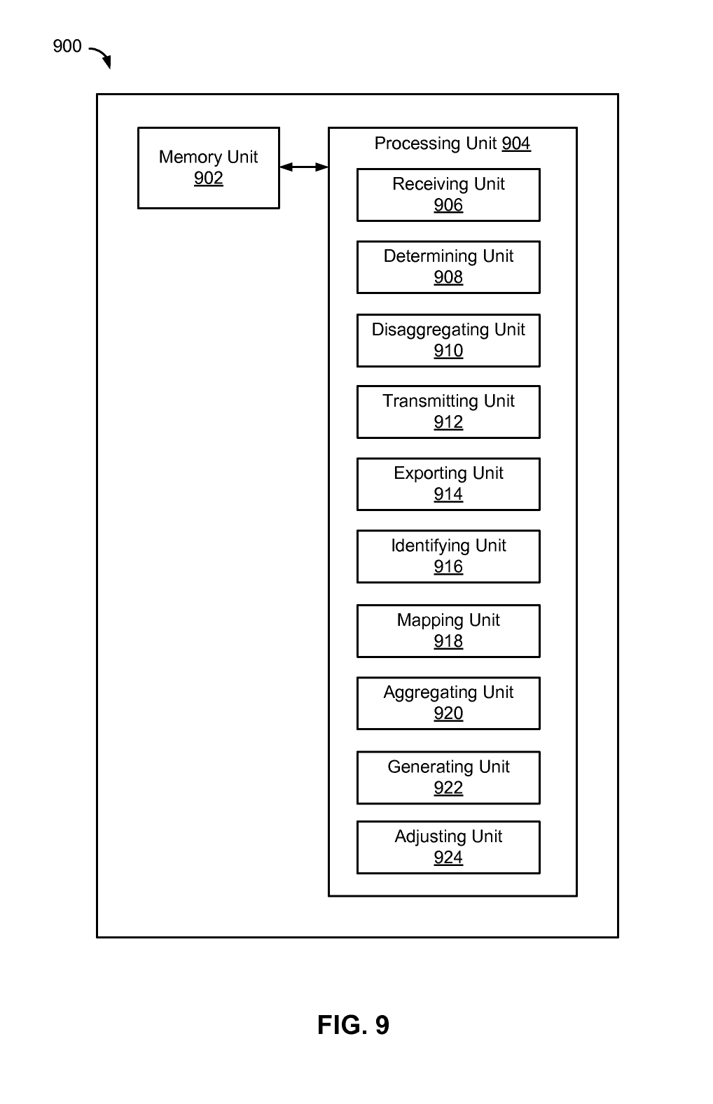

As shown in FIG. 9, an electronic device 900, which may be the same as or similar to network entity 20 (FIGS. 1A and 1B) includes memory unit 902, which may be configured to store data for retrieval, and processing unit 904 coupled to the memory unit 902. In some embodiments, processing unit 904 includes receiving unit 906, determining unit 908, disaggregating unit 910, transmitting unit 912, exporting unit 914, identifying unit 916, mapping unit 918, aggregating unit 920, generating unit 922, and adjusting unit 924.

Processing unit 904 may be configured to receive (e.g., via receiving unit 906) an expense report file including one or more expense data objects; determine (e.g., via determining unit 908) that each expense data object from the one or more expense data objects of the expense report qualifies for submission to a reviewing entity in response to receiving the expense report file; disaggregate (e.g., via disaggregating unit 910) the expense report file into one or more approval groups of expenses each having distinct reviewing entities based on a determination that each expense data object from the one or more expense data objects of the expense report qualifies for submission to the reviewing entity; transmit (e.g., via transmitting 912) a resolution request indication (e.g., expense approval request) to an external electronic device associated with the reviewing entity; receive (e.g., via receiving unit 906) one or more resolution indications (e.g., approval/denial indications) for each of the one or more expense data objects from the external electronic device associated with the reviewing entity; and export (e.g., via exporting unit 914) the one or more expense data objects to one or more target databases each uniquely associated with the one or more electronic devices.

In accordance with some embodiments, processing unit 904 may be further configured to adjust (e.g., via adjusting unit 924) a first set of expense output data to a second set of expense output data using an autonomous expense procedure based on receiving the one or more resolution indications and in response to exporting the one or more expense data objects to the one or more target databases.

In accordance with some embodiments, the first set of expense output data and the second set of expense output data are associated with one or more data parameter field values of the one or more expense data objects (e.g., at electronic device 900).

In accordance with some embodiments, the autonomous expense procedure is a string distance determination process (e.g., at electronic device 800).

In accordance with some embodiments, in order to export the one or more expense data objects, processing unit 904 may be configured to: identify (e.g., via identifying unit 916) the one or more target databases based in part on one or more export characteristics; and map (e.g., via mapping unit 918) the one or more expense data objects to the one or more target databases based in part on one or more expense parameters

In accordance with some embodiments, processing unit 904 may be configured to aggregate (e.g., via aggregating unit 920) the one or more approval groups of expenses into the expense report file, wherein each expense data object in the aggregated expense report file is associated with a corresponding resolution indication.

In accordance with some embodiments, processing unit 904 may be configured to generate (e.g., via generating unit 922) an approval scheme associated with one or more reviewing entities including the reviewing entity.

In accordance with some embodiments, in order to determine whether each expense data object from the expense report qualifies for submission to the reviewing entity, processing unit 904 may be configured to determine (e.g., via determining unit 908) based in part on one or more policy parameters.

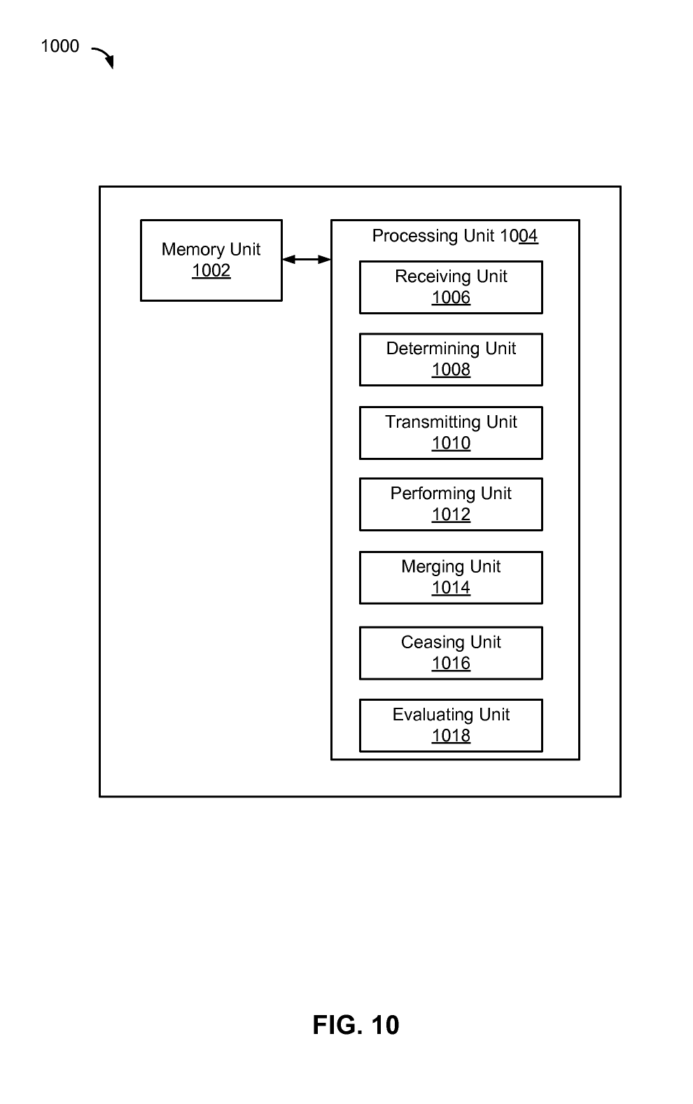

As shown in FIG. 10, an electronic device 1000, which may be the same as or similar to network entity 20 (FIGS. 1A and 1B) includes memory unit 1002, which may be configured to store data for retrieval, and processing unit 1004 coupled to the memory unit 1002. In some embodiments, processing unit 1004 includes receiving unit 1006, determining unit 1008, transmitting unit 1010, performing unit 1012, merging unit 1014, ceasing unit 1016, and evaluating unit 1018.

Processing unit 1004 may be configured to receive (e.g., via receiving unit 1006) a first expense data object; determine (e.g., via determining unit 1008) that a second expense data object stored in the first database matches the first expense data object to form a duplicate expense object pair, in accordance with a determination that the second expense data object stored in the first database matches the first expense data object, determine (e.g., via determining unit 1008) whether a characteristic of each expense data object forming the duplicate expense object pair satisfies auto-merge criteria; in accordance with a determination that the characteristic of each expense data object forming the duplicate expense object pair does not satisfy auto-merge criteria, determine (e.g., via determining unit 1008) whether the duplicate expense object pair is an exclusion match of an excluded expense data object pair stored in the second database; and in accordance with a determination that the duplicate expense object pair does not match the excluded expense object pair: transmit (e.g., via transmitting unit 1010) a potential duplicate flag indication to an external electronic device associated with a user; receive (e.g., via receiving unit 1006) a resolution indication from the external electronic device in response to transmitting the potential duplicate flag indication; and perform (e.g., via performing unit 1012) an expense resolution procedure using at least the first expense data object in response to receiving a first user input.

In accordance with some embodiments, wherein the processing unit 1004 is further configured to, in accordance with a determination that the characteristic of each expense data object forming the duplicate expense object pair satisfies auto-merge criteria, merge (e.g., via merging unit 814) the first expense data object with the second expense data object.

In accordance with some embodiments, wherein the processing unit 1004 is further configured to, in accordance with a determination that the duplicate expense object pair matches the excluded expense object pair, evaluate (e.g., via evaluating unit 1018) one or more expense data object parameters.

In accordance with some embodiments, the characteristic of each expense data object forming the duplicate expense object pair includes one or more of a transaction source indication, a merchant identifier, a date indication, or an amount indication.

In accordance with some embodiments, the excluded expense object pair corresponds to an indication of a previous determination that the two expense data objects do not match.

In accordance with some embodiments, in order to perform the expense resolution procedure, processing unit 1004 may be configured to merge (e.g., via merging unit 1014) the first expense data object with the second expense data object based on a determination that the first expense data object in response to receiving the resolution indication.

In accordance with some embodiments, in order to determine whether the second expense data object stored in the database matches the expense data object, processing unit 1004 may be configured to determine (e.g., via determining unit 1008) according to one or more confidence level thresholds.

In accordance with some embodiments, the user input includes one of a merge expenses indication, a delete duplicate expense indication, or a hide potential duplicate flag indication.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
at a network entity including one or more electronic devices and a database:
receiving a first expense data object;
determining whether a second expense data object stored in the database matches the first expense data object;
in accordance with a determination that the second expense data object stored in the database matches the first expense data object, determining whether one or both of the first expense data object or the second expense data object satisfy auto-merge criteria;
in accordance with a determination that one or both of the first expense data object or the second expense data object do not satisfy auto-merge criteria, transmitting a potential duplicate flag indication to an external electronic device associated with a user,
receiving a resolution indication from the external electronic device in response to transmitting the potential duplicate flag indication; and
performing an expense resolution procedure using at least the first expense data object in response to receiving user input.

2. The method of claim 1, further comprising:
determining whether the first expense data object has been exported to an integrated entity based on a determination that the second expense data object stored in the database matches the first expense data object; and
transmitting the potential duplicate flag indication to the external electronic device associated with the user based on a determination that the first expense data object has been exported to the integrated entity.

3. The method of claim 1, wherein performing the expense resolution procedure includes merging the first expense data object with the second expense data object based on a determination that the first expense data object has not been exported to the review entity.

4. The method of claim 1, wherein performing the expense resolution procedure includes foregoing store of the first expense data object associated with a duplicate match indication and an exported status.

5. The method of claim 1, wherein performing the expense resolution procedure includes ceasing presentation of the potential duplicate flag indication.

6. The method of claim 1, wherein determining whether the second expense data object stored in the database matches the first expense data object includes determining according to one or more confidence level thresholds.

7. The method of claim 1, wherein determining whether one or both of the first expense data object or the second expense data object satisfy auto-merge criteria includes determining whether the second expense data object is an exact match to the first expense data object according to a confidence percentage value.

8. The method of claim 1, wherein the user input includes one of a merge expenses indication, a delete duplicate expense indication, or a hide potential duplicate flag indication.

9. A computer-readable storage medium comprising one or more programs for execution by one or more processors of an electronic device, the one or more programs including instructions which, when executed by the one or more processors, cause the electronic device to:
receive a first expense data object;
determine whether a second expense data object stored in the database matches the first expense data object;
in accordance with a determination that the second expense data object stored in the database matches the first expense data object, determine whether one or both of the first expense data object or the second expense data object satisfy auto-merge criteria;
in accordance with a determine that one or both of the first expense data object or the second expense data object do not satisfy auto-merge criteria, transmitting a potential duplicate flag indication to an external electronic device associated with a user,
receive a resolution indication from the external electronic device in response to transmitting the potential duplicate flag indication; and
perform an expense resolution procedure using at least the first expense data object in response to receiving user input.

10. The computer-readable storage medium of claim 9, wherein the one or more programs include instructions which cause the electronic device to:
determine whether the first expense data object has been exported to an integrated entity based on a determination that the second expense data object stored in the database matches the first expense data object; and
transmit the potential duplicate flag indication to the external electronic device associated with the user based on a determination that the first expense data object has been exported to the integrated entity.

11. The computer-readable storage medium of claim 9, wherein to perform the expense resolution procedure, the one or more programs include instructions which cause the electronic device to merge the first expense data object with the second expense data object based on a determination that the first expense data object has not been exported to the review entity.

12. The computer-readable storage medium of claim 9, wherein to determine whether the second expense data object stored in the database matches the expense data object, the one or more programs include instructions which cause the electronic device to determine according to one or more confidence level thresholds.

13. The computer-readable storage medium of claim 9, wherein to determine whether the second expense data object stored in the database matches the expense data object, the one or more programs include instructions which cause the electronic device to determine whether the second expense data object is an exact match to the first expense data object according to a confidence percentage value.

14. The computer-readable storage medium of claim 9, wherein the user input includes one of a merge expenses indication, a delete duplicate expense indication, or a hide potential duplicate flag indication.

15. An electronic apparatus comprising:
one or more processors;
memory; and
one or more programs stored in memory, the one or more programs including instructions for:
receiving a first expense data object;
determining whether a second expense data object stored in the database matches the first expense data object;
in accordance with a determination that the second expense data object stored in the database matches the first expense data object, determining whether one or both of the first expense data object or the second expense data object satisfy auto-merge criteria;
in accordance with a determination that one or both of the first expense data object or the second expense data object do not satisfy auto-merge criteria, transmitting a potential duplicate flag indication to an external electronic device associated with a user,
receiving a resolution indication from the external electronic device in response to transmitting the potential duplicate flag indication; and
performing an expense resolution procedure using at least the first expense data object in response to receiving user input.

16. The electronic apparatus of claim 15, wherein the one or more programs including instructions for:
determining whether the first expense data object has been exported to an integrated entity based on a determination that the second expense data object stored in the database matches the first expense data object; and
transmitting the potential duplicate flag indication to the external electronic device associated with the user based on a determination that the first expense data object has been exported to the integrated entity.

17. The electronic apparatus of claim 15, wherein performing the expense resolution procedure includes merging the first expense data object with the second expense data object based on a determination that the first expense data object has not been exported to the review entity.

18. The electronic apparatus of claim 15, wherein to determine whether the second expense data object stored in the database matches the expense data object, the one or more programs including instructions for determining according to one or more confidence level thresholds.

19. The electronic apparatus of claim 15, wherein determining whether one or both of the first expense data object or the second expense data object satisfy auto-merge criteria includes determining whether the second expense data object is an exact match to the first expense data object according to a confidence percentage value.

20. The electronic apparatus of claim 15, wherein the user input includes one of a merge expenses indication, a delete duplicate expense indication, or a hide potential duplicate flag indication.
